(19) United States
(12) Patent Application Publication
(10) Pub. No.: US 2024/0025057 A1
(43) Pub. Date: Jan. 25, 2024

(54) Fingers for Workpiece Holding Devices

(71) Applicant: Norgren Automation Solutions LLC, Saline, MI (US)

(72) Inventors: Scott Alexander Stilson, Chicago, IL (US); Tom T. Nguyen, Highlands Ranch, CO (US); Nicolas Alexander Hall, Castle Rock, CO (US); Stephan Merkelbach, Kleve (DE); Kurt Wyatt Reinschmidt, Bellingham, WA (US); Oscar Arturo Arellano Sevilla, Querétaro (MX); Corey R. Shidler, Saline, MI (US)

(21) Appl. No.: 18/248,552

(22) PCT Filed: Aug. 18, 2021
(86) PCT No.: PCT/EP2021/072918

§ 371 Date: Apr. 11, 2023

Related U.S. Application Data
(60) Provisional application No. 63/091,585, filed on Oct. 14, 2020.

(51) Int. Cl. B25J 15/10

(52) U.S. Cl. CPC B25J 15/106

(57) ABSTRACT

An example finger includes a finger body and a finger tip. The finger tip is configured to be removably mounted to the finger body. The finger includes a locking mechanism configured to secure or couple the finger tip to the finger body.

### BACKGROUND

In the manufacturing industry, various manufacturing and assembly operations are performed on numerously configured workpieces. Such operations not only involve manufacturing and assembly operations being performed on the workpieces, but such operations also require handling and shuttling the workpieces between workstations. To properly hold the workpiece, tooling assemblies must be able to properly grasp and manipulate the workpiece. Tooling systems for grasping known or similar types of objects present fewer design problems in that a gripper design may be selected that is well suited to complete a particular task. In such instances, the grippers may include a pair of fingers having simple geometries, such as flat tips for engaging the workpiece. Alternatively, the fingertips may have customized geometries for engaging workpieces with specific geometries.

In both instances, such grippers provide relatively generic or customized geometries that lend themselves to being utilized on relatively simple or specific workpiece geometries, wherein the grippers might not be easily changed or configured for other various workpiece configurations. In these situations, the grippers or tooling assemblies can be exchanged for different grippers and tooling assemblies in order to accommodate different workpiece configurations. Such exchanges require the purchasing and storing of additional grippers and tooling assemblies. Machine down time associated with exchanging such gripper and tooling assemblies may also occur, which provides for inefficiencies that are undesirable in an industrial environment.

It is with respect to these and other considerations that the disclosure made herein is presented.

### SUMMARY

Within examples described herein, the present disclosure describes implementations that relate to fingers for workpiece holding devices.

Within additional examples described herein, the present disclosure describes finger comprising a finger body and a finger tip removably coupled to the finger body, and a locking mechanism to securely couple the finger tip to the finger body.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 is a side view of a pair of gripper jaws of the finger driven work-holding method and apparatus engaging a workpiece, in accordance with an example implementation.

FIG. 2 is a perspective view of an additional implementation of the fingers of the finger driven work-holding method and apparatus, in accordance with an example implementation.

FIG. 3A is a perspective view of yet another implementation of the fingers of the finger driven work-holding method and apparatus, in accordance with an example implementation.

FIG. 3B is a front view of several of the fingers shown in FIG. 3A of the finger driven work-holding method and apparatus, in accordance with an example implementation.

FIG. 3C is a front view of the finger shown in FIG. 3A of the finger driven work-holding method and apparatus, in accordance with an example implementation.

FIG. 3D is a side of the finger shown in FIG. 3A of the finger driven work-holding method and apparatus, in accordance with an example implementation.

FIG. 4A is a front view of an additional implementation of the locking mechanism showing a collet system of the finger driven work-holding method and apparatus, in accordance with an example implementation.

FIG. 4B is a sectional view of the collet system taken in the direction of arrows A-A of FIG. 4A of the finger driven work-holding method and apparatus, in accordance with an example implementation.

FIG. 5 is an exploded view of yet another implementation of the locking mechanism showing a wedge lock system of the finger driven work-holding method and apparatus, in accordance with an example implementation.

FIG. 6 is a sectional view showing a cam actuator for the wedge lock system of FIG. 5 of the finger driven work-holding method and apparatus, in accordance with an example implementation.

FIG. 7 is a partial sectional view of even yet another implementation of the locking mechanism showing a wedge lock system having a biased roller cam actuator of the finger driven work-holding method and apparatus, in accordance with an example implementation.

FIG. 8 is a side view of a stepper motor engaging the finger of the finger driven work-holding method and apparatus, in accordance with an example implementation.

FIG. 9 is a schematic diagram showing the electronic configurations for the adjustment mechanism of the finger driven work-holding method and apparatus, in accordance with an example implementation.

FIG. 10 is a schematic diagram of the alignment station view of the finger driven work-holding method and apparatus, in accordance with an example implementation.

FIG. 11 is a perspective view of the fingers in a high-density application of the work-holding method and apparatus, in accordance with an example implementation.

FIG. 12 is an exploded view of a linear actuated cam-lock locking mechanism of the work-holding method and apparatus, in accordance with an example implementation.

FIG. 13 is a perspective view of a hydraulic actuated locking mechanism of the work-holding method and apparatus, in accordance with an example implementation.

FIG. 14 is partial sectional view showing the hydraulic actuated locking mechanism of the work-holding method and apparatus, in accordance with an example implementation.

FIG. 15 is a partial sectional view of the rocker locking mechanism of the work-holding method and apparatus, in accordance with an example implementation.

FIG. 16 is a perspective view of the rocker locking mechanism of the work-holding method and apparatus, in accordance with an example implementation.

FIG. 17 is a sectional view of the vacuum locking mechanism of the work-holding method and apparatus, in accordance with an example implementation.

FIG. 18 is s schematic drawing of the vacuum locking mechanism of the work-holding method and apparatus, in accordance with an example implementation.

FIG. 19 is a sectional drawing showing the collet locking mechanism of the work-holding method and apparatus, in accordance with an example implementation.

FIG. 20 is a perspective view of the finger-setter of the work-holding method and apparatus, in accordance with an example implementation.

FIG. 21 is a perspective view of the finger-setter with gripper jaws of the work-holding method and apparatus, in accordance with an example implementation.

FIG. 22 is a schematic drawing of a programmable finger-setter of the work-holding method and apparatus, in accordance with an example implementation.

FIG. 23 is a schematic drawing of a finger-setter mounted on a transverse rail of the work-holding method and apparatus, in accordance with an example implementation.

FIG. 24 is a schematic drawing of a finger-setter on top of the gripper jaws of the work-holding method and apparatus, in accordance with an example implementation.

FIG. 25 is a schematic drawing of a finger-setter mounted on a three-axis rail of the work-holding method and apparatus, in accordance with an example implementation.

FIG. 26 is a schematic drawing showing the rocker arm locking mechanism of the work-holding method and apparatus, in accordance with an example implementation.

FIG. 27 is a schematic drawing showing the gripper jaws stacked in the work-holding method and apparatus, in accordance with an example implementation.

FIG. 28 illustrates a perspective view of a device for holding a workpiece, in accordance with an example implementation.

FIG. 29 illustrates another perspective view of the device of FIG. 28, in accordance with an example implementation.

FIG. 30 illustrates a perspective view of a finger of the device of FIG. 28, in accordance with an example implementation.

FIG. 31 illustrates a perspective view of a housing of the device of FIG. 28, in accordance with an example implementation.

FIG. 32 illustrates a partial cross-sectional top view of the device of FIG. 28 showing guide rails mounted to the housing, in accordance with an example implementation.

FIG. 33 illustrates a cross-sectional side view of the device of FIG. 28 showing engagement of a finger with a guide rail, in accordance with an example implementation.

FIG. 34 illustrates a cross-sectional front view of the device of FIG. 28, in accordance with an example implementation.

FIG. 35 illustrates another cross-sectional front view of the device of FIG. 28, in accordance with an example implementation.

FIG. 36 illustrates a front view of the device of FIG. 28 in an unclamped position, in accordance with an example implementation.

FIG. 37 illustrates an exploded view of a device having an adaptor assembly, in accordance with an example implementation.

FIG. 38 illustrates a perspective view of a finger having a finger body and a replaceable tip, in accordance with an example implementation.

FIG. 39 illustrates a partial perceptive view of a device having a plurality of fingers configured to receive an attachment, in accordance with an example implementation.

FIG. 39B illustrates a perspective view of a finger having a tack, in accordance with an example implementation.

FIG. 40 illustrates a perspective view of a device for holding a workpiece, in accordance with an example implementation.

FIG. 41 illustrates another perspective view of the device of FIG. 40, in accordance with an example implementation

FIG. 42 illustrates an exploded perspective view of the device of FIG. 40, in accordance with an example implementation.

FIG. 43 illustrates a side cross-sectional view of the device of FIG. 40, in accordance with an example implementation.

FIG. 44 illustrates a perspective view of a body of a finger, in accordance with an example implementation.

FIG. 46 illustrates a side cross-sectional view of the device of FIG. 40, in accordance with an example implementation.

FIG. 46 illustrates a perspective cross-sectional front view of the device of FIG. 40, in accordance with an example implementation

FIG. 47 illustrates a cross-sectional front view of the device of FIG. 40, in accordance with an example implementation.

FIG. 48 illustrates another cross-sectional side view of the device of FIG. 40 showing an interface between driving wedges and driven wedges, in accordance with an example implementation.

FIG. 49 illustrates a partial side cross-sectional view of the device of FIG. 40 in an unlocked state, in accordance with an example implementation.

FIG. 50 illustrates a partial side cross-sectional view of the device of FIG. 40 after driven wedges have moved downward and a retaining tube has contacted interior surfaces of fingers, in accordance with an example implementation.

FIG. 51 illustrates a partial perspective front cross-sectional view of a device for holding a workpiece, in accordance with an example implementation.

FIG. 52 illustrates a partial front cross-sectional view of the device of FIG. 51, in accordance with an example implementation.

FIG. 53 illustrates a top perspective view of a retaining tube, in accordance with an example implementation.

FIG. 54 illustrates a bottom perspective view of a retaining tube, in accordance with an example implementation.

FIG. 55 illustrates a front cross-sectional view of a device for holding a workpiece, in accordance with an example implementation

FIG. 56 illustrates a top perspective view of a retaining tube, in accordance with an example implementation.

FIG. 57 illustrates a side cross-sectional view of the device of FIG. 55, in accordance with an example implementation.

FIG. 58 illustrates a perspective view of a finger having a finger body and a finger tip, in accordance with an example implementation.

FIG. 59 illustrates a perspective view of the finger body and the finger tip of FIG. 58 before assembly, in accordance with an example implementation.

FIG. 60 illustrates a perspective cross-sectional view of the finger of FIG. 58, in accordance with an example implementation.

FIG. 61 illustrates a perspective view of a finger body, in accordance with an example implementation.

FIG. 62 illustrates a perspective cross-sectional view of the finger body of FIG. 61, in accordance with an example implementation.

FIG. 63 illustrates detail “B” labelled in FIG. 62, in accordance with an example implementation.

FIG. 64 illustrates a perspective view of a finger having a finger body and a finger tip, in accordance with an example implementation.

FIG. 65 illustrates a partial perspective view of the finger of FIG. 64 depicting a cam member inserted into a finger body, in accordance with an example implementation.

FIG. 66 illustrates a partial top view of the finger of FIG. 64, in accordance with an example implementation.

FIG. 67 illustrates a perspective cross-sectional view of the finger of FIG. 64, in accordance with an example implementation.

FIG. 68 illustrates a side cross-sectional view of the finger of FIG. 64, in accordance with an example implementation.

FIG. 69 illustrates a partial perspective view of a device for holding a workpiece, in accordance with an example implementation.

FIG. 70 illustrates a side cross-sectional view of the device of FIG. 69, in accordance with an example implementation.

FIG. 71 illustrates a top perspective view of a finger having a finger body and a finger tip, in accordance with an example implementation.

FIG. 72 illustrates a bottom perspective view of the finger of FIG. 71, in accordance with an example implementation.

FIG. 73 illustrates a side view of the finger of FIG. 71, in accordance with an example implementation.

FIG. 74 illustrates a partial perspective view of the finger of FIG. 71 showing a clamp disposed through a hole of a finger body, in accordance with an example implementation.

FIG. 75 illustrates a perspective partial cross-sectional view of the finger of FIG. 71, in accordance with an example implementation.

FIG. 76 illustrates a perspective partial cross-sectional view of the finger if FIG. 71 with a stud having a flat surface, in accordance with an example implementation.

FIG. 77 illustrates a partial cross-sectional view of the finger of FIG. 71 with the stud of FIG. 76 oriented at a different angle, in accordance with an example implementation.

FIG. 78 illustrates a partial cross-sectional view of the finger of FIG. 71 with a stud having a flat surface without a hexagonal head, in accordance with an example implementation.

FIG. 79 illustrates a partial perspective view of two devices having fingers configured as the finger of FIG. 71, in accordance with an example implementation.

FIG. 80 is a flowchart of a method for operating a device for holding a workpiece, in accordance with an example implementation.

### DETAILED DESCRIPTION

Disclosed examples will now be described more fully hereinafter with reference to the accompanying drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

In order to accommodate the many types of manufacturing and assembly operations that exist today, as well as accommodate the numerous types of workpiece configurations, it may be desirable for tooling systems to adapt to a wide variety of workpiece shapes and sizes. The absence of prior knowledge regarding the type of workpiece, variations in the type of workpiece, and the variations in the workpiece location and position present difficulties in providing a tooling system that can adapt to these situations. These challenges are multiplied by the need to provide a tooling system that is simple, robust and tolerant of poor or inaccurate sensor information. Tooling systems have been developed which include fully articulated fingers that are able to grasp a wide variety of workpieces having different shapes. However, these types of tooling systems often require complex planning and advance knowledge of the workpiece configuration in order to properly secure and hold the workpiece. In addition, such tooling systems utilizing fully articulated fingers may require numerous actuators and controls. The complexity and quantity of such actuators may lead to such tooling systems being expensive and prone to maintenance, which is undesirable in an industrial environment.

In examples, a tooling system can be configured to adjust to a wide variety of differently configured workpieces by providing gripper jaws that utilize a plurality of dowel pins or plungers that are arranged parallel to each other and which are slidably adjustable along their longitudinal direction. The gripper jaws may oppose one another so that the workpiece may be engaged between the gripper jaws. When the gripping jaws move toward one another to engage the workpiece, the dowel pins or plungers are deflected in accordance with the contour of the workpiece, so that the contour of the workpiece is positively received by the dowel pins or plungers of the gripper jaws. The dowel pins or plungers may be deflected against a biasing force, such as springs or pneumatic pressure, or the dowel pins or plungers may be manually moved into their proper position. The dowel pins or plungers are then fixed into position through the use of a clamping mechanism so that the workpiece can be positively received by the gripper jaws. In some cases, however, a clamping mechanism might fail to hold the dowel pins or plungers in a fixed position under high loads and forces. Movement of the dowel pins or plungers may lead to movement of the workpiece, which is detrimental to machining and/or positioning of the workpiece. In addition, setting the position of the dowel pins or plungers may be inaccurate or inconsistent due to the configuration of the workpiece, inconsistencies between workpieces, inconsistencies in biasing forces against the dowel pins or plungers, errors by the user, etc.

It may thus be desirable to provide an automatic tooling assembly that could provide an accurate and consistent system for adjustably engaging a variety of workpieces having numerous configurations.

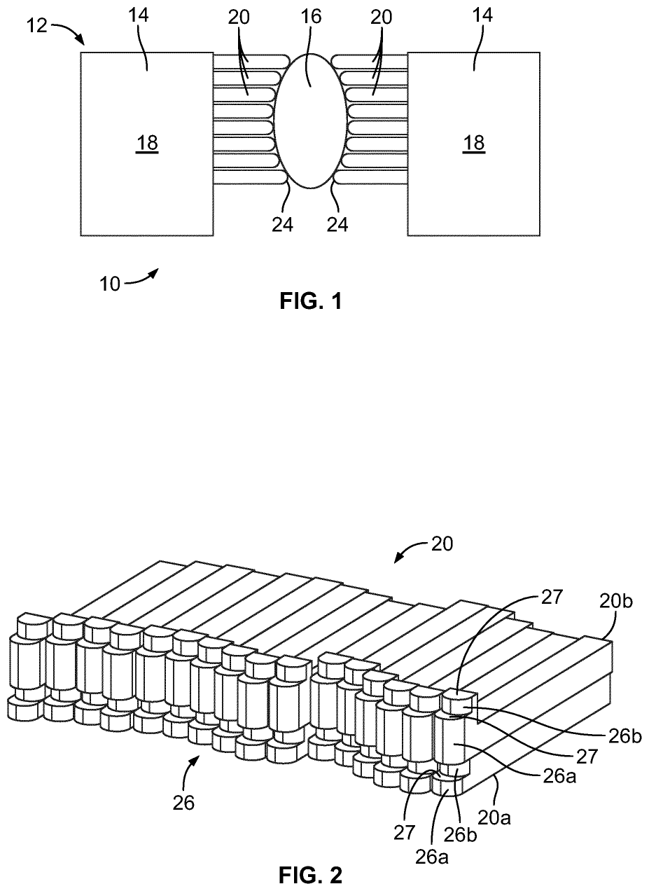

The present disclosure provides a finger driven work-holding method and apparatus that automatically adjusts to the configuration of a workpiece so that the workpiece can be properly secured and held during machining and material handling operations. As seen in FIG. 1, the finger driven work-holding apparatus 10 provides a work-holding device 12 having a pair of opposing gripper jaws 14 for engaging a workpiece 16. Each gripper jaw 14 provides an enclosure 18 for housing a plurality of substantially-parallel fingers 20 that extend longitudinally from the enclosure 18. The term “finger” is used here to indicate a longitudinally-extending member that can be referred to as a clamping pin configured to be longitudinally-movable to interact with the workpiece 16.

The fingers 20 extend from opposing sides of the gripper jaws 14 such the fingers 20 engage the workpiece 16 from opposite sides of the workpiece 16. An adjustment mechanism is utilized to adjust the length in which each of the fingers 20 extend longitudinally from the enclosure 18, wherein the length of the fingers 20 are adjusted along their longitudinal axes such that a free end 24 of the fingers 20 engage the workpiece 16. Once the fingers 20 are in their desired position, the fingers 20 are locked into position by a locking mechanism such that the fingers 20 cannot move upon engaging the workpiece 16. An example locking mechanism involves a pneumatic locking assembly. The fingers 20 engage the workpiece 16 from opposing sides of the workpiece 16 thereby securing the workpiece 16 for machining and/or material handling operations.

FIG. 2, illustrates fingers 20a having elongated and substantially rectangular shape, and/or the fingers 20b may be substantially rectangular and L-shaped, in accordance with an example implementation. The tips 26 of the fingers 20a, 20b may be contoured or arcuate, such as a semi-cylindrical shape, or the tips 26 may have a longitudinally extended portion 26a and/or a longitudinally recessed portion 26b. The extended portion 26a of the tips 26 provides a ledge 27 which may engage a bottom surface of the workpiece 16 such that the workpiece 16 may rest on the ledge 27 of the extended portion 26a. The recessed portion 26b of the tip 26 may then engage a side of the workpiece 16. This type of tip 26 may allow the workpiece 16 to sit higher than the fingers 20 thereby allowing certain manufacturing or machining operations to be performed on the upper portion of the workpiece 16. This may also be beneficial when the workpiece 16 is small and/or thin and cannot be easily engaged by the fingers 20. When the fingers 20a, 20b are stacked adjacent to one another, the extended portion 26a of the tips 26 may engage both a top and a bottom surface of the workpiece 16, or the extended portion 26a of the fingers 20a, 20b may extend into recesses provided in the workpiece 16, while the recessed portion 26b of the fingers 20a, 20b may engaged outer extending portions of the workpiece 16. This configuration of the fingers 20 may assist in engaging smaller and/or more complex configurations of the workpiece 16.

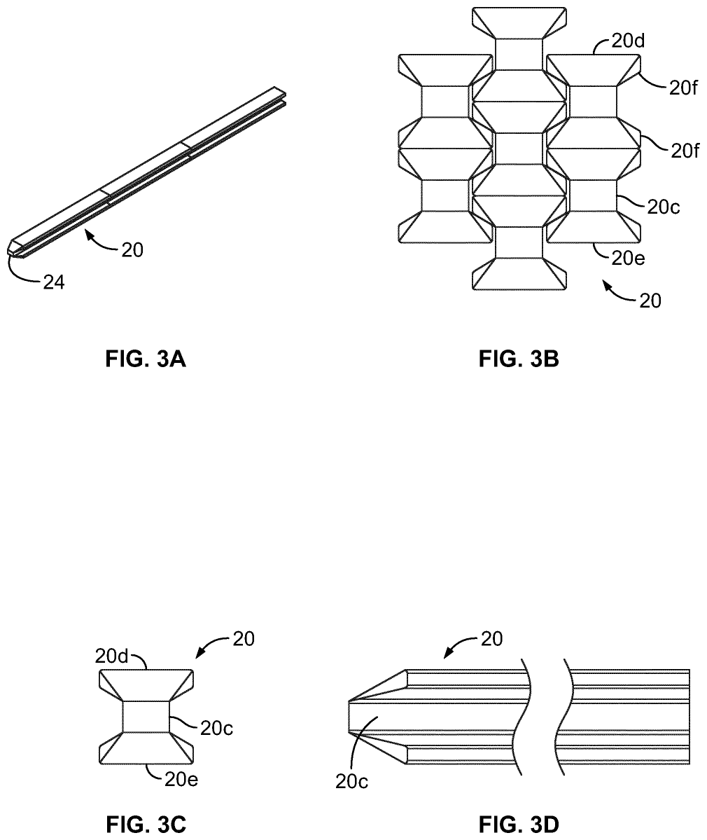

In another implementation, the fingers 20 may have a substantially hour-glass cross-sectional shape, as shown in FIGS. 3A-3D. The fingers 20 may be elongate and extend along a longitudinal axis with a substantially-rectangular mid-portion 20c. The mid-portion 20c has a top portion 20d and a bottom portion 20e of the finger 20 that extend outward at an angle from the mid-portion 20c. The top and bottom portions 20d, 20e have chamfered corners 20f along the sides of the top and bottom portions 20d, 20e of the finger 20. The free end 24 of the finger 20 is tapered downward toward the mid-portion 20c leaving the free end 24 with a substantially rectangular tip or end. The benefit of this implementation of the fingers 20 is that the sides of the fingers 20 create interlocking profiles that assist in keeping the fingers 20 together such that the fingers 20 tend to act as a single block as opposed to individual fingers 20. The interlocking profiles provide superior load bearing capability as compared to other finger 20 structures.

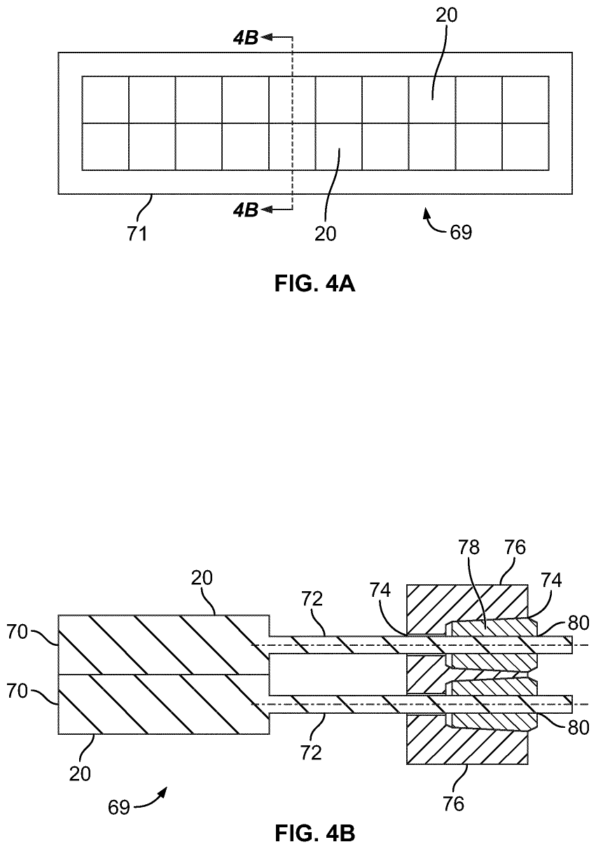

As mentioned above, in order to lock the fingers 20 into their desired positions, a locking mechanism, such as a pneumatic locking assembly, may be used for example. It should be noted that the present disclosure anticipates that other forms or implementations of the locking mechanism could be provided. As shown in the non-limiting disclosure of FIGS. 4A-4B, an implementation of a locking mechanism having a collet and block system 69 that could be utilized for locking the fingers 20 into the locked position. The fingers 20 are adjacently aligned and disposed within an enclosure 71, and each finger 20 has a body 70 and a stem 72, wherein the stem 72 is connected to and extends from the body 70 while extending through an aperture 74 provided through a block 76. The aperture 74 in the block 76 has a stepped diameter wherein the larger diameter portion of the aperture 74 is tapered slightly inward toward the opening in the block 76. The larger diameter of the aperture 74 receives a collet 78 wherein the collet 78 also has an aperture 80 extending there through for receiving the stem 72 of the finger 20. The collet 78 has open ended relief slots (not shown) longitudinally formed in the walls of the collet 78 such that the walls of the collet 78 can compress inward when forced further into the narrowing portion of the tapered aperture 74 in the block 76. When the stem 72 is positioned within the collet 78, and the collet 78 is forced further into the narrower portion of the tapered aperture 74, the walls of the collet 78 compress onto the stem 72 of the finger 20 thereby securing or locking the finger 20 into position. Thus, in the unlocked position, the collet 78 is moved slightly outward toward the wider portion of the tapered aperture 74 so that the walls of the collet 78 move to their relaxed state so as not to compress the stem 72 of the finger 20. This allows the stem 72 of the finger 20 to freely move through the aperture 74 of the block 76 and the collet 78 thereby allowing the finger 20 to be adjustably positioned along its longitudinal axis. Once the finger 20 is moved into its desired position, the collet 78 is forced downward into the narrower portion of the tapered aperture 74, wherein the walls of the collet 78 are compressed against the stem 72 of the finger 20 thereby securing the finger 20 in the locked position.

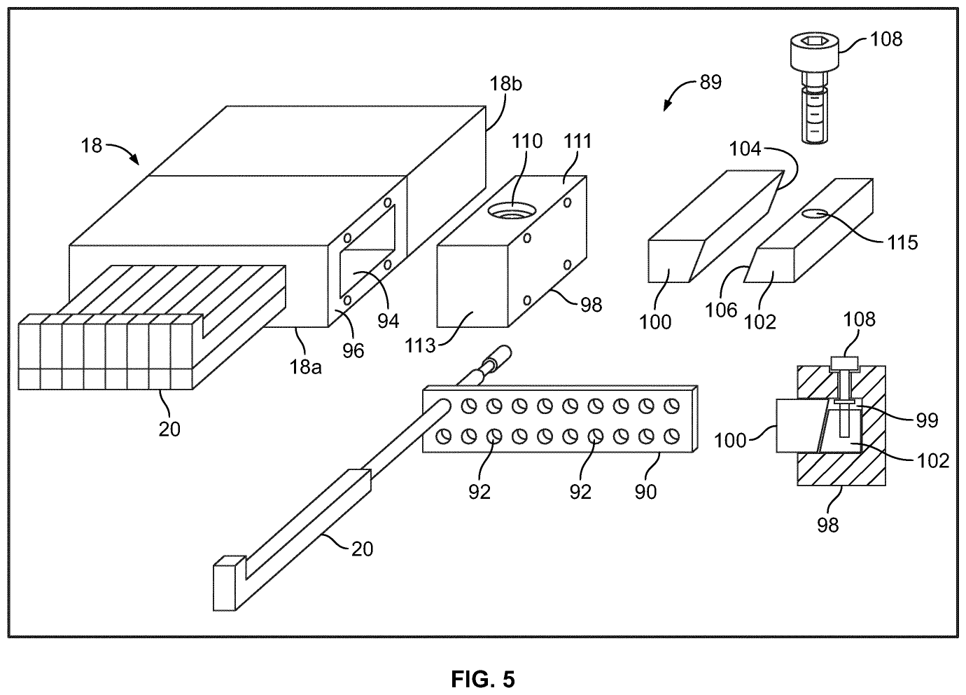

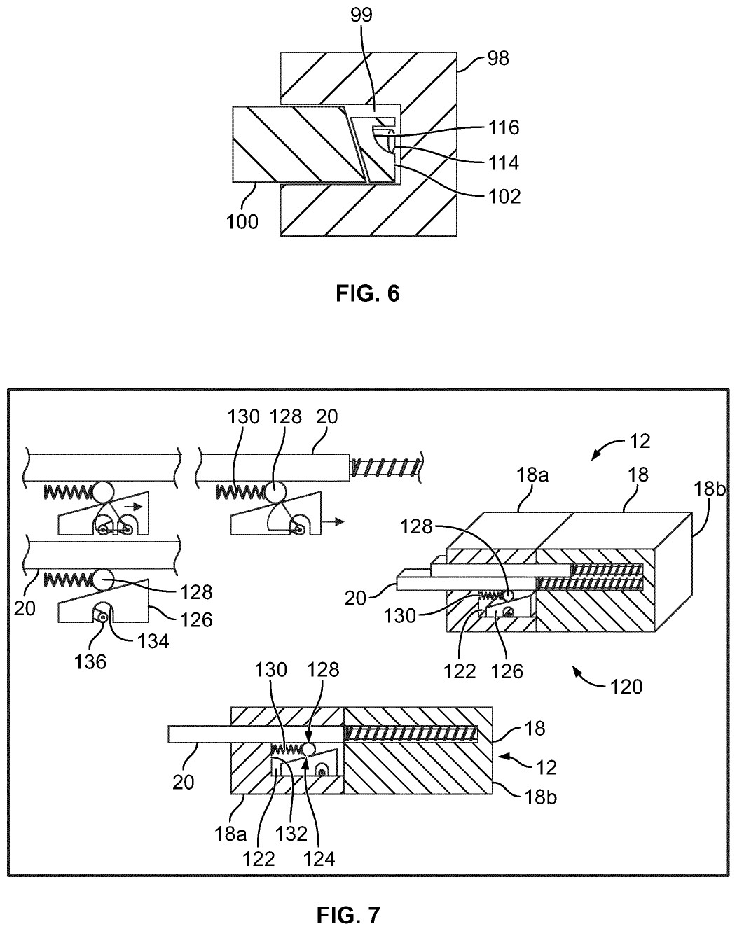

In an another implementation, the locking mechanism for locking the fingers 20 may include a wedge block system 89, as shown in FIG. 5. The non-limiting disclosure provides that the enclosure 18 may have a front portion 18a for receiving the locking mechanism and a rear portion 18b for housing the adjustment mechanism. The fingers 20 are partially housed within the enclosure 18 and extend from the rear portion 18b to the front portion 18a of the enclosure 18, wherein the fingers 20 extend outward from the front portion 18a of the enclosure 18. A bracket 90 having a plurality of apertures 92 formed there through may be positioned within the enclosure 18 for receiving and supporting a portion of the fingers 20. The front portion 18a of the enclosure 18 has a side wall 96 with an opening 94 formed therein. A lock box 98 is connected to the side wall 96 of the enclosure 18 such that a recess 99 in the lock box 98 communicates with the opening 94 formed in the side wall 96 of the enclosure 18. The lock box 98 houses a driven wedge block 100 and a driver wedge block 102 wherein the wedge blocks 100, 102 are adjacently aligned with abutting angled surfaces 104, 106 that slidably move and engage one another. The driver wedge block 102 is completely disposed within the recess 99 of the lock box 98, and the driven wedge block 100 is partially disposed within the recess 99 of the lock box 98 while also partially extending into the opening 94 formed in the side wall 96 of the enclosure 18. An actuator comprising a set screw 108 is received within and extends through an aperture 110 provided in the locked box 98. The set screw 108 may extend through a top wall 111 of the lock box 98, through the aperture 110, and into a threaded aperture 115 provided in the driver wedge block 102, as shown in FIG. 5, or the set screw 108 may comprise a cam actuator or follower 114, as shown in FIG. 6, wherein the cam actuator or follower 114 extends through an end wall 113 of the lock box 98 for rotatably engaging a cam path 116 formed from a recess in the driver wedge block 102. The driver wedge block 102 is smaller than the recess 99 formed in the lock box 98 such the driver wedge block 102 can move along the longitudinal axis of the set screw 108 upon rotation of the set screw 108, as shown in FIG. 5, or move substantially perpendicular to the rotational axis of the cam actuator or follower 114, as shown in FIG. 6. The driven wedge block 100 is similar in size to the recess 99 in the lock box 98, such that the driven wedge block 100 can slide freely within the recess 99 of the lock box 98. The driven wedge block 100 extends from the lock box 98 into the opening 94 provided in the side wall 96 of the enclosure 18, wherein the driven wedge block 100 engages the sides of the stacked fingers 20. In the unlocked position, the driver wedge block 102 is lowered in the recess 99 of the lock box 98 by the set screw 108, as shown in FIG. 5, or the cam actuator or follower 114, as shown in FIG. 6, so that the driven wedge block 100 relaxes and does not compress the fingers 20. This allows the fingers 20 to be adjusted along their longitudinal axes. Once the fingers 20 are adjusted and placed in their desired positions, the set screw 108, as shown in FIG. 5, or the cam actuator or follower 114, as shown in FIG. 6, can be turned or rotated to raise the driver wedge block 102 upward and to move the driven wedge block 100 outward through the sliding engagement of the adjacent angled surfaces 104, 106 of the wedge blocks 100, 102. The outward movement of the driven wedge block 100 compresses the fingers 20 together and locks the fingers 20 into position thereby establishing the locked position.

In another implementation, the locking mechanism for moving the fingers 20 between the locked position and the unlocked position may comprise a cam actuator system 120, as shown in FIG. 7 in a non-limiting disclosure. The cam actuator system 120 provides the work-holding device 12 with the enclosure 18 for housing the fingers 20, wherein the enclosure 18 may have a front portion 18a for receiving the locking mechanism and a rear portion 18b for housing the adjustment mechanism. The fingers 20 are partially housed within the enclosure 18 and extend from the rear portion 18b to the front portion 18a of the enclosure 18, wherein the fingers 20 extend outward from the front portion 18a of the enclosure. The enclosure 18 may have an opening 122 formed within the front portion 18a of the enclosure 18 directly below the fingers 20. A cam follower 124 is disposed within the opening 122 of the enclosure 18, wherein the cam follower 124 is fabricated from a block 126 having an angle surface which acts as the cam follower 124 directly beneath the fingers 20. A spring biased roller 128 is seated between the angled cam follower 124 and the underside of the fingers 20. A compression spring 130 is placed between the roller 128 and a wall 132 of the enclosure 18 defining the opening 122 in the enclosure 18. The spring 130 biases the roller 128 against the angled cam follower 124 and the underside of the fingers 20. The block 126 of the cam follower 124 has a curved cam surface 134 defined by a recess in the cam follower 124. A rotatable cam driver 136 is disposed within the recess of the cam follower 124, wherein the rotatable cam driver 136 is engageable with the cam surface 134. The rotatable cam driver 136 is connected to a rod or axle (not shown) that extends outside of the enclosure 18 through an aperture (not shown) provided in the front portion 18a of the enclosure 18. In the unlocked position, the rotatable cam driver 136 is rotated so that the angled cam follower 124 on the block 126 is positioned to allow the greatest distance between the block 126 and the fingers 20. This allows the roller 128 to relax thereby allowing the fingers 20 be adjusted along their longitudinal axes. Once the fingers 20 are placed in their desired positions, the rotatable cam driver 136 is rotated against the cam surface 134 thereby moving the block 126 such that the angled cam follower 124 on the block 126 is positioned so that a minimal distance is formed between the angled cam follower 124 of the block 126 and the underside of the fingers 20. This applies pressure on the roller 128, which in turn applies pressure to the fingers 20 thereby locking the fingers 20 into their desired position in the locked position. In should be noted that the roller 128 can by spherical where only one finger 20 exists, or the roller 128 may be cylindrical with a longer block 126 for engaging a plurality of the fingers 20.

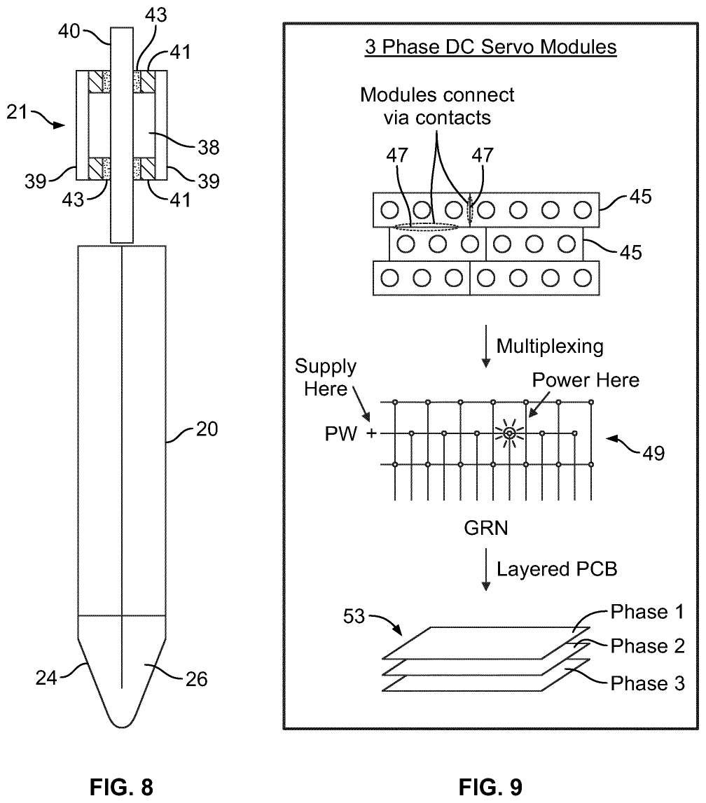

To adjust the position of the fingers 20, an adjustment mechanism 21 may provide a linear stepper motor 38 to adjust the position of each finger 20 longitudinally, as shown in FIG. 8. Each of the linear stepper motors 38 may be housed within the enclosure 18 or disposed within a separate housing 37 attached to the enclosure 18 to form a linear servo array (not shown). Each of the linear stepper motors 38 may be housed within an enclosure 39, wherein a forcer rod 40 extends through an aperture provided at each end of the enclosure 39. The forcer rod 40 is supported by a spacer 41 and a bushing 43 at each end of the enclosure 39 to allow the forcer rod 40 to move longitudinally with respect to the enclosure 39. The forcer rod is coupled to the linear stepper motor 38 with one end of the forcer rod 40 connected to one end of the finger 20 opposite the tip 26 of the finger 20. The linear stepper motor 38 drives the forcer rod 40 in a linearly reciprocal fashion thereby moving the finger 20 longitudinally in a linear reciprocal fashion. The linear stepper motors 38 are small, accurate, and can provide precise incremental movements of the fingers 20. The linear stepper motor 38 is in communication with a central processing unit (CPU) (not shown), such as a programmable controller, computer system, etc. The CPU provides instructions to the linear stepper motor 38 as to where to position each of the fingers 20 longitudinally through the use of a computer program which stores the desired position of each of the fingers 20. A computer program may be created for each differently configured workpiece 16, such that a specific computer program can be accessed upon the input of the workpiece 16.

The linear servo array may comprise different configurations in order to create a compact enclosure 18. As shown in FIG. 9, electrical connections for the linear stepper motors 38 and the CPU of the linear servo array may comprise three phase DC servo modules 45 wherein the modules 45 are adjacently aligned via electrical contacts 47. Multiplexing 49 may also be utilized to combine multiple analog or digital signals into one signal over a shared medium. Lastly, layered printed circuit boards 53 may be utilized to provide the necessary electrical communication for three phase DC servo modules.

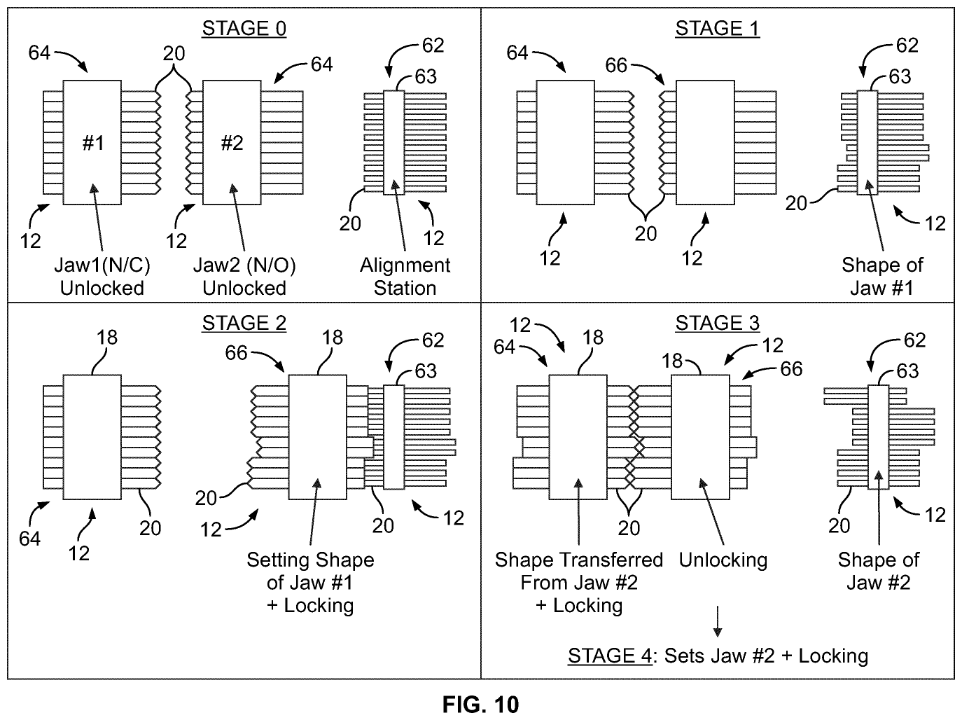

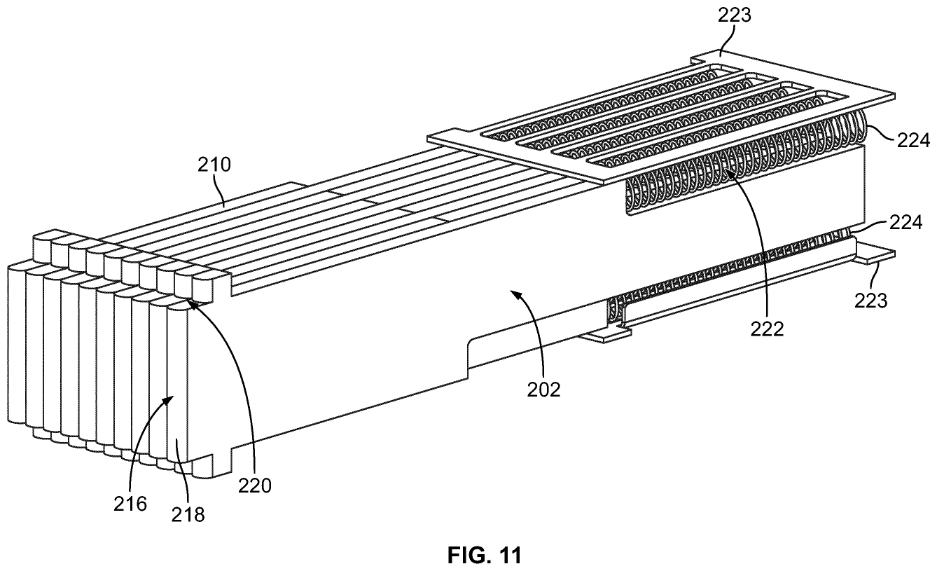

Although we have described the disclosed method and apparatus 10 as automatically adjusting the fingers 20 in the gripper jaws 14 of the work-holding device 12, the present disclosure also provides that the method and apparatus 10 may provide an alignment station 62, as shown in FIG. 10. The alignment station 62 provides the fingers 20 in the work-holding device 12 as previously described, wherein the position of the fingers 20 are automatically adjusted as previously described, or the alignment station 62 may comprise a type of gage wherein the fingers 20 are disposed within an enclosure 63 with the locking mechanism provided therein for locking and unlocking the fingers 20 into position but without the automatic adjustment mechanism 21 for adjusting the position of the fingers 20. In those instances in which an automatic adjustment mechanism 21 is not provided in the alignment station 62, the fingers 20 could be manually positioned or adjusted by a user, or the fingers 20 could be positioned by having a robotic arm (not shown) use a stylist or poker (not shown) to engage and push each finger 20 into position from the back side of the gage or work-holding device 12.

The work-holding device 12 in the alignment station 62 is not designed to engage and hold the workpiece 16, but rather, the work-holding device 12 in the alignment station 62 is used as a gage for which other work-holding devices 12 and their associated fingers 20 can be adjusted thereto. The difference is that the work-holding devices 12 used outside of the alignment station 62 do not include the automatic adjustment mechanism 21, but rather, the work-holding devices 12 would only include the locking mechanism for locking the fingers 20 in the desired position. The use of the alignment station 62 reduces the cost associated with the work-holding devices 12 being used in production, as only the work-holding device 12 in the alignment station 62 would require the linear stepper motors 38 and programmability associated with the automatic adjustment mechanism 21 of the method and apparatus 10. Those work-holding devices 12 in production would not require the cost associated with the automatic adjustment mechanism 21.

In order to position and set the fingers 20 in their desired position using the alignment station 62, a first gripper jaw 64, a second gripper jaw 66, and the alignment station 62 start out are in an unlocked, initial position, as seen in Stage 0. That is, the position of the fingers 20 in the first gripper jaw 64, the second gripper jaw 66, and the alignment station 62 have not been positioned and set, and therefore, the fingers 20 in the first gripper jaw 64, the second gripper jaw 66, and the alignment station 62 are in the unlocked position. As shown in Stage 1, the fingers 20 in the alignment station 62 are positioned and then locked in the locked position using the method and apparatus 10 previously described. The fingers 20 in the alignment station 62 do not have rounded tips, but rather, both ends of fingers 20 in the alignment station 62 may be flat. As shown in Stage 2, the second gripper jaw 66 is placed in the unlocked position and moved into position adjacent the alignment station 62 such the flat ends of the fingers 20 on the second gripper jaw 66 align and engage the flat ends of the corresponding fingers 20 on the alignment station 62. Once the fingers 20 on the second gripper jaw 66 mirror the position of the fingers 20 in the alignment station 62, the fingers 20 on the second gripper jaw 66 are placed into the locked position. As shown in Stage 3, the first gripper jaw 64 then approaches the second gripper jaw 66 in the unlocked position, wherein the rounded ends of the fingers 20 in the first gripper jaw 64 engage the rounded ends of the fingers 20 in the second gripper jaw 66 such that the fingers 20 in the first gripper jaw 64 mirror the position of the fingers 20 in the second gripper jaw 66. The fingers 20 in the first gripper jaw 64 are then placed into the locked position as shown in Stage 4, and both the first gripper jaw 64 and the second gripper jaw 66 are ready to engage and hold the workpiece 16.

In operation, the method and apparatus 10 of the present disclosure provides the work-holding device 12 with a pair of the gripper jaws 14, wherein the fingers 20 of the gripper jaws 14 are in an unlocked position. The desired positions of the fingers 20 are predetermined and stored within a computer program of the central processing unit (CPU). Each computer file of the computer program corresponds to a particular configuration of the workpiece 16, wherein the position of each finger 20 is predefined. The user selects the desired computer file or workpiece 16, and the adjustment mechanism 21 moves the fingers 20 into the predetermined positions along the longitudinal axes of the fingers 20. Once the fingers 20 are in the desired position, the locking mechanism locks the fingers 20 into the locked position, and the gripper jaws 14 move toward one another wherein the free ends 24 or the tips 26 of the fingers 20 engage the workpiece 16 in the predetermined configuration. Once the gripper jaws 14 have finished handling and/or moving the workpiece 16, the fingers 20 may be reconfigured so that the gripper jaws 14 may properly engage a differently configured workpiece 16. To do so, the user simply selects the computer program corresponding to the differently configured workpiece 16, the locking mechanism moves to the unlocked position, and the process repeats itself.

The present disclosure provides additional implementations of the method and apparatus 10, as shown in FIG. 11, which is similar to the implementation shown in FIG. 5. The implementation shown in FIG. 11 provides the work-holding device 12 with a gripper jaw having a housing 202. The housing 202 has a substantially-rectangular passageway that extends through the housing 202 for partially housing a plurality of substantially similar fingers 210.

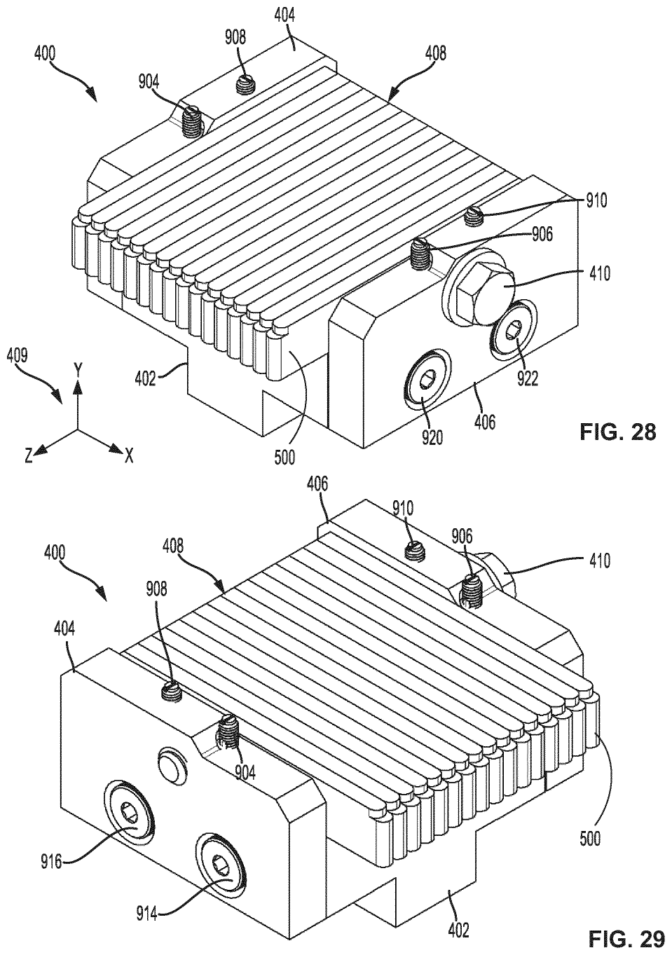

In order for the fingers 210 to adjustably engage the workpiece 16, the fingers 210 are adjacently aligned in a single row, although the present disclosure is not limited to a single row of fingers 210. In addition, the gripper jaws 200 may be stacked to provide two sets of fingers 210, as shown in FIG. 27.

Each finger 210 has a workpiece engaging portion that extends outward from the housing 202 to contact and engage the workpiece 16. In a non-limiting disclosure, the workpiece engaging portion of the finger 210 is substantially-rectangular with a substantially rounded free end 216 having an extended portion 218 and a recessed portion 220 which are used to engage the workpiece 16. Each finger 210 has a spring rod 222 that is connected to and extends from the workpiece engaging portion at an end opposite the free end 216 of the workpiece engaging portion.

In an example implementation, the spring rod 222 may alternate from the top and bottom of adjacent fingers 210, as shown in FIG. 11, to allow for thinner fingers 210, which may allow for a greater number or density of fingers 210. In this particular implementation, separate brackets 223 are utilized to provide spacers between compression springs 224. As seen in FIG. 11, the spring rod 222 is substantially-cylindrical for receiving a compression spring 224 that slides over the spring rod 222. The adjacently aligned fingers 210 are disposed in the passageway of the housing 202 such that the free end 216 of the fingers 210 extend outward from the housing 202.

In an example, the spring rods 222 extend into a recess of a rear housing (not shown) coupled to the housing 202 wherein a free end of the spring rods 222 extend through apertures provided in a spring plate. The spring plate can be an L-shaped bracket mounted within the recess of the rear housing. The apertures in the spring plate are large enough to allow the free end of the spring rod 222 to pass through the aperture when assembling the spring rods 222 to the spring plate, but the apertures are small enough to prohibit the spring 224 from passing through the aperture thereby abutting the spring plate. When assembled, the compressions springs 224 bias the fingers 210 outward away from the housing 202.

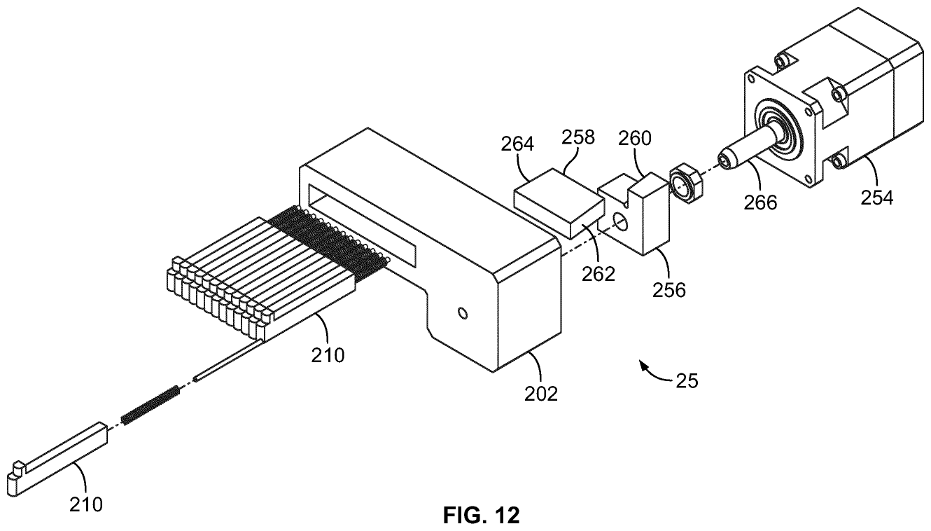

In an example implementation shown in FIG. 12, the locking mechanism may use a linear actuator 254 to drive a cam-lock wedge 256 and a cam-locked compression plate 258. The cam-lock wedge 256 has an L-shaped configuration with an angle cam surface 260 formed thereon. The cam-lock wedge 256 is disposed within a recess 242 in the housing 202 along with the cam-lock compression plate 258. The cam-lock compression plate 258 has a substantially-rectangular configuration with an angled cam surface 262 formed thereon which slidably engages the cam surface 260 of the cam-lock wedge 256. The cam-lock compression plate 258 extends into the passageway of the housing 202, wherein a compression surface 264 of the cam-lock compression plate 258 engages a side of the last finger 210 located on the end of the adjacently aligned fingers 210. The linear actuator 254 has a piston rod 266 connected to the cam-lock wedge 256, wherein the piston rod 266 may reciprocally drive the cam-lock wedge 256 between the unlocked and locked positions. That is, when the linear actuator 254 retracts to the unlocked position, the cam-lock wedge 256 moves relative to the cam-lock compression plate 258 such the cam surfaces 260, 262 slide to relieve any pressure applied from the cam-lock compression plate 258 to the fingers 210 thereby allowing the fingers 210 to be adjusted to a desired position. When the linear actuator 254 extends to the locked position, the cam-lock wedge 256 moves relative to the cam-lock compression plate 258 such the engaging cam surfaces 260, 262 forces the cam-lock compression plate 258 against the side of the last finger 210 thereby locking the fingers 210 in a predetermined position.

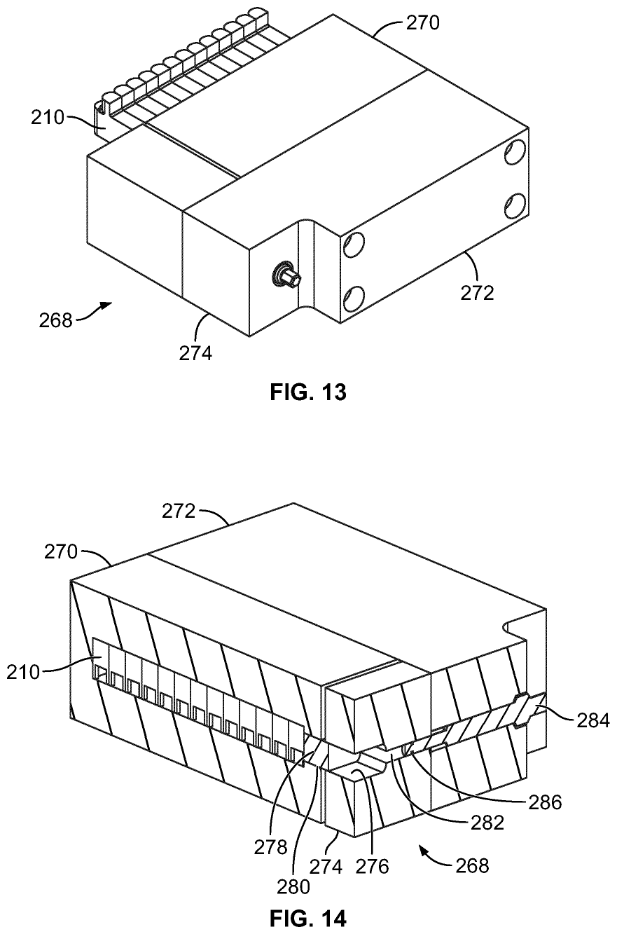

In another implementation, the apparatus 10 may utilize a locking mechanism having a hydraulic clamping mechanism 268, as shown in FIGS. 13-14. The apparatus 10 provides a main housing 270 and a rear housing 272 wherein the fingers 210 are similarly disposed within the main housing 270 and the rear housing 272. However, in this implementation, the hydraulic clamping mechanism 268 provides a hydraulic chamber 274 that is mounted adjacent the main housing 270 and a portion of the rear housing 272. The hydraulic chamber 274 provides a recess 276 for housing a hydraulic fluid (not shown). The recess 276 is in communication with the passageway in the main housing 270, wherein a piston 278 is slidably disposed within a portion of the recess 276 and a portion of the passageway such that the piston 278 is engageable with a side of the last finger 210 in the adjacently aligned fingers 210. A flexible seal 280 is seated within an annular recess provided in the piston 278 to seal the piston 278 form the hydraulic chamber 274 and prevent the hydraulic fluid from exiting the hydraulic chamber 274.

To move the locking mechanism between the locked and unlocked positions, the hydraulic chamber 274 has an aperture 282 that extends from the recess 276, through the hydraulic chamber 274, and through a portion of the rear housing 272. A clamp screw 284 extends from outside the rear housing 272, through the aperture 282 in the rear housing 272, and through a portion of the aperture 282 in the main housing 270 leading to the recess 276. The clamp screw 284 threadably engages a portion of the aperture 282, wherein the portion of the clamp screw 284 extending outside the rear housing 272 may be engaged by a tool to turn the clamp screw 284 about the threaded region of the aperture 282. The opposite end of the clamp screw 284 has an annular recess for receiving a flexible seal 286 for sealing the clamp screw 284 from the aperture 282 with the hydraulic chamber 274. The hydraulic fluid fills the recess 276 of the hydraulic chamber 274 such that turning the clamp screw 284 in and out of the aperture 282 affects the volume in the recess 276 thereby affecting the pressure of the hydraulic fluid within the recess 276. Thus, in the unlocked position, the clamp screw 284 is rotated away from the recess 276, thereby allowing the hydraulic fluid to apply less pressure to the piston 278 such that the piston 278 does not compress the fingers 210. This, in turn, allows the position of the fingers 210 to be adjusted in a predetermined position in the unlocked position. To move the locking mechanism to the locked position, the clamp screw 284 is threadably rotated toward the recess 276 to increase the pressure applied by the hydraulic fluid against the piston 278, thereby driving the piston 278 against the fingers 210 and locking the fingers 210 in the locked position.

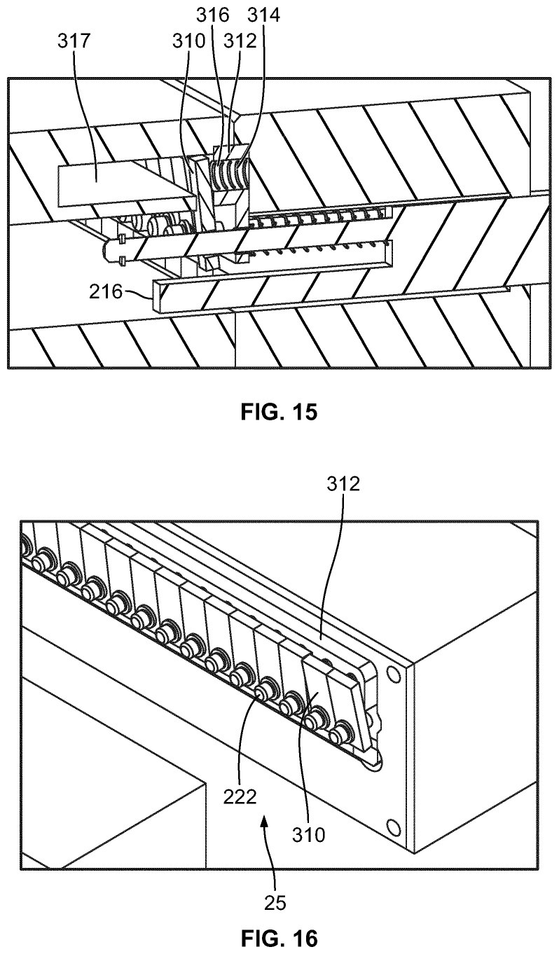

In another implementation, the apparatus 10 may provide the locking mechanism with a rocker panel 310 that pinches the end of the spring rod 222 of the fingers 210 to secure the fingers 210 in the locked position, as shown in FIGS. 15-16. The implementation is similar to the implementation described in FIG. 11 wherein the fingers 210 are disposed with the housing 202 and a rear housing. Each finger 210 is spring biased using the compression spring 224 placed on the spring rod 222 of the finger 210.

In the implementation of FIGS. 15-16, the rocker panel 310 comprises a one-piece structure to receive all of the spring rods 222 of the fingers 210, as seen in FIG. 15, or the rocker panel 310 may comprise an individual structure that receives only one spring rod 222, as seen in FIG. 16. Either way, the rocker panel 310 has the ability to tilt at an angle away from the housing 202 such that the rocket panel 310 leverages against the spring rod 222 to hold the fingers 210 in position through friction. A wedge structure 312 may be placed between the rocker panel 310 and the housing 202, wherein a compression spring 314 is disposed within an aperture 316 extending through the wedge structure 312. One end of the compression spring 314 engages the housing 202 while the other end of the compression spring 314 engages the rocker panel 310 to bias the rocker panel 310 away from the housing 202 toward the locked position, wherein the fingers 210 are locked in a predetermined position. An engagement structure 317 extending from the rear housing may be used to move the rocker panel 310 toward the housing 202 and against the compression spring 314 such that the rocker panel 310 may move toward the unlocked position, wherein the fingers 210 may be adjustably moved toward a predetermined position.

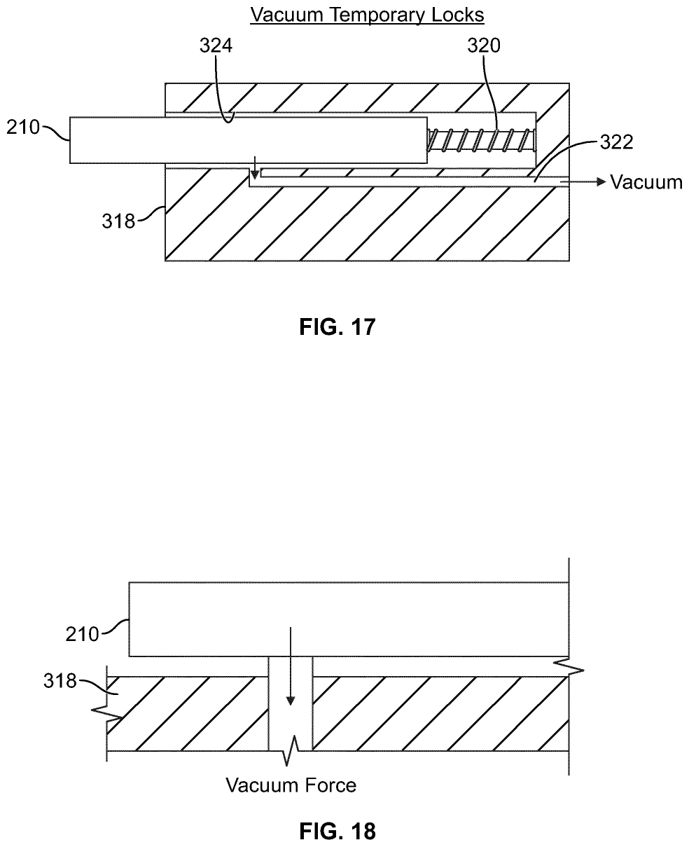

In an alternative implementation, the apparatus 10 may provided a locking mechanism that utilizes vacuum to hold the fingers 210 in a temporarily locked position while the fingers 210 are being adjusted to a predetermined position, as shown in FIGS. 17 and 18. The implementation is similar to the implementation disclosed in FIG. 11, as the fingers 210 are disposed within a recess 324 provided in an enclosed housing 318, wherein compression springs 320 bias the fingers 210 outward away from the housing 318. A passageway 322 extends through the housing 318 and opens into the recess 324 of the housing 318 adjacent the fingers 210. The opposite end of the passageway 322 is in communication with a vacuum source (not shown). When the position of the fingers 210 is adjusted, the vacuum source is engaged to provide vacuum within the recess 324 of the housing 318. The vacuum within the recess 324 holds the fingers 210 in their adjusted position until all of the fingers 210 are properly positioned. Once all of the fingers 210 are placed in their predetermined positions, the locking mechanism may lock the fingers 210 in their predetermined positions in the locked position, and the vacuum source may be disengaged.

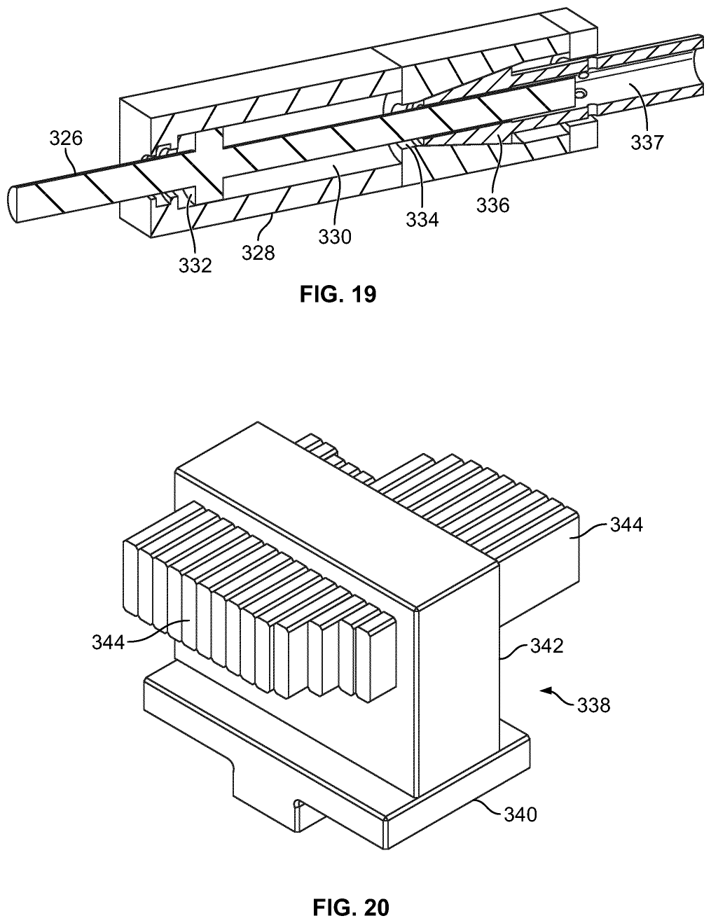

In another implementation, the apparatus 10 may provide a locking mechanism utilizing a collet mechanism for locking the fingers 210 in the locked position, as shown in FIG. 19. In this implementation, each finger 326 may be disposed in an individual housing 328. The housing 328 may have a cylindrical aperture 330 extending through the housing 328, and the finger 326 may have a cylindrical configuration to be received and partially disposed within the aperture 330 in the housing 328. The finger 326 has a diameter smaller than the aperture 330 in the housing 328; however, the finger 326 provides a piston 332 with a diameter that is similar in size to the aperture 330 to support movement of the finger 326 along the aperture 330 of the housing 328. The aperture 330 has a tapered narrowing portion 334 at one end of the housing 328, wherein a tapered narrowing collet 336 complementarily engages the narrowing portion 334 of the aperture 330. A cylindrical aperture 337 passes through the collet 336 for partially receiving the finger 326, and one end of the collet 336 extends outward from the housing 328. When in the unlocked position, the narrowing portion of the collet 336 is moved away from the narrowing portion 334 of the aperture 330 in the housing 328 such that the collet 336 does not apply pressure to the finger 326, thereby allowing the finger 326 to be adjusted and moved to a predetermined position. Once the position of the finger 326 is properly positioned, the narrowing portion of the collet 336 is pushed into the narrowing portion 334 of the aperture 330 thereby allowing the collet 336 to apply pressure to the finger 326 to lock the finger 326 in the locked position.

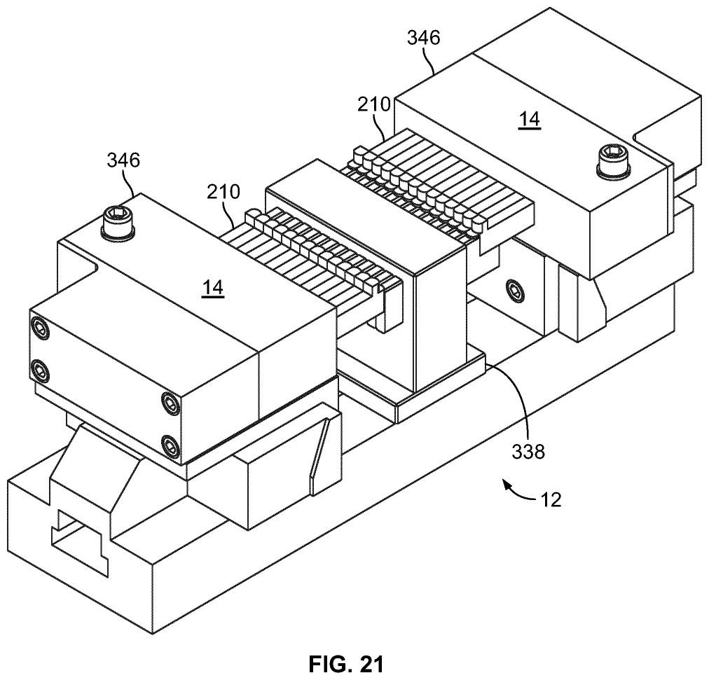

In another implementation, the apparatus 10 provides the adjustment mechanism 21 in the form of a finger-setter 338 for adjusting the fingers 210 of a gripper jaw 14 into their desired position. As shown in FIGS. 20 and 21, the finger-setter 338 may provide a platform 340 and a housing 342, wherein the housing 342 holds a plurality of finger setting bars or fingers 344 that extend from each side of the housing 342. The position of the finger setting bars 344 may be set manually using a manual locking mechanism or automatically through the use of drives, actuators, and/or other automatic locking mechanisms. The finger setting bars 344 move between an unlocked position, wherein the position of the finger setting bars 344 may be adjusted, and a locked position, wherein the finger setting bars 344 are locked into predetermined positions.

The finger-setter 338 is used to position the fingers 344 into a predetermined position. As shown in FIG. 21, the finger-setter 338 may be used in the work-holding device 12 between gripper jaws 14. Each gripper jaw 14 has its own set of fingers 210 that extend from a housing 346 of each gripper jaw 14. As described throughout the present disclosure, various structures and methods may be utilized to move the fingers 210 between the locked and unlocked positions. Here, the finger-setter 338 is placed between the gripper jaws 14 such that the fingers 210 can engage the finger setting bars 344. To move the fingers 210 to their proper position, the finger-setter 338 may manually set and lock the finger setting bars 344 in a predetermined position. In the alternative, the finger setting bars 344 may move automatically to their predetermined positions once positioned between the gripper jaws 14. When the finger-setter 338 is placed between the gripper jaws 14, the fingers 210 engage the finger setting bars 344 in the unlocked position so that the fingers 210 mirror the position of the finger setting bars 344. Once the fingers 210 are in position, the fingers 210 are locked into the locked position. The finger-setter 338 is then removed, and the work-holding device 12 is then ready for use.

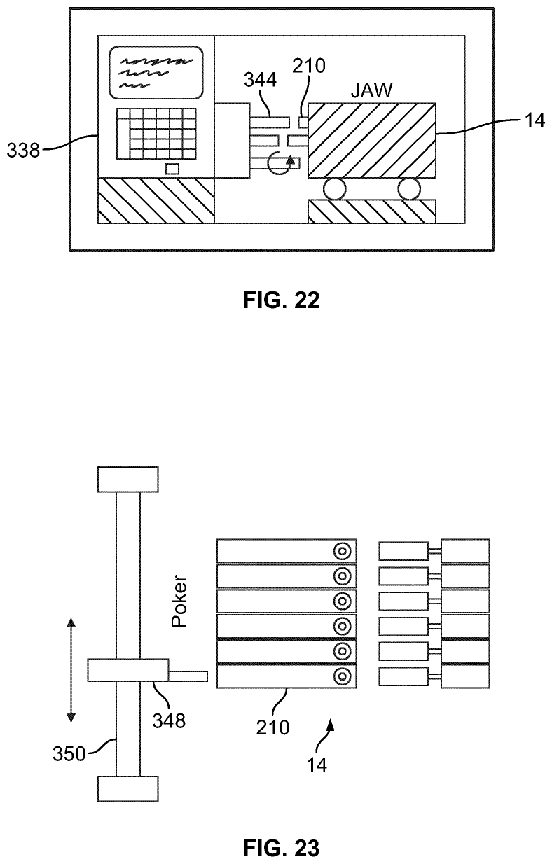

In another implementation, the finger-setter 338 may be a programmable device that engages the gripper jaw 14 in a precise fixture that locates and holds the gripper jaw 14 while the fingers 210 are being properly adjusted, as seen in FIG. 22. The finger-setter 338 provides saved profiles, wherein a user would select the desired profile based on the workpiece 16. The finger-setter 338 would automatically position the finger setting bars 344, and the finger setting bars 344 would engage and move the fingers 210 into a predetermined position when in the unlocked position. Once positioned, the fingers 210 would then be locked in the locked position.

Other adjustment mechanisms 21 may include a programmable linear actuator or poker 348 mounted on a transverse rail 350, as shown in FIG. 23. The programmable poker 348 would have a number of profiles saved in a programmable controller, and the user would select the profile based on the workpiece 16. The poker 348 moves along the rail 350 and engages each finger 210 separately. The poker 348 pushes the finger 210 inward towards its predetermined position based on the selected profile when the finger 210 is in the unlocked position. Once properly positioned, the finger 210 is locked into position in the locked position. The poker 348 would then move to and adjust the next finger 210 until all of the fingers 210 were adjusted.

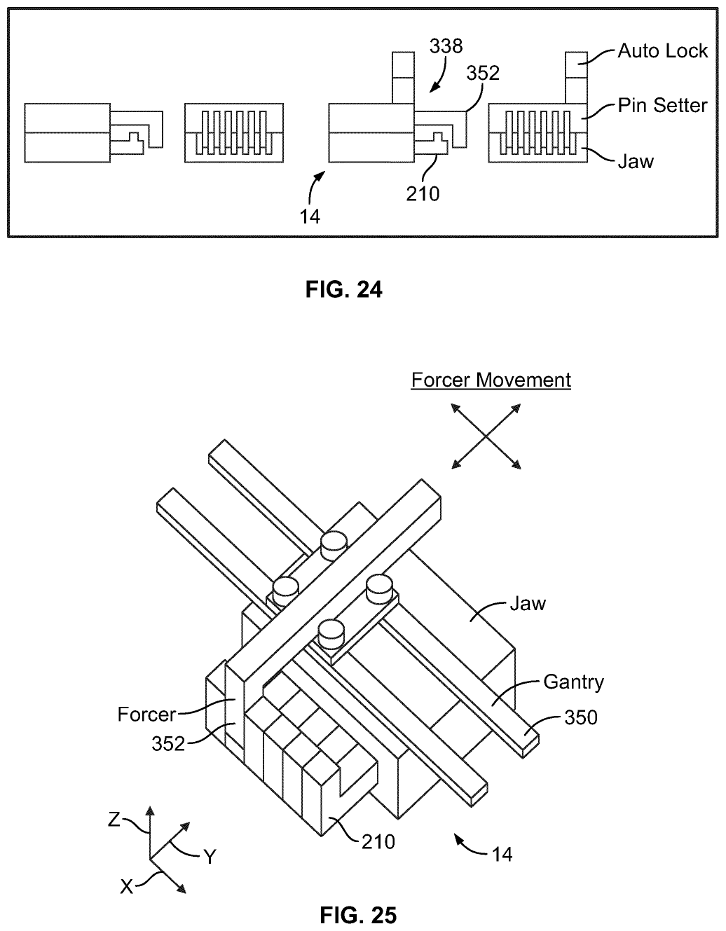

In another example adjustment mechanism, the finger-setter 338 could be placed on the top of the gripper jaw 14, as shown in FIG. 24. Here, the finger-setter 338 provides fingers 352 that extend over the fingers 210 and pull the fingers 210 inward into their desired position. The fingers 352 could preset into a predetermined position, or the finger-setter 338 could be programmable such that the finger 352 actively moves when positioning the fingers 210. If programmable, the finger-setter 338 would have the ability to store predetermined profiles of the fingers 210 into a programmable controller. The locking of the fingers 210 between the locked and unlocked positions could be done manually or automatically and could be done by the gripper jaw 14 and/or the finger-setter 338. In another implementation, the finger-setter 338 with fingers 352 could be mounted to the transverse rail 350 to provide three axes of movement as well to adjust the position of the fingers 210, as shown in FIG. 25.

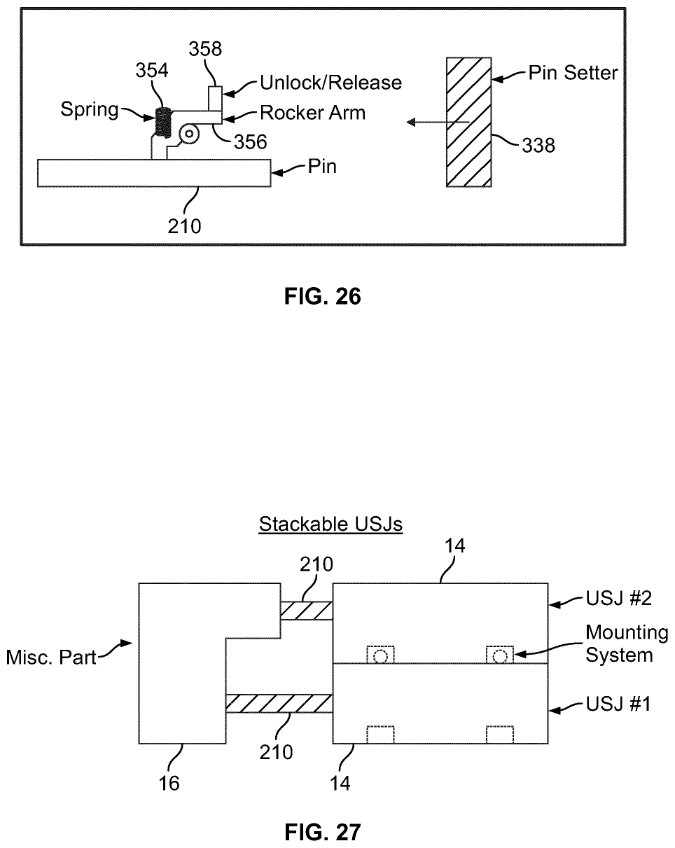

In other implementations, the locking mechanism of the apparatus 10 may include the temporary locking of individual fingers 210 until all of the fingers 210 are adjusted. As shown in FIG. 26, a compression spring 354 biases a pivoting rocker arm 356 down onto the finger 210 in order to hold the finger 210 in place. The force applied by the rocker arm 356 onto the finger 210 is greater than the friction force between adjacent fingers 210. A release lever 358 can engage the rocker arm 356 to pivot the rocker arm 356 away from the finger 210 thereby allowing the finger 210 to be adjusted into the desired position by the finger-setter 338. Once the finger 210 is in position, the release lever 358 is released to allow pressure back on the finger 210. Once the fingers 210 are in position, the locking mechanism moves to the locked position.

FIG. 28 illustrates a perspective view of a device 400 for holding a workpiece, FIG. 29 illustrates another perspective view of the device 400, in accordance with an example implementation. The device 400 includes a housing 402 sandwiched or interposed between a fixed clamping plate 404 and a movable clamping plate 406. The device 400 represents one side of a workpiece holding apparatus, and a second device similar to the device 400 can be used such that the workpiece 16 can be secured between the two devices (see e.g., FIGS. 1, 21).

The device 400 further includes a plurality of fingers 408 resting against a surface of the housing 402. Similar to the fingers described above, the fingers 408 can slide longitudinally along the z-axis of coordinate system 409. Each finger of the fingers 408 is individually-actuated, e.g., manually or via any of the actuation mechanisms described above.

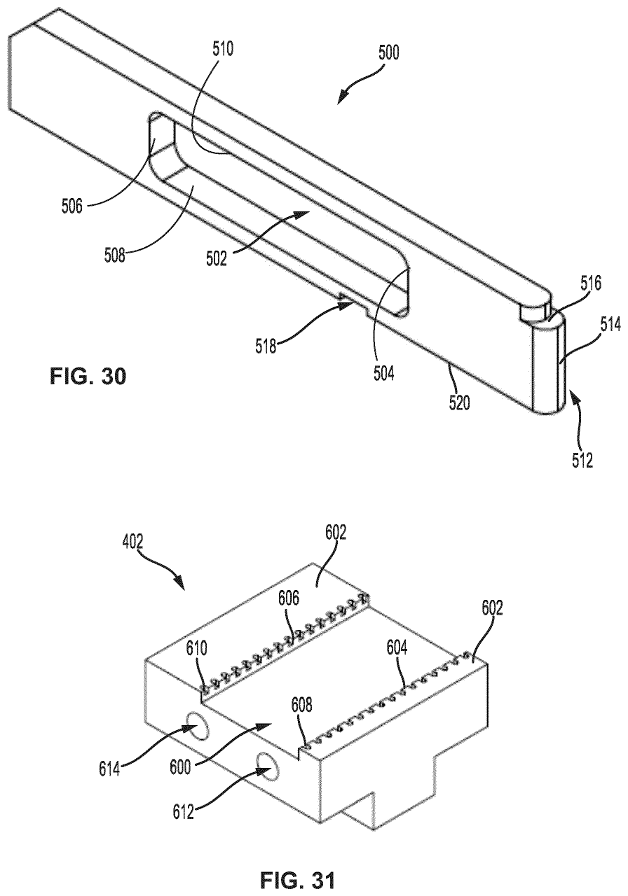

FIG. 30 illustrates a perspective view of a finger 500 of the fingers 408, in accordance with an example implementation. The finger 500 has a slot 502 configured as a through-window or generally-rectangular through-hole. The slot 502 is bounded by interior distal surface 504, interior proximal surface 506, a first interior lateral surface 508, and a second interior lateral surface 510. The first interior lateral surface 508 can be referred to as an interior bottom surface, and the second interior lateral surface 510 can be referred to as an interior top surface.

In an example, the finger 500 has a substantially rounded end 512 having an extended or axially-protruding portion 514 and a recessed portion 516, which are used to engage the workpiece 16. The finger 500 further has a keyway 518 formed as a recess in a surface 520 of the finger 500, where the keyway 518 is configured to engage with a slidable component as described below.

FIG. 31 illustrates a perspective view of the housing 402. The housing 402 has a recessed area 600 formed as depression relative to a top surface 602 of the housing 402. The housing 402 further includes a first edge 604 and a second edge 606 opposite the first edge 604. The edges 604, 606 are formed at the transition from the top surface 602 to the recessed area 600. The edges 604, 606 include a plurality of opposite slots such as slot 608 and slot 610. Opposite slots of each pair of opposite slots, e.g., the slots 608, 610, are configured as receptacles that receive a guide rail.

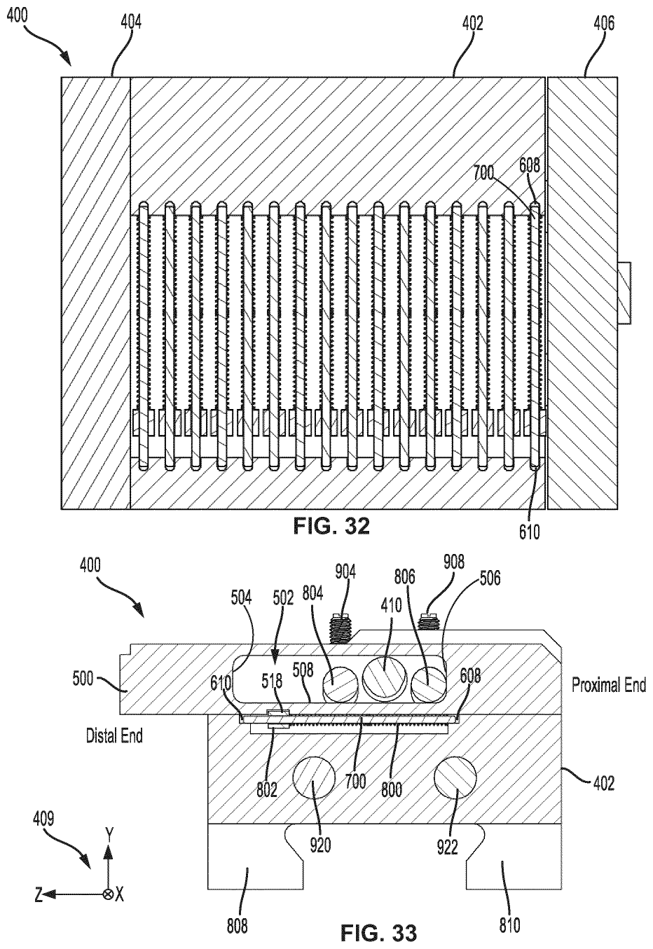

FIG. 32 illustrates a partial cross-sectional top view of the device 400 showing guide rails mounted to the housing 402, and FIG. 33 illustrates a cross-sectional side view of the device 400 showing engagement of the finger 500 with a guide rail 700, in accordance with an example implementation. As shown in FIG. 33, the device 400 includes several guide rails, one guide rail for each finger, that facilitate longitudinal motion of the fingers 408. As an example, the guide rail 700 is received in the slots 608, 610 and facilitates movement of the finger 500. The guide rails can be configured as generally-cylindrical components.

Referring to FIG. 33, the device 400 includes at least one spring, such as spring 800 disposed about the guide rail 700. Further, the device 400 includes a slidable component 802 disposed about the guide rail 700. In an example, the slidable component 802 is a cylindrical component that is hollow such that the guide rail 700 is disposed therethrough, and the slidable component 802 can slide about the guide rail 700.

Further, the slidable component 802 engages with the keyway 518 of the finger 500, i.e., the slidable component 802 is disposed partially within the keyway 518. A distal end of the spring 800 rests against the slidable component 802 and is movable therewith, whereas a proximal end of the spring 800 is fixedly resting against the interior surface of the housing 402. With this configuration, the spring 800 applies a biasing force on the finger 500 in the distal direction, causing the finger 500 to assume the illustrated extended position.

With this configuration, the finger 500 is spring-loaded. Upon an actuator moving the finger 500 in the proximal direction (to the right in FIG. 33 in the negative z-axis direction) against the biasing force of the spring 800, the finger 500 causes the slidable component 802 to slide in the proximal direction along with the finger 500 due to its engagement with the keyway 518 of the finger 500. As a result, the spring 800 is compressed. Once an actuation force pulling the finger 500 in the proximal direction is removed, the spring 800 pushes the finger 500 back to the position shown in FIG. 33. In the configuration illustrated in the figures, each finger has a corresponding guide rail and a respective spring disposed about the respective guide rail.

Once the fingers 408 are actuated or adjusted longitudinally to a particular configuration that matches a desired shape of the workpiece 16, the device 400 includes mechanisms that retain the fingers 408 and lock them in position.

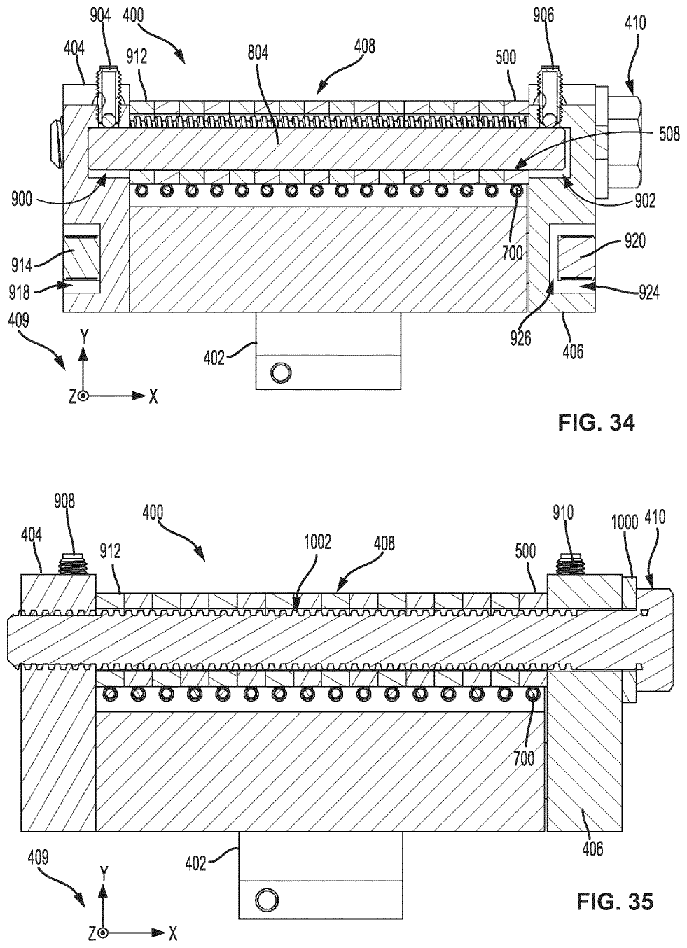

FIG. 34 illustrates a cross-sectional front view of the device 400, in accordance with an example implementation. Referring to FIGS. 33-34 together, respective slots of the fingers 408, e.g., the slot 502 of the finger 500, receive therethrough two retaining dowels: a first retaining dowel 804 and a second retaining dowel 806. The retaining dowels 804, 806 extend transversely with respect to the fingers 408 (see for example the retaining dowel 804 in FIG. 34) and are configured to retain the fingers 408 such that the fingers 408 are precluded from moving along the y-axis and precluded from rotating or rocking about the x-axis during operation of the device 400.

Referring to FIG. 34, the retaining dowels 804, 806 extend transversely and are disposed between the fixed clamping plate 404 and the movable clamping plate 406. Particularly, the fixed clamping plate 404 has a dowel cavity 900 and the movable clamping plate 406 has a respective dowel cavity 902. A first end of the retaining dowel 804 extends within the dowel cavity 900 and contacts the interior surface of the fixed clamping plate 404 such that the fixed clamping plate 404 preludes the retaining dowel 804 from moving transversely in the negative x-axis direction (to the left in FIG. 34). A second end of the retaining dowel 804 extends within the dowel cavity 902. Further, the retaining dowel 804 rests against the interior bottom surfaces of the slots of the fingers 408, e.g., the first interior lateral surface 508 of the slot 502 of the finger 500.

The device 400 includes adjusting set screws that can move the retaining dowels 804, 806 toward the interior bottom surfaces of the respective slots of the fingers 408. For example, the device 400 includes a first adjusting set screw 904 and a second adjusting set screw 906. Rotating the adjusting set screws 904, 906 in a given direction, e.g., clockwise, causes them to move toward the retaining dowel 804, and in turn pressing the retaining dowel 804 with a light pressure against the interior bottom surfaces of the slots, e.g., the first interior lateral surface 508, of the fingers 408.

Similarly referring to FIGS. 28, 33, the device 400 includes a third adjusting set screw 908 and a fourth adjusting set screw 910 that can be rotated and moved toward the retaining dowel 806 until it contacts the interior bottom surfaces of the respective slots, e.g., the first interior lateral surface 508 of the slot 502. The retaining dowel 806 then applies pressure against the interior bottom surfaces, e.g., the first interior lateral surface 508, of the slots of the fingers 408.

The retaining dowels 804, 806 are spaced-apart along the z-axis with respect to the fingers 408 (i.e., spaced-apart along a length of the finger 500). Thus, the retaining dowels 804, 806 balance each other with respect to applying pressure on the fingers 408. Because of the retaining dowels 804, 806 being spaced-apart along the z-axis, while contacting and applying pressure on the fingers 408, the fingers 408 are precluded from moving along the y-axis and at the same time, they are precluded from rocking or rotating about the x-axis.

In addition to retaining the fingers 408 in the y-axis direction and precluding them from rotating about the x-axis, the retaining dowels 804, 806 also limit respective strokes of the fingers 408 in the z-axis direction. For example, referring to the finger 500, when the finger 500 is pulled via an actuator in the proximal direction (i.e., negative z-axis direction), the finger 500 can move until the interior distal surface 504 contacts the retaining dowel 804, which then precludes further movement in the negative z-axis direction. When the finger 500 is released, the spring 800 pushes it in the distal direction (i.e., the positive z-axis direction) until the interior proximal surface 506 contacts the retaining dowel 806, which then precludes further movement in the positive z-axis direction.

Additionally, the fingers 408 are retained in the x-axis direction by way of the fixed clamping plate 404 and the movable clamping plate 406. Referring to FIGS. 28, 33, 34 together, the device 400 includes a locking bolt 410 mounted transversely through the respective slots of the fingers 408. The locking bolt 410 is mounted between the retaining dowels 804, 806 as shown in FIG. 33.

Once the fingers 500 are actuated or adjusted longitudinally (along the z-axis) to a particular configuration that matches a desired shape of the workpiece 16, the locking bolt 410 is used to move the movable clamping plate 406 along the x-axis to press it against the finger 500. The finger 500 in turn presses on a neighboring finger, and so forth, until finger 912, disposed at the opposite end of the fingers 408 relative to the finger 500, is pressed against the fixed clamping plate 404. As a result, the fingers 408 are secured in position in the particular configuration.

As shown in FIG. 34, the fixed clamping plate 404 contacts the housing 402 and the finger 912. Referring to FIGS. 29, 34 together, the fixed clamping plate 404 is coupled to the housing 402 via a shoulder bolt 914 and shoulder bolt 916.

The shoulder bolts 914, 916 have an unthreaded, cylindrical shoulder section and a threaded bottom portion. The threaded bottom portions of the shoulder bolts 914, 916 respectively engage with threaded holes 612, 614 in the housing 402 shown in FIG. 31. Further, the fixed clamping plate 404 includes bolt cavities that receive respective heads of the shoulder bolts 914, 916. For instance, the fixed clamping plate 404 includes a bolt cavity 918 shown in FIG. 34 that receives the shoulder bolt 914 therein. As shown in FIG. 34, the head of the shoulder bolt 914 bears against or contacts the interior surface of the fixed clamping plate 404.

The movable clamping plate 406 is disposed on the opposite side of the housing 402 relative to the fixed clamping plate 404 and is configured to contact the finger 500. The movable clamping plate 406 might not contact the housing 402 and is movable relative thereto. Referring to FIGS. 28, 34, the movable clamping plate 406 is coupled to the housing 402 via respective shoulder bolts 920, 922.

The movable clamping plate 406 includes bolt cavities that receive respective heads of the shoulder bolts 920, 922. For instance, the movable clamping plate 406 includes a bolt cavity 924 shown in FIG. 34 that receives the shoulder bolt 920 therein. In contrast with the shoulder bolt 916, the head of the shoulder bolt 920 does not bear against the movable clamping plate 406 when the movable clamping plate 406 is in the clamping position shown in FIG. 34. Rather, a gap 926 exists between the head of the shoulder bolt 920 and the interior surface of the movable clamping plate 406. The gap 926 (and a similar gap for the shoulder bolt 922) allows the movable clamping plate 406 to move along the x-axis to unclamp the fingers 408.

FIG. 35 illustrates another cross-sectional front view of the device 400, in accordance with an example implementation. The cross-sectional view of FIG. 35 is taken at a different plane relative to the cross-sectional view in FIG. 34. Particularly, referring to FIG. 33, the plane of the cross-sectional view in FIG. 35 passes through the locking bolt 410, in between the retaining dowels 804, 806.

The device 400 includes a washer 1000 disposed between a head of the locking bolt 410 and the movable clamping plate 406. The locking bolt 410 extends through a hole in the movable clamping plate 406, through respective slots of the fingers 408 (e.g., the slot 502 of the finger 500), and through a respective hole in the fixed clamping plate 404.

The movable clamping plate 406 is mounted or coupled to the locking bolt 410 such that linear motion of the locking bolt 410 causes the movable clamping plate 406 to move therewith. In an example, the locking bolt 410 is configured as a lead screw, such that rotary motion of the locking bolt 410 about the x-axis causes it to translate or move linearly along the x-axis.

Particularly, in an example, the locking bolt 410 can have male threads 1002 formed on an exterior peripheral surface of the locking bolt 410. For instance, the male threads 1002 can be Acme or trapezoidal threads. However, other types of threads (e.g., square threads) may be used.

As depicted in FIG. 35, the hole in the fixed clamping plate 404 through which the locking bolt 410 extends is tapped, i.e., has female threads on an interior surface of the fixed clamping plate 404 that bounds the hole. The female threads of the fixed clamping plate 404 engage with the male threads 1002 of the locking bolt 410. With this configuration, when the locking bolt 410 is rotated, it translates along the x-axis relative to the fixed clamping plate 404.

On the other hand, the hole in the movable clamping plate 406 through which the locking bolt 410 extends is not tapped. Rather, the movable clamping plate 406 is coupled or mounted to the locking bolt 410 and moves therewith.

Once the fingers 408 are actuated to their desired positions that match a shape of the workpiece 16, the locking bolt 410 is used to clamp the fingers 408 in position. The device 400 is shown in FIG. 35 in a clamped position where the locking bolt 410 is rotated in a given rotational direction (e.g., clockwise), causing the locking bolt 410 and the movable clamping plate 406 mounted thereto to move linearly in the negative x-axis direction toward the fingers 408. The movable clamping plate 406 then contacts the finger 500, and further motion in the negative x-axis direction causes the movable clamping plate 406 to squeeze the fingers 408 against the fixed clamping plate 404. This way, the fingers 408 are locked in position.

Thus, the locking bolt 410 of the device 400 traverses the fingers 408 through their respective slots (e.g., through the slot 502 of the finger 500). With the configuration of the device 400 where the locking bolt 410 traverses the fingers 408 through their respective slots, the force that the locking bolt 410 may apply to the fingers 408 is transmitted through the center of the fingers 408. Thus, in some examples, the locking bolt 410 may be more effective in clamping the fingers 408.

In examples, it may be desirable to reset the configuration of the fingers 408 to allow a user to reconfigure them for a workpiece of different geometry. In these examples, the device 400 can be reset by unclamping the fingers 408. Particularly, the locking bolt 410 is rotated in an opposite direction (e.g., counter-clockwise) so that it moves in the positive x-direction and the movable clamping plate 406 moves therewith, relieving pressure on the fingers 408.

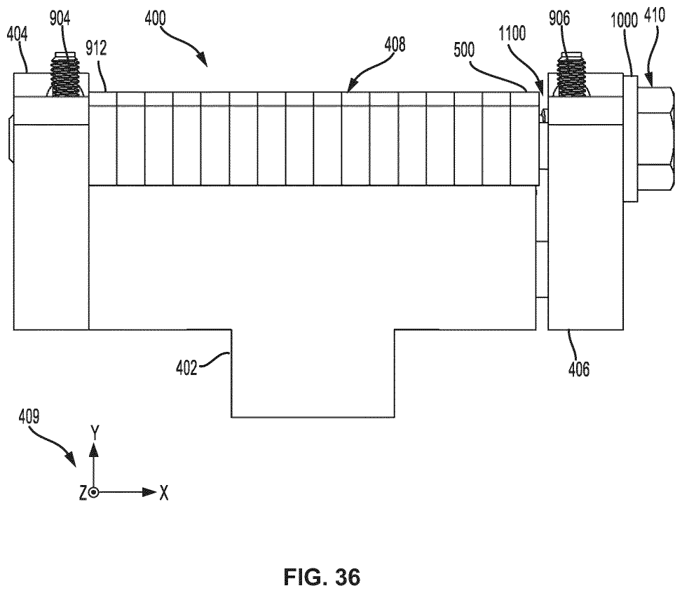

FIG. 36 illustrates a front view of the device 400 in an unclamped position, in accordance with an example implementation. As depicted in the FIG. 36, the locking bolt 410 has been rotated such that it moves outward in the positive x-direction, thereby causing the movable clamping plate 406 to move therewith away from the finger 500. In the unclamped position, a gap 1100 forms between movable clamping plate 406 and the finger 500. This way, the fingers 408 are no longer squeezed between the fixed clamping plate 404 and the movable clamping plate 406, and are released in the x-axis direction.

Further, the adjusting set screws 904, 906, 908, 910 can also be rotated (e.g., counter-clockwise) to move outward in the positive y-axis direction and relieve pressure on the interior bottom surfaces of the fingers 408 (e.g., the first interior lateral surface 508 of the finger 500). This way, the retaining dowels 804, 806 no longer apply a force on the fingers 408, and the fingers 408 are free to move along the z-axis with no hindrance from the retaining dowels 804, 806.

The fingers 408 can then be actuated to different configuration that matches the geometry of a different workpiece as desired.

In examples, the housing 402 can be configured to match a vise of a particular machine (e.g., a particular lathe). For example, referring to FIG. 33, the housing 402 can have leg 808 and leg 810. The legs 808, 810 have a particular configuration as depicted in FIG. 33 that might match a particular vise to facilitate mounting the housing 402, and the device 400, to the vise. In other examples, however, the housing can be made generic or with an adaptor configuration that facilitates mounting the housing to multiple vise configurations.

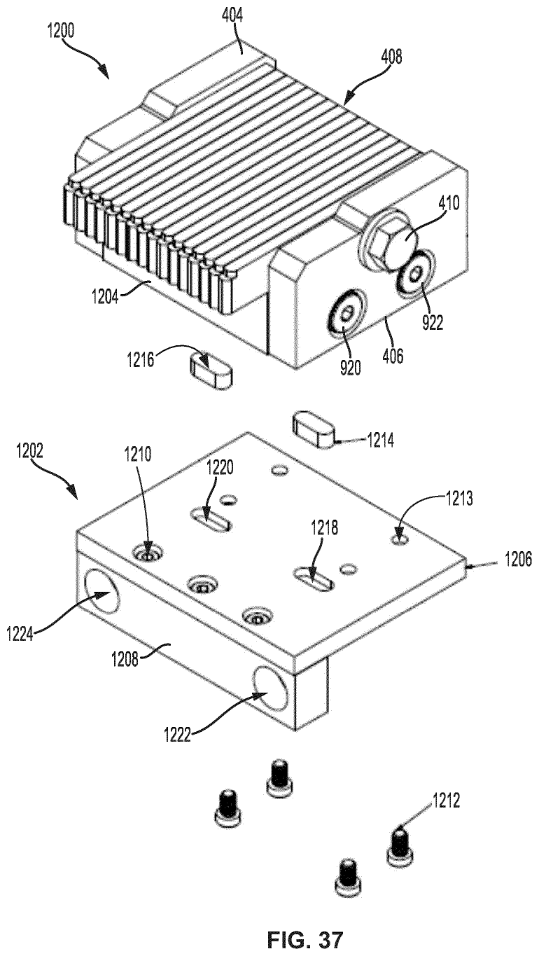

FIG. 37 illustrates an exploded view of a device 1200 having an adaptor assembly 1202, in accordance with an example implementation. Components of the device 1200 that are similar to components of the device 400 are designated with the same reference numbers.

The device 1200 includes a housing 1204 that is configured to be a universal housing, which is not machine- or vise-specific. The adaptor assembly 1202 is configured to couple the housing 1204 to multiple types of vises with various configurations.

The adaptor assembly 1202 includes an adaptor plate 1206 and an adaptor block 1208. In an example, the adaptor plate 1206 is coupled to the adaptor block 1208 via plurality of dowels and mounting screws such as mounting screw 1210.

The adaptor plate 1206 is coupled to the housing 1204 via mounting screws 1212 disposed through holes such as hole 1213 in the adaptor plate 1206 and corresponding holes in the housing 1204. Further, keys such as key 1214 and key 1216 can be used to form a keyed joint that secures the housing 1204 to the adaptor plate 1206 to prevent relative movement therebetween under forces resulting from machining the workpiece 16. The keys 1214, 1216 can be disposed partially in respective keyways 1218, 1220 in the adaptor plate 1206 and partially in housing keyways (not shown) formed in the housing 1204.

The adaptor block 1208 is used to couple the device 1200 to a vise of a machine. For example, as depicted in FIG. 37, the adaptor block 1208 has a bolt pattern including a hole 1222 and a hole 1224 that can couple the adaptor block 1208 to a Kurt vise via fasteners. A Kurt vise is used herein as an example for illustration only. The adaptor block 1208 can be replaced with other adaptor blocks with a different bolt pattern that allows the adaptor plate 1206 and the device 1200 coupled thereto to be mounted to any type of vise.

The configuration of the fingers 408 shown and described herein are not meant to be limiting. The configuration of the fingers 408 can vary to accommodate the different shapes and configuration of workpieces. In one example, the fingers 408 can have replaceable tips that can removed and replaced with other tips to match or accommodate different workpieces.

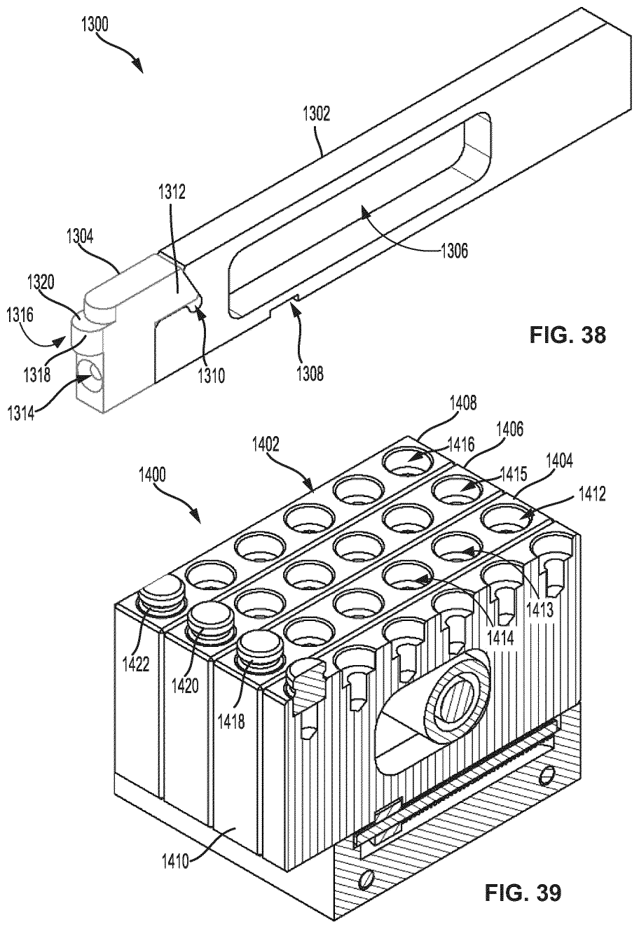

FIG. 38 illustrates a perspective view of a finger 1300 having a finger body 1302 and a replaceable tip 1304, in accordance with an example implementation. The finger body 1302 includes a slot 1306 that is similar to the slot 502 of the finger 500. The finger body 1302 also includes a keyway 1308 that is similar to the keyway 518 of the finger 500.

The finger 1300 differs from the finger 500 in that it has the replaceable tip 1304, which can be removed and changed with another tip based on the type, material, and/or shape of the workpiece to be held. In an example implementation, the finger body 1302 includes a cleat 1310 that is configured as a receptacle of a portion 1312 (e.g., L-shaped) of the replaceable tip 1304, which dove tails into the cleat 1310. While replaceable tips such as the replaceable tip 1304 may have different front end shape or configuration that matches a particular workpiece, they have a back end shape that is similar to that of the replaceable tip 1304 to facilitate mounting the replaceable tips to the finger body 1302.

The replaceable tip 1304 is mounted or coupled to the finger body 1302 via fastener 1314. Further, the back end of the replaceable tip 1304 interfaces with a front end surface of the finger body 1302. This way, during machining or working on the workpiece held by the finger 1300 and other fingers, the forces acting on the replaceable tip 1304 are transmitted to not only the fastener 1314 but also to the finger body 1302. This way, not the entire load is applied to the fastener 1314 alone; rather, the load is carried also by the finger body 1302.

As mentioned above, the replaceable tip 1304 can have a shape and/or material that are suitable for a particular workpiece. For example, the replaceable tip 1304 has a substantially rounded end portion 1316 having an extended or axially-protruding portion 1318 and a recessed portion 1320, which are used to engage the workpiece. Other replaceable tips can have other shapes, e.g., flat surfaces or protrusions shaped differently.

Further, the replaceable tip 1304 can be made of a material different from a respective material of the finger body 1302. For example, the replaceable tip 1304 is made of a softer material (e.g., brass) than the material (e.g., steel) of the finger body 1302. In this example, with the material of the replaceable tip 1304 being soft, damage to the workpiece may be avoided.

In an example, one or more of the fingers 408 may be configured similar to the finger 1300, while other may be configured similar to the finger 500.

In other example implementations, rather than the front end faces of the fingers contacting the workpiece, the top surfaces of the fingers may be configured to have an interface that facilitates mounting a fixture or attachment that is configured to hold onto the workpiece. In these examples, the front end faces of the fingers may be flat surfaces and might not contact the workpiece.

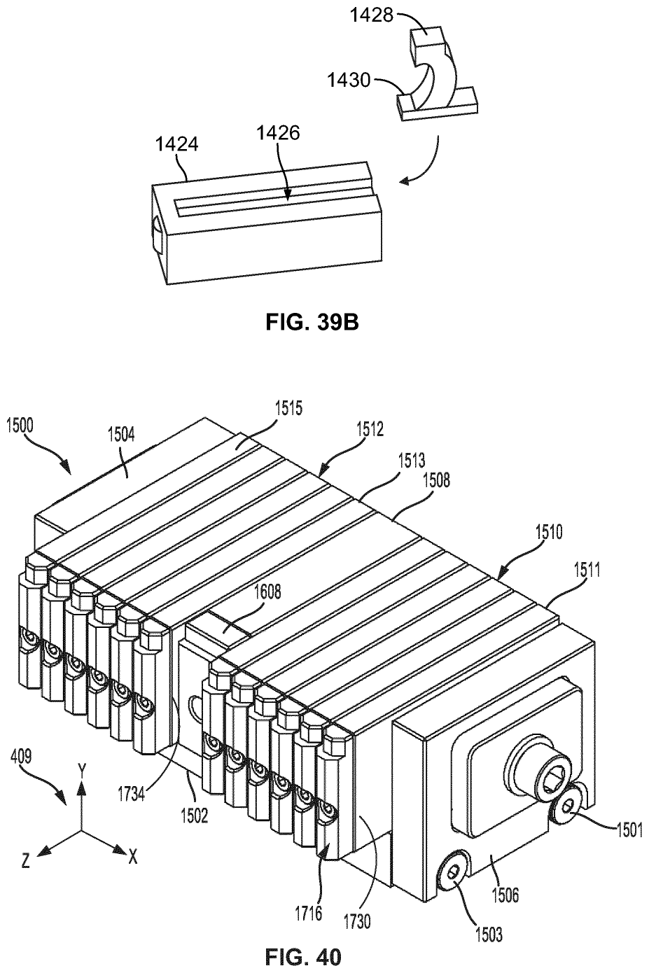

FIG. 39 illustrates a partial perceptive view of a device 1400 having a plurality of fingers 1402 configured to receive an attachment, in accordance with an example implementation. Three fingers 1404, 1406, and 1408 are shown in the partial view of FIG. 39. However, the device 1400 can have more fingers.

In an example, the fingers 1404-1408 may be wider compared to other fingers shown above, e.g., the fingers 500, 1300. The fingers 1404-1408 may have flat front end surfaces, such as flat front end surface 1410 of the finger 1404. In an example, the flat front end surfaces might not contact the workpiece to be held by the fingers 1402. Rather, the fingers 1402 have a top interface configured to receive an attachment that can then hold on to or grab the workpiece.

In the example implementation shown in FIG. 39, each of the fingers 1404-1408 has a pattern of pilot holes disposed at the top surface of the respective finger. For instance, the finger 1404 has multiple pilot holes such as pilot hole 1412, pilot hole 1413, and pilot hole 1414; the finger 1406 has multiple pilot holes such as pilot hole 1415; and the finger 1408 has multiple pilot holes such as pilot hole 1416.

In an example, the pilot holes of each finger can be disposed in a single row as shown in FIG. 39, and the pilot holes may be equispaced. In this example, the distance between the pilot hole 1412 and the pilot hole 1413 (e.g., the distance between their respective centers) is the same as the distance between the pilot hole 1413 and the pilot hole 1414. Further, in an example, the pilot holes of one finger may also be equidistant from their neighboring pilot holes of the adjacent finger. For example, the distance between the pilot hole 1412 and the pilot hole 1415 is the same as the distance between the pilot hole 1415 and the pilot hole 1416. As such, in this example implementation, the pilot holes form a pattern of uniform incrementation.

The pilot holes can form a universal pilot hole system or pattern that can facilitate mounting one or more attachments that can be used to hold onto any workpiece. For example, the pilot holes can be configured to receive removable studs, such as stud 1418, stud 1420, and stud 1422 that can be mounted therein (e.g., screwed).

Only three studs are shown; however, any number of studs can be attached or mounted to the fingers 1402 depending on the shape and configuration of the workpiece. Further, although the studs are shown as cylindrical components, in other example implementations, they can have other shapes and configurations. They can also have different heights depending on the shape and height of the workpiece. For a tall workpiece, taller studs can be used to increase the surface area of the workpiece with which the studs interface, such that the studs can grab onto the workpiece more stably or firmly.

Notably, the pattern of the pilot holes facilitates mounting the studs at different locations. For example, some of the studs can be moved back, while others remain near the front of the finger to accommodate the shape and different depths of a workpiece.

With this configuration, the fingers 1402, and particularly their top surfaces, operate as an attachment platform wherein one or more attachments (e.g., studs) or accessories can be mounted to the top surface of the fingers 1402. The attachments or accessories then facilitate interfacing with the workpiece and holding onto it.

In examples, rather than having discrete pilot holes as shown in FIG. 39, the fingers can be configured to have a track or channel that allows a stud or block to slide therein, thereby providing a continuum of positions rather than discrete positions.

FIG. 39B illustrates a perspective view of a finger 1424 having a channel or track 1426, in accordance with an example implementation. In an example, the track 1426 is configured as a T-shaped slot; however, other shapes can be used. Rather than screwing a stud in a pilot hole as described with respect to FIG. 39, a slidable block 1428 can be slidably mounted to the finger 1424. Particularly, the slidable block 1428 has a base 1430 configured to engage the track 1426 and slide or move longitudinally therein.

A user can slide the slidable block 1428 within the track 1426 until a desired position is reached. The user can then lock the slidable block 1428 in position via any locking means (a clip, screw or any type of fastener, friction, etc.). The slidable block 1428 can have any shape that matches a profile of the workpiece 16 and can be moved to a given position within the track 1426 based on a configuration of the workpiece.

It should be understood that the features of FIG. 38, 39 or 39B can also be used with the device 400 or any other device described herein. Similarly, features from any of the implementations described with respect to a particular device can be used with other devices described herein where applicable.

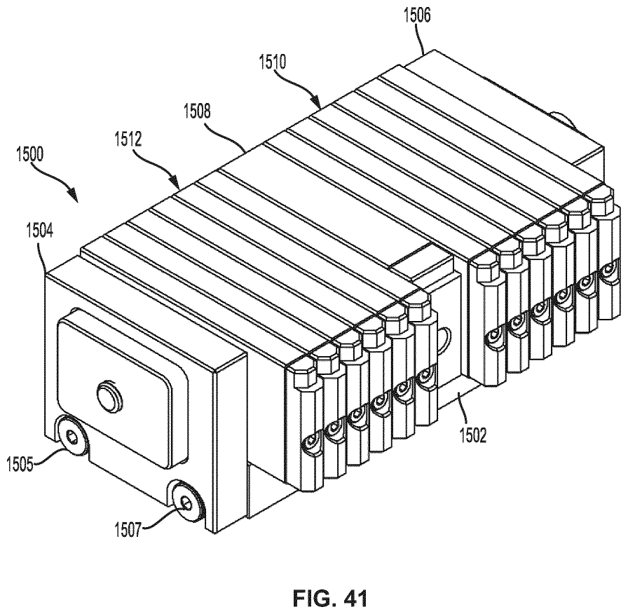

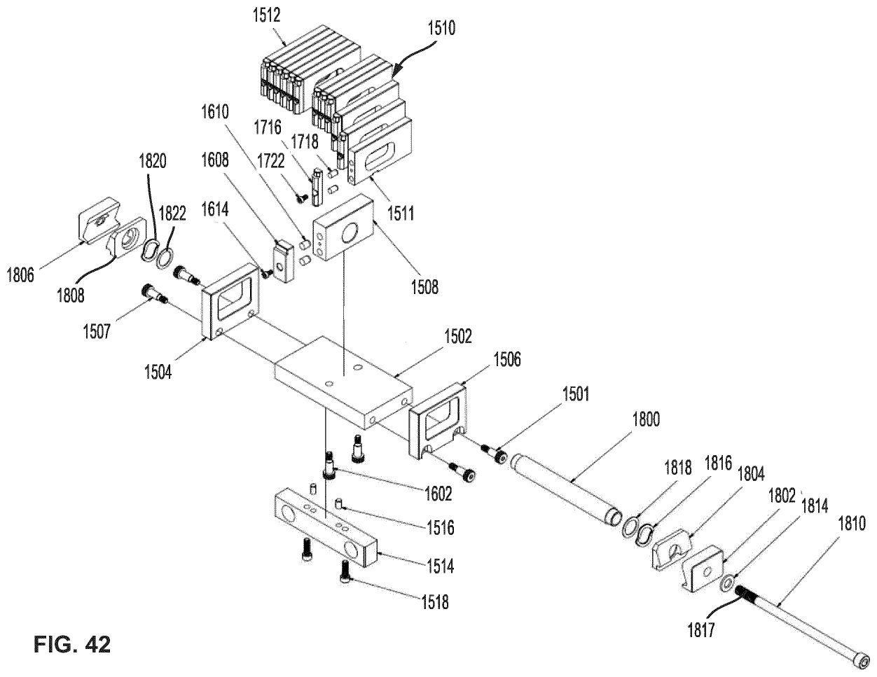

FIG. 40 illustrates a perspective view of a device 1500 for holding a workpiece, FIG. 41 illustrates another perspective view of the device 1500, and FIG. 42 illustrates an exploded perspective view of the device 1500, in accordance with an example implementation. FIGS. 40-42 are described together.

The figures depicting the device 1500 include the coordinate system 409 described above. The x-axis can be referred to as the transverse axis, and movement along the x-axis can be referred to as transverse motion (e.g., movement along the negative x-axis direction can be referred to as movement in a first transverse direction, while movement along the positive x-axis direction can be referred to as movement in a second transverse direction that is opposite the first transverse direction). Movement along the y-axis can be referred to as lateral motion (e.g., movement along the positive y-axis direction can be referred to as movement in a first lateral direction, while movement along the negative y-axis direction can be referred to as movement in a second lateral direction that is opposite the first lateral direction). Movement along the z-axis can be referred to as longitudinal motion (e.g., movement along the positive z-axis direction can be referred to as movement in a first longitudinal direction or distal direction, while movement along the negative z-axis direction can be referred to as movement in a second longitudinal direction or proximal direction that is opposite the first transverse direction).

Referring to FIGS. 40-42, the device 1500 includes a housing base plate 1502 sandwiched or interposed between a first fixed housing plate 1504 and a second fixed housing plate 1506.

The first fixed housing plate 1504 is coupled to the housing base plate 1502 via shoulder bolt 1501 and shoulder bolt 1503. Similarly, the second fixed housing plate 1506 is coupled to the housing base plate 1502 via shoulder bolt 1505 and shoulder bolt 1507 shown in FIG. 41.

The device 1500 represents one side of a workpiece holding apparatus. A second device similar to the device 1500 can be used such that the workpiece 16 can be secured between the two devices (see e.g., FIGS. 1, 21).

The device 1500 includes a rib 1508 fixedly-coupled to the housing base plate 1502. The rib 1508 is located at a center of the housing base plate 1502 between the first fixed housing plate 1504 and the second fixed housing plate 1506.

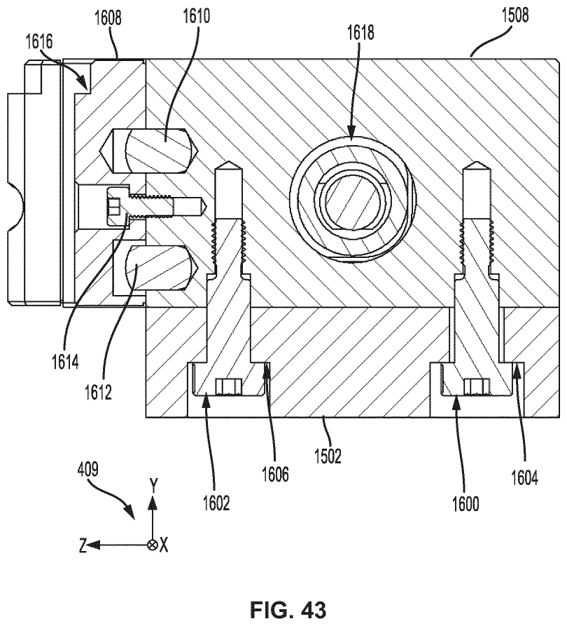

FIG. 43 illustrates a side cross-sectional view of the device 1500, in accordance with an example implementation. The cross section shown in FIG. 43 is taken a long a plane that passes through the rib 1508 looking in the negative x-axis direction of the coordinate system 409.

The rib 1508 is coupled to the housing base plate 1502 via shoulder bolt 1600 and shoulder bolt 1602. The heads of the shoulder bolts 1600, 1602 are received within respective cavities formed in the housing base plate 1502. Particularly, the housing base plate 1502 has a shoulder 1604 against which a head of the shoulder bolt 1600 rests and a shoulder 1606 against which a head of the shoulder bolt 1602 rests. The shoulders 1604, 1606 act as reference surfaces to locate the rib 1508 with respect to the housing base plate 1502. The shoulder bolts 1600, 1602 have threaded ends that engage threads tapped in respective bolt holes formed in the rib 1508.

Further, a rib tip 1608 is removably coupled to the rib 1508. Particularly, the rib 1508 can have a dowel hole configured to receive a first rib dowel 1610 and another dowel hole configured to receive a second rib dowel 1612. During assembly, the rib dowels 1610, 1612 are press-fitted in their respective dowel holes in the rib 1508. The rib tip 1608 has corresponding dowel holes that can be aligned with the rib dowels 1610, 1612 mounted to the rib 1508, and then the rib tip 1608 is slid about the rib dowels 1610, 1612 to be mounted to the rib 1508. A rib screw 1614 is then used to affix the rib tip 1608 to the rib 1508.

In examples, the rib tip 1608 is made of a material different from the material of the rib 1508. For instance, the rib tip 1608 can be made of a softer material compared to the material of the rib 1508. The rib 1508 can be made of hardened material.

In examples, the rib tip 1608 has a shoulder or step 1616. The rib 1508, and particularly the rib tip 1608 having the step 1616, operate as or provide a fixed reference surface for the workpiece 16 to rest on. The fingers can then be actuated to engage the workpiece 16. Different rib tips can have different step depths. For example, different rib tip can have respective step depths ranging from 0 (no step) to 12 mm or half inch.

The rib 1508 further has a through-hole 1618. The through-hole 1618 allows a retaining tube and clamping bolt (described below) to pass therethrough.

Referring back to FIGS. 40-42, the device 1500 further includes a first set of fingers 1510, such as finger 1511. The device 1500 also includes a second set of fingers 1512, such as finger 1513 and finger 1515. Both sets of fingers rest against a surface of the housing base plate 1502. The first set of fingers 1510 are interposed between the fixed housing plate 1506 and the rib 1508, whereas the second set of fingers 1512 are interposed between the fixed housing plate 1504 and the rib 1508.

In the example implementation shown in FIGS. 40-42, the first set of fingers 1510 have six fingers and the second set of fingers 1512 have respective six fingers. However, in other example implementations, more or fewer fingers can be used in each set.

The first set of fingers 1510 can be referred to as left-hand set of fingers as they are located to the left of the rib 1508 when looking in the positive z-axis direction. The second set of fingers 1512 can be referred to as right-hand set of fingers as they are located to the right of the rib 1508 when looking in the positive z-axis direction.

Similar to the fingers described above with respect to the device 400, the sets of fingers 1510, 1512 can slide longitudinally along the z-axis of the coordinate system 409. Each finger of the sets of fingers 1510, 1512 is individually-actuated, e g, manually or via any of the actuation mechanisms described above.

In an example, the sets of fingers 1510, 1512 can all be pushed back (in the negative z-axis direction) behind the rib tip 1608, such that the rib tip 1608 is the foremost portion in the positive z-axis direction. The workpiece 16 can then be located relative to the reference surface provided by the rib tip 1608, and some or all of the sets of fingers 1510, 1512 can then be pushed toward the workpiece 16 to grab it and secure it. Once the sets of fingers 1510, 1512 are in the desired position relative to the workpiece 16, they are clamped in the x-axis direction as described below.

The rib 1508 provides a non-moving surface for the sets of fingers 1510, 1512 fingers to be clamped against. As described below, a locking or retaining mechanism is used to squeeze the first set of fingers 1510 against the rib 1508 while squeezing the second set of the fingers 1512 against the rib 1508 in the distal direction. Advantageously, having the rib 1508 stationary in the middle between the sets of fingers 1510, 1512 allows larger and more consistent squeezing forces (along the x-axis direction) to be applied to the sets of fingers 1510, 1512.

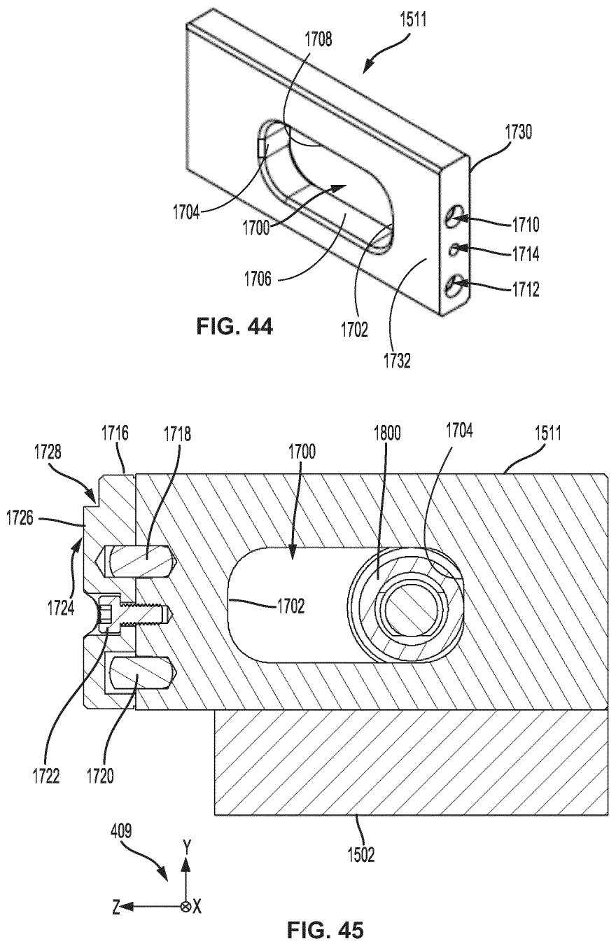

FIG. 44 illustrates a perspective view of a body of the finger 1511, and FIG. 45 illustrates a side cross-sectional view of the device 1500, in accordance with an example implementation. The cross section shown in FIG. 45 is taken a long a plane that passes through the finger 1511 looking in the negative x-axis direction of the coordinate system 409. The finger 1511 is described with respect to FIGS. 44-45 as a representative of the fingers of both sets. The other fingers can be configured similarly.

The body of the finger 1511 is formed as a generally rectangular block having a slot 1700 configured as a through-window (e.g., generally-rectangular through-hole with rounded corners). The slot 1700 is bounded by interior distal surface 1702, interior proximal surface 1704, a first interior lateral surface 1706, and a second interior lateral surface 1708. The first interior lateral surface 1706 can be referred to as an interior bottom surface, and the second interior lateral surface 1708 can be referred to as an interior top surface.

The finger 1511 has a first finger dowel hole 1710 and a second finger dowel hole 1712. The finger 1511 also includes a screw hole 1714. The finger dowel holes 1710, 1712 and the screw hole 1714 facilitate mounting a removable or replaceable finger tip.

For example, referring to FIG. 45, a replaceable finger tip 1716 can be coupled to the finger 1511. The replaceable finger tip 1716 is removable and can be replaced with another finger tip based on the type, material, and/or shape of the workpiece to be held.

To mount the replaceable finger tip 1716 to the finger 1511, a first finger dowel 1718 is press-fitted in the first finger dowel hole 1710 and a second finger dowel 1720 is press-fitted in the second finger dowel hole 1712. The replaceable finger tip 1716 has corresponding dowel holes that can be aligned with the finger dowels 1718, 1720 mounted to the finger 1511, and then the replaceable finger tip 1716 is slid about the finger dowels 1718, 1720 to be mounted to the finger 1511. A finger screw 1722 can be mounted through the screw hole 1714 and is used to affix the replaceable finger tip 1716 to the finger 1511 when screwed in.

The replaceable finger tip 1716 can have a shape and/or material that are suitable for a particular workpiece. For example, referring to FIGS. 40 and 45 together, the replaceable finger tip 1716 has a substantially rounded end portion 1724 having an extended or axially-protruding portion 1726 and a step or recessed portion 1728, which are used to engage a workpiece. Other replaceable tips can have other shapes, e.g., flat surfaces or protrusions shaped differently.

Further, the replaceable finger tip 1716 can be made of a material different from a respective material of the finger 1511. For example, the replaceable finger tip 1716 is made of a softer material (e.g., brass) than the material (e.g., steel) of the finger 1511. In this example, with the material of the replaceable finger tip 1716 being soft, damage to the workpiece may be avoided.

In an example, fingers of the first set of fingers 1510 (e.g., the finger 1511) are similar to fingers of the second set of fingers 1512 (e.g., the finger 1513). In other examples, however, the fingers of the first set of fingers 1510 are different from fingers of the second set of fingers 1512.

For example, one side of each finger may be roughened or made coarse via shot blasting or other surface treatments. However, the side of the fingers of the first set of fingers 1510 that is roughened is opposite to the side of the fingers of the second set of fingers 1512 that is roughened. As a particular example, the side that is facing toward the rib 1508 is made coarse. Thus, in this example, sides of the first set of fingers 1510 facing toward negative x-axis are made coarse, whereas sides of the second set of fingers 1512 facing toward the positive x axis are made coarse.

For instance, referring the finger 1511 in FIGS. 40 and 44, it has a side surface 1730 facing toward the second fixed housing plate 1506 and a side surface 1732 opposite the side surface 1730 and facing toward the rib 1508. In the case of the finger 1511, the side surface 1732 is made coarse, while the side surface 1730 is made soft or smooth. Conversely, the finger 1513 in FIG. 44 has a side surface 1734 facing toward the rib 1508 and another side surface opposite the side surface 1734 and facing toward the first fixed housing plate 1504. The side surface 1734 is made coarse, while the other side is made soft or smooth.

Having side surfaces of the fingers facing toward the rib 1508 made coarse increases the coefficient of friction between adjacent fingers. As the fingers are stacked together, a rough surface of one finger contacts a smooth or soft surface of the adjacent finger. Thus, a rough surface engages or deforms the non-treated smooth surface of the adjacent finger, thereby increasing the friction or grip force between the adjacent fingers.

With this configuration, after a finger is actuated (e.g., moved along the z-axis toward a workpiece), it may remain in the actuated position prior to applying side clamping forces (as described below) while adjusting the positions of the other fingers. This may allow the operator to move the fingers individually until the fingers are in a desired position, then the operator may apply the clamping forces. Further, when the operator applies the clamping force, the increased coefficient of friction between the fingers enhances retaining the fingers in the clamped or locked position.

Once the fingers are actuated or adjusted longitudinally to a particular configuration that matches a desired shape of the workpiece 16, the device 1500 includes a locking mechanism that retains the fingers and locks them in position.

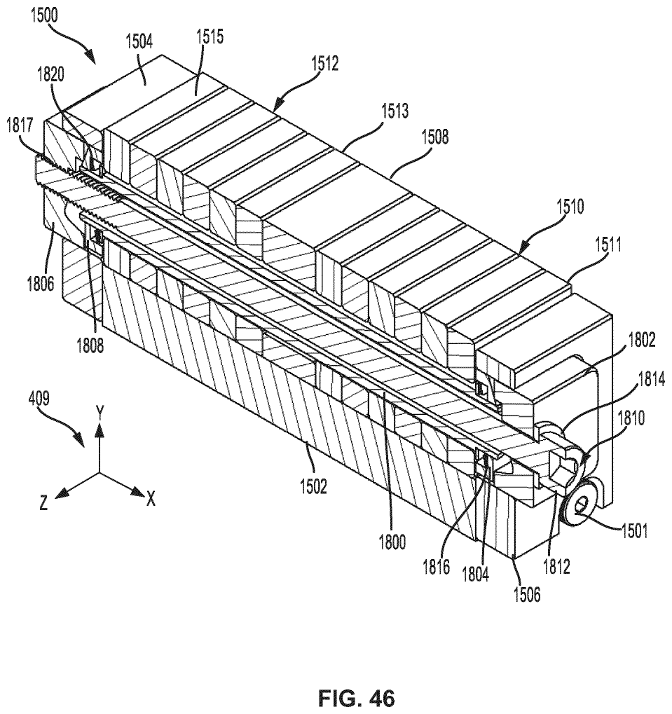

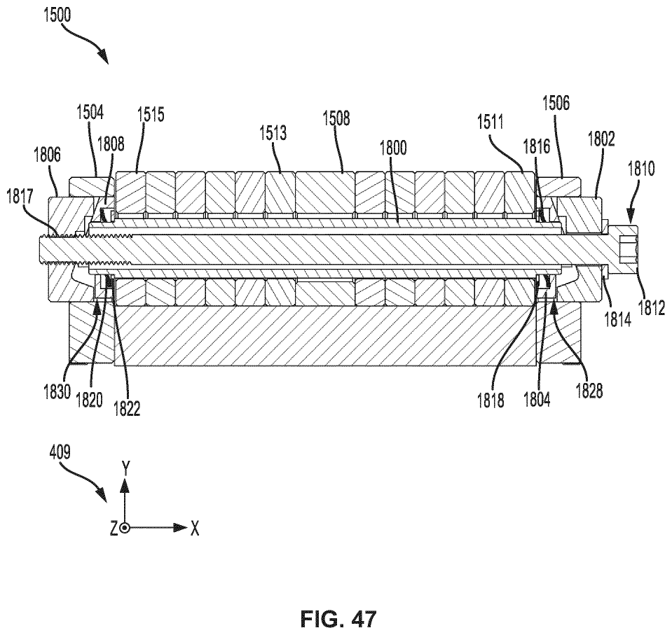

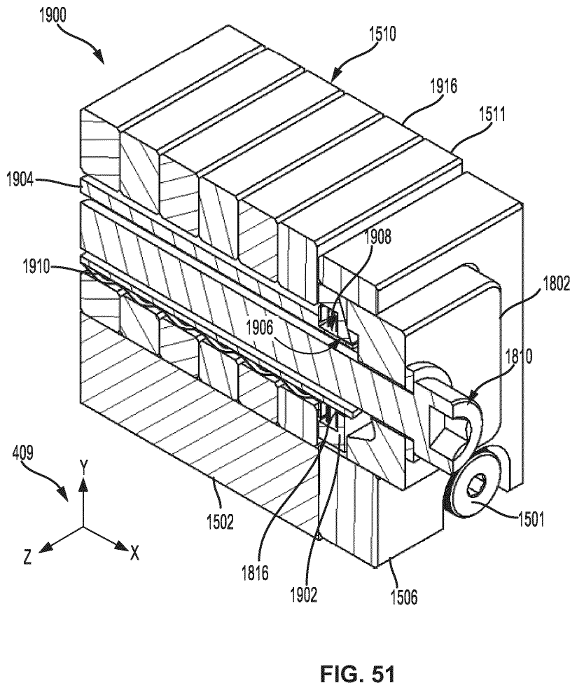

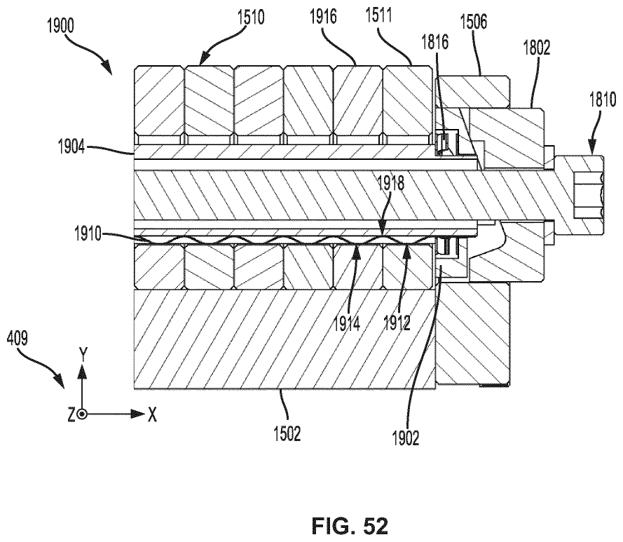

FIG. 46 illustrates a perspective cross-sectional front view of the device 1500, and FIG. 47 illustrates a cross-sectional front view of the device 1500, in accordance with an example implementation. The device 1500 includes a retaining tube 1800 (e.g., a hollow cylinder) disposed through respective slots of the fingers, e.g., the slot 1700 of the finger 1511, and through the through-hole 1618 of the rib 1508. As such, the retaining tube 1800 extends transversely with respect to the sets of fingers 1510, 1512 and the rib 1508. As described below, the retaining tube 1800 is configured to retain the sets of fingers 1510, 1512 such that the sets of fingers 1510, 1512 are precluded from moving along the y-axis. In an example, the retaining tube 1800 may also be configured to preclude the sets of fingers 1510, 1512 from rotating or rocking about the x-axis during operation of the device 1500 as described below with respect to FIGS. 51-52.

As best shown in FIG. 42, the fixed housing plates 1504, 1506 each has a respective through-window that is generally-rectangular. The retaining tube 1800 extends transversely and is disposed between the fixed housing plates 1504, 1506. The retaining tube 1800 is also received partially within the respective through windows thereof.

The retaining tube 1800 is configured to limit respective strokes of the sets of fingers 1510, 1512 in the z-axis direction. For example, referring to the finger 1511, when the finger 1511 is pulled in the negative z-axis direction, the finger 1511 can move until the interior distal surface 1702 contacts the retaining tube 1800, which then precludes further movement in the negative z-axis direction. When the finger 1511 is actuated in the positive z-axis direction, it can move until the interior proximal surface 1704 contacts the retaining tube 1800, which then precludes further movement in the positive z-axis direction (see FIG. 45).

The device 1500 further comprises a driving wedge 1802 and a driven wedge 1804 received through the rectangular window of the fixed housing plate 1506. The driving wedge 1802 contacts the driven wedge 1804 along an inclined plane as described below. The device 1500 similarly includes a driving wedge 1806 and a driven wedge 1808 received through the rectangular window of the fixed housing plate 1504. The driving wedge 1806 contacts the driven wedge 1808 along an inclined plane as described below.

The device 1500 further includes a clamping bolt 1810 mounted transversely through the driving wedge 1802, the driven wedge 1804, the retaining tube 1800 (which is hollow), the respective slots of the sets of fingers 1510, 1512, the driven wedge 1808, and the driving wedge 1806. The clamping bolt 1810 has a bolt head 1812 resting against a clamping bolt washer 1814, which in turn contacts the driving wedge 1802.

The device 1500 further includes a first wave spring 1816 disposed within the driven wedge 1804. The first wave spring 1816 rests against a shim 1818, which in turn rests against a shoulder or step formed by the exterior surface of the retaining tube 1800. The first wave spring 1816 is preloaded to apply a biasing force in an outward direction (i.e., in the positive x-axis direction) on the driven wedge 1804 and the driving wedge 1802.

Similarly, the device 1500 includes a second wave spring 1820 disposed within the driven wedge 1808. The second wave spring 1820 rests against a shim 1822, which in turn rests against a shoulder or step formed by the exterior surface of the retaining tube 1800. The second wave spring 1820 is preloaded to apply a biasing force in an outward direction (i.e., in the negative x-axis direction) on the driven wedge 1808 and the driving wedge 1806.

In an example, the clamping bolt 1810 is configured as a lead screw, such that rotary motion of the clamping bolt 1810 about the x-axis causes it to translate or move linearly along the x-axis, and thereby causing the driving wedge 1802 to move therewith. Particularly, in an example, the clamping bolt 1810 has male threads 1817 (exterior threads) formed on an exterior peripheral surface at an end portion of the clamping bolt 1810. For instance, the male threads 1817 can be Acme or trapezoidal threads. However, other types of threads (e.g., square threads) may be used.

The driving wedge 1806 has female threads (interior threads) in a tapped hole through which the clamping bolt 1810 extends and configured to engage with the male threads 1817 of the clamping bolt 1810. The male threads 1817 of the clamping bolt 1810 and the female thread of the driving wedge 1806 are configured such when the clamping bolt 1810 is rotated and translates in a given direction, the driving wedge 1806 moves in the opposite direction.

For instance, if the clamping bolt 1810 is rotated clockwise, it translates in the negative x-axis direction, pushing the driving wedge 1802 in the negative x-axis direction, and pulling the driving wedge 1806 in the positive x-axis direction. Conversely, if the clamping bolt 1810 is rotated counter-clockwise, it translates in the positive x-axis direction, allowing the driving wedge 1802 to move in the positive x-axis direction (via the biasing force of the first wave spring 1816), and causing the driving wedge 1806 to move in the negative x-axis direction.

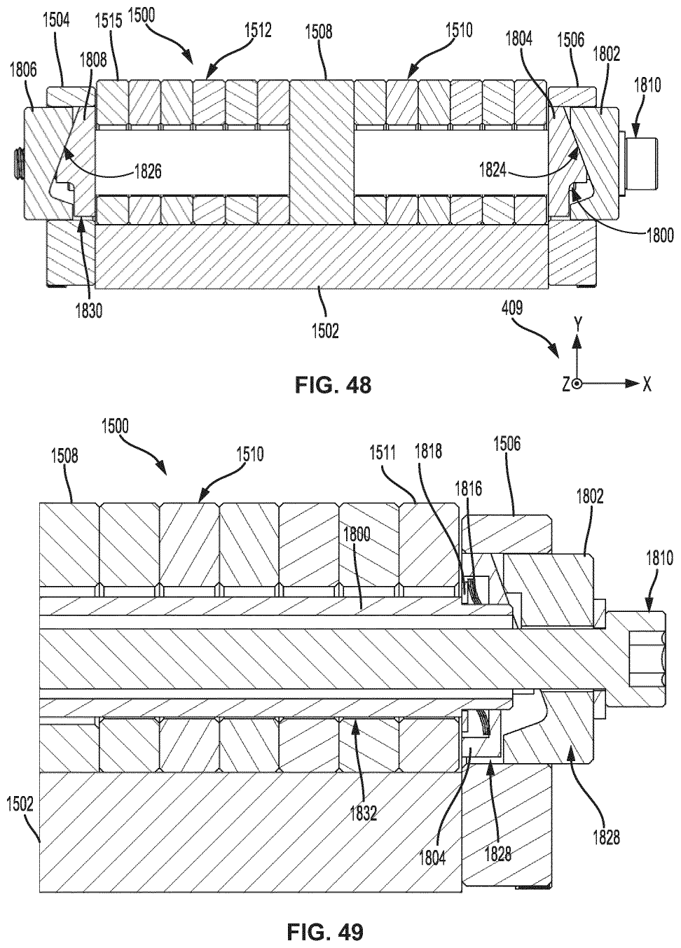

FIG. 48 illustrates another cross-sectional side view of the device 1500 showing an interface between the driving wedges 1802, 1806 and the driven wedges 1804, 1808, in accordance with an example implementation. As depicted in FIG. 48, the driving wedge 1802 has an inclined surface that contacts a respective inclined surface of the driven wedge 1804 along an angled or inclined plane 1824. Similarly, the driving wedge 1806 has an inclined surface that contacts a respective inclined surface of the driven wedge 1808 along an angled or inclined plane 1826.

FIGS. 46-48 illustrate the device 1500 in an unlocked or unclamped state. In this unlocked state, the clamping bolt 1810 is unscrewed (i.e., is moved in the positive x-axis direction), and the first wave spring 1816 pushes the driven wedge 1804 and the driving wedge 1802 outward such that there is a gap between the driven wedge 1804 and the finger 1511. Similarly, the movement of the clamping bolt 1810 in the positive x-axis direction causes the driving wedge 1806 to move in the negative x-axis direction, and the second wave spring 1820 pushes the driven wedge 1808 toward the driving wedge 1806 such that there is a gap between the driven wedge 1808 and the finger 1515.

In the unlocked position, a gap 1828 separates the bottom surface of the driven wedge 1804 from the interior surface of the fixed housing plate 1506. Similarly, in the unlocked position, a gap 1830 separates the bottom surface of the driven wedge 1808 from the interior surface of the fixed housing plate 1504.

The retaining tube 1800 is disposed through respective holes in the driven wedges 1804, 1808 such that the exterior surface of the retaining tube 1800 contacts the interior surfaces of the driven wedges 1804, 1808 bounding their respective holes. Thus, when the driven wedges 1804, 1808 are shifted upward, the retaining tube 1800 is also shifted upward.

FIG. 49 illustrates a partial side cross-sectional view of the device 1500 in an unlocked state, in accordance with an example implementation. As depicted, the retaining tube 1800 is shifted slightly upward along with the driven wedges 1804 such that a gap 1832 separates the bottom surface of the retaining tube 1800 from the interior bottom surfaces of the sets of fingers 1510, 1512 (e.g., the first interior lateral surface 1706 of the finger 1511). In another example, the retaining tube 1800 contacts the sets of fingers 1510, 1512 but does not apply a force thereon, such that the sets of fingers 1510, 1512 are free to move along the z-axis.

In the unlocked position, the operator can adjust the longitudinal positions of the sets of fingers 1510, 1512 as desired. Once the sets of fingers 1510, 1512 are actuated or adjusted longitudinally (along the z-axis) to a particular configuration that matches a desired shape of the workpiece 16, the clamping bolt 1810 is screwed in (e.g., rotated clockwise) to move in the negative x-axis direction. As the clamping bolt 1810 moves, it causes the driving wedge 1802 to move therewith in the negative x-axis direction and causing the driving wedge 1806 to move in the positive x-axis direction as described above.

Due to the driving wedge 1802 contacting the driven wedge 1804 along inclined surfaces, linear motion of the driving wedge 1802 in the negative x-axis direction causes the driven wedge 1804 to slide along the inclined plane 1824, thereby moving initially downward in the negative y-axis direction (in a lateral direction) traversing a portion of the gap 1828. Similarly, due to the driving wedge 1806 contacting the driven wedge 1808 along inclined surfaces, linear motion of the driving wedge 1806 in the positive x-axis direction causes the driven wedge 1808 to slide along the inclined plane 1824, thereby moving initially downward in the negative y-axis direction traversing a portion of the gap 1830. In an example, grease or other lubricant can be used at the interface between the driving wedge 1802 and the driven wedge 1804 and between the driving wedge 1806 and the driven wedge 1808 to facilitate the sliding motion of the driven wedges 1804, 1808.

As the driven wedges 1804, 1808 move downward, they move the retaining tube 1800 downward therewith. The driven wedges 1804, 1808 and the retaining tube 1800 can move downward until the retaining tube 1800 contacts the interior bottom surfaces of the sets of fingers 1510, 1512 (e.g., the first interior lateral surface 1706 of the finger 1511).

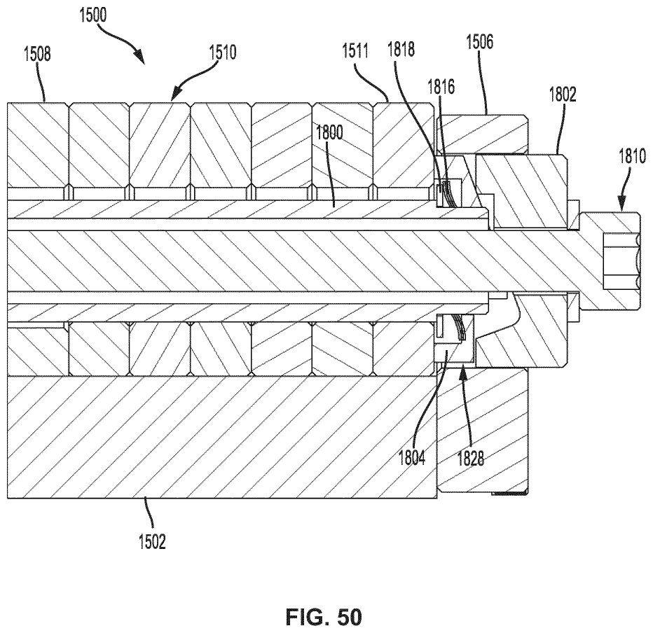

FIG. 50 illustrates a partial side cross-sectional view of the device 1500 after the driven wedges 1804, 1808 have moved downward and the retaining tube 1800 has contacted the interior surfaces of the fingers 1510, in accordance with an example implementation. As shown, the gap 1828 is smaller in FIG. 50 compared to FIGS. 48-49, indicating that the driven wedge 1804 has moved downward.

Further, the retaining tube 1800 now contacts the interior bottom surfaces of the fingers 1510, and the gap 1832 no longer exists. As such, the retaining tube 1800 and the driven wedges 1804, 1808 are precluded from moving further downward along the y-axis.

Thereafter, as the clamping bolt 1810 continues to move the driving wedges 1802, 1806 inward (i.e., toward the sets of fingers 1510, 1512), the driven wedges 1804, 1808 are forced to move inward in a linear direction along the x-axis. Particularly, the driven wedge 1804 moves toward and contacts the finger 1511 of the first set of fingers 1510, thereby compressing the first wave spring 1816, and the driven wedge 1808 moves toward and contacts the finger 1515 of the second set of fingers 1512, thereby compressing the second wave spring 1820.

As such, the driven wedges 1804, 1808 go through a two-phase movement as the clamping bolt 1810 is rotated to clamp the sets of fingers 1510, 1512. Initially, the driven wedges 1804, 1808 move downward along the y-axis until the retaining tube 1800 contacts the interior bottom surfaces of the sets of fingers 1510, 1512. The, the driven wedges 1804, 1808 move linearly along the x-axis toward the respective fingers.

As the driven wedge 1804 presses against the finger 1511, the finger 1511 in turn presses against an adjacent finger, and so forth, until the first set of fingers 1510 are squeezed against each other and between the driven wedge 1804 on one side and the rib 1508 on the other side. Similarly, as the driven wedge 1808 presses against the finger 1515, the finger 1515 in turn presses against an adjacent finger, and so forth, until the second set of fingers 1512 are squeezed against each other and between the driven wedge 1808 on one side and the rib 1508 on the other side. As a result, the sets of fingers 1510, 1512 are secured in a locked position. In the example where one side of the fingers is coarse, the surface roughness of one side interacting with a smooth side of an adjacent finger enhances locking the fingers in position.

Notably, the device 1500 is symmetric such that the clamping bolt 1810 flipped to facilitate operating it from either side. In other words, the clamping bolt 1810, the bolt washer 1814, the driving wedges 1802, 1806, and the driven wedges 1804, 1808 can be removed and flipped to be mounted on the opposite side of the housing base plate 1502. This way, the clamping bolt 1810 can be operated (i.e., screwed and unscrewed) from either side of the device 1500, and particularly whichever side is more convenient to the operator given and the setup of the machine. In addition, as two devices 1500 are used to secure the workpiece 16, the orientation of the respective clamping bolts can be matched so that the operator can adjust both devices from the same side rather than having to change sides.

Similar to the device 400, the device 1500 can be configured to match a vise of a particular machine (e.g., a particular lathe) or can be can be configured in a generic manner with an adaptor configuration that facilitates mounting the housing base plate 1502 to multiple vise configurations. For example, referring to FIG. 42, the housing base plate 1502 can be coupled to an adaptor block 1514 via dowels and fasteners such as dowel 1516 and fastener 1518.

The adaptor block 1514 is used to couple the device 1500 to a vise of a given machine. The adaptor block 1514 can be replaced with other adaptor blocks with a different bolt and hole pattern that allows the device 1500 coupled thereto to be mounted to any type of vise.

Various alternative or additional features can be implemented to the device 1500.

FIG. 51 illustrates a partial perspective front cross-sectional view of a device 1900, and FIG. 52 illustrates a partial front cross-sectional view of the device 1900, in accordance with an example implementation. Similar components between the device 1500 and the device 1900 are designated with the same reference numbers.

The device 1900 has a driven wedge 1902 and a retaining tube 1904 that differ from the driven wedge 1804 and the retaining tube 1800. Particularly, while the hole of the driven wedge 1804 through which the retaining tube 1800 is disposed may have a completely circular boundary, the interior surface of driven wedge 1902 that bounds the hole has a flat portion 1906 (i.e., the hole in the driven wedge 1902 is not completely circular).

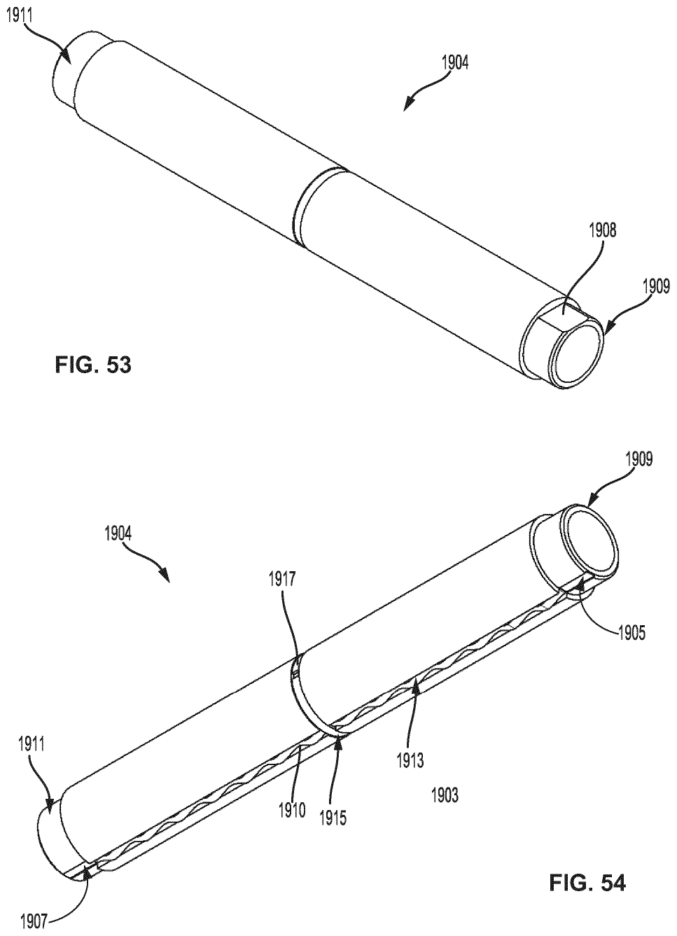

FIG. 53 illustrates a top perspective view of the retaining tube 1904, in accordance with an example implementation. Referring to FIGS. 51, 53 together, the retaining tube 1904 has a respective flat portion 1908 disposed in a neck portion 1909 (e.g., a reduced diameter portion) of the retaining tube 1904. The respective flat portion 1908 of the retaining tube 1904 interfaces with the flat portion 1906 of the driven wedge 1902. With this configuration, the retaining tube 1904 is not free to rotate about the x-axis, and may thus preclude the sets of fingers 1510, 1512 from rotating about the x-axis.

Further, referring to FIGS. 51-52, rather than using a guide rail system similar to that of the device 400 (e.g., the guide rail 700, the spring 800, etc.), the device 1900 has an alternative mechanism that keeps the sets of fingers 1510, 1512 in place when the clamping force is removed, rather than resetting the sets of fingers 1510, 1512 to a fully extended position. Particularly, the device 1900 includes a linear wave spring 1910 that is interposed between the retaining tube 1904 and the interior bottom surfaces of the sets of fingers 1510, 1512. With this configuration, the retaining tube 1904 does not directly contact the sets of fingers 1510, 1512; rather the linear wave spring 1910 is interposed therebetween.

FIG. 54 illustrates a bottom perspective view of the retaining tube 1904, in accordance with an example implementation. In an example, the linear wave spring 1910 is disposed in a keyway 1913 formed in the bottom surface of the retaining tube 1904, such that surfaces of the keyway bounding the linear wave spring 1910 retain the linear wave spring 1910 in the z-axis direction. In an example, the retaining tube 1904 has a circumferential groove 1915 configured to receive a retaining hope 1917 to retain the linear wave spring 1910 to the retaining tube 1904.

Further, the ends of the keyway 1913 are open such that the linear wave spring 1910 is not enclosed. Rather, the ends of the linear wave spring 1910 are free to expand in the x-axis direction when the linear wave spring 1910 is compressed in the y-axis direction. In an example, the neck portion 1909 of the retaining tube 1904 has an axial groove 1905 ridge, and a neck portion 1911 of the retaining tube 1904 (on the other end of the retaining tube 1904) has an axial groove 1907. This way, when the linear wave spring 1910 expands in the x-axis direction when compressed in the y-axis direction, the axial grooves 1905, 1907 operate as a guide for the ends of the linear wave spring 1910.

Referring to FIGS. 51-52, in the device 1900, the first wave spring 1816 and the second wave spring 1820 are made sufficiently strong, such that when the device 1900 is in the unlocked state (i.e., when the clamping bolt 1810 is unscrewed and the sets of fingers 1510, 1512 are unclamped in the x-axis direction), the linear wave spring 1910 is compressed in the x-axis direction. When the linear wave spring 1910 is compressed, its lower crests contact the interior bottom surfaces of the sets of fingers 1510, 1512, and its upper crests contact the retaining tube 1904.

In an example, referring to FIG. 52, the lower crests of the linear wave spring 1910 contact respective centers of the sets of fingers 1510, 1512, whereas the upper crests contact the retaining tube 1904 at a point that is aligned with an interface between two adjacent fingers. For instance, a lower crest 1912 contacts the finger 1511 at a center thereof, and lower crest 1914 contacts a finger 1916 at a center thereof. In this example, the upper crest 1918 contacts the retaining tube 1904 at a point aligned with the interface between the fingers 1511, 1916. With this configuration, a period of the linear wave spring 1910 (i.e., distance between two consecutive lower or upper crests) is equal to the thickness of the finger.

As the lower crests of the linear wave spring 1910 contact the interior bottom surfaces of the sets of fingers 1510, 1512 and the upper crests contact the retaining tube 1904 when the device 1900 is in the unlocked state, the linear wave spring 1910 applies a light friction force on the sets of fingers 1510, 1512. Such friction force maintains the sets of fingers 1510, 1512 in position even when the clamping bolt 1810 is unscrewed to unclamp the sets of fingers 1510, 1512.

However, the load is sufficiently light that an operator can then adjust the longitudinal positions of the individual fingers by moving them (e g, manually) along the z-axis to a different position. Once in the new position, the sets of fingers 1510, 1512 stay there even when the actuation force is removed due to the friction imposed by the linear wave spring 1910. Further, when one finger is being moved, it might not drag an adjacent finger with it because the linear wave spring 1910 applies the friction force on the adjacent finger to preclude it from moving.

When the clamping bolt 1810 is tightened to lock the sets of fingers 1510, 1512 in position, the first wave spring 1816 and the second wave spring 1820 are sufficiently strong, and they compress the linear wave spring 1910. As a result, the linear wave spring 1910 protrudes past the exterior surface of the retaining tube 1904, and contacts the interior bottom surfaces of the sets of fingers 1510, 1512 to retain them along the y-axis and preclude their rotation about the x-axis.

In another alternative configuration, rather than retaining the sets of fingers 1510, 1512 via a retaining tube that moves along the y-axis via wedges sliding along an inclined plane, a cam system can be used to retain the sets of fingers 1510, 1512 upon rotating the retaining tube.

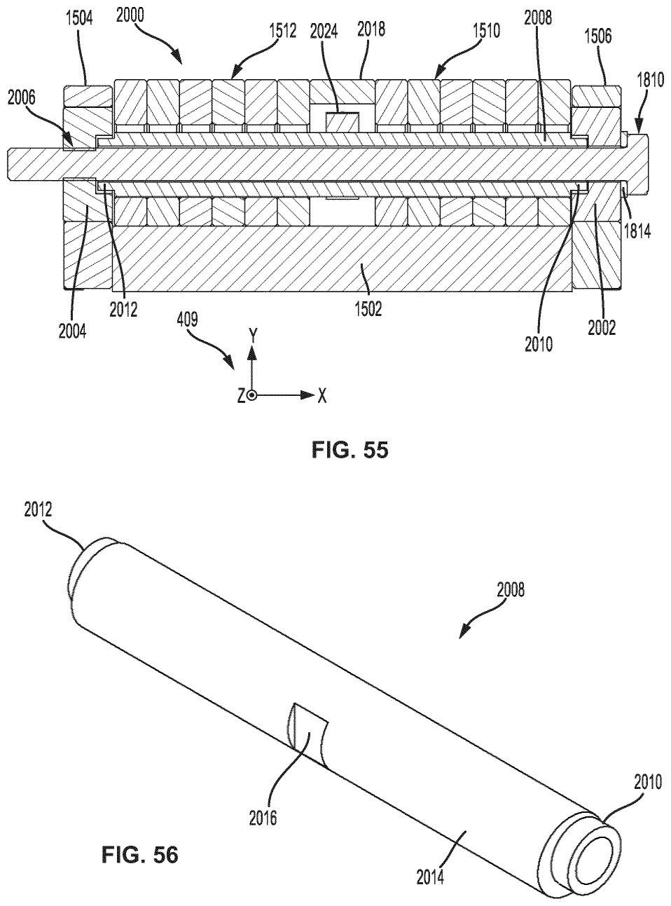

FIG. 55 illustrates a front cross-sectional view of a device 2000, in accordance with an example implementation. Similar components between the device 1500, the device 1900, and the device 2000 are designated with the same reference numbers.

Rather than having a driving wedge interacting with a driven wedge, the device 2000 has a first movable block 2002 that is received through the rectangular window of the fixed housing plate 1506 and is slidable along the x-axis. Similarly, the device 2000 has a second movable block 2004 that is received through the rectangular window of the fixed housing plate 1504 and is slidable along the x-axis.

The movable blocks 2002, 2004 interact with the clamping bolt 1810 similar to the driving wedges 1802, 1806. Particularly, the movable block 2002 has a through-hole that is not threaded and through which the clamping bolt 1810 is disposed. On the other hand, the movable block 2004 has a tapped or threaded hole that engages with exterior threads of the clamping bolt 1810 at threaded region 2006. Further, the device 2000 includes a retaining tube 2008 that differs from the retaining tube 1800 and the retaining tube 1904.

FIG. 56 illustrates a top perspective view of the retaining tube 2008, in accordance with an example implementation. The retaining tube 2008 includes a first boss 2010 at a first end of the retaining tube 2008, and includes a second boss 2012 at a second end of the retaining tube 2008 opposite the first end. The term “boss” is used herein to indicate a protruding feature on the retaining tube 2008 configured to locate the retaining tube 2008 within a pocket, hole, or cavity in the movable blocks 2002, 2004. As shown in FIG. 55, the first boss 2010 of the retaining tube 2008 is received in a cavity in the movable block 2002, and the second boss 2012 of the retaining tube 2008 is received in a cavity in the movable block 2004. The first boss 2010 and the second boss 2012 are concentric.

The retaining tube 2008 further comprises a cam portion 2014 disposed between the first boss 2010 and the second boss 2012. The cam portion 2014 is eccentric relative to the first boss 2010 and the second boss 2012.

The cam portion 2014 includes a flat portion 2016. The flat portion 2016 is formed at a central portion of the cam portion 2014 and aligns with or is disposed within the slot of a rib 2018

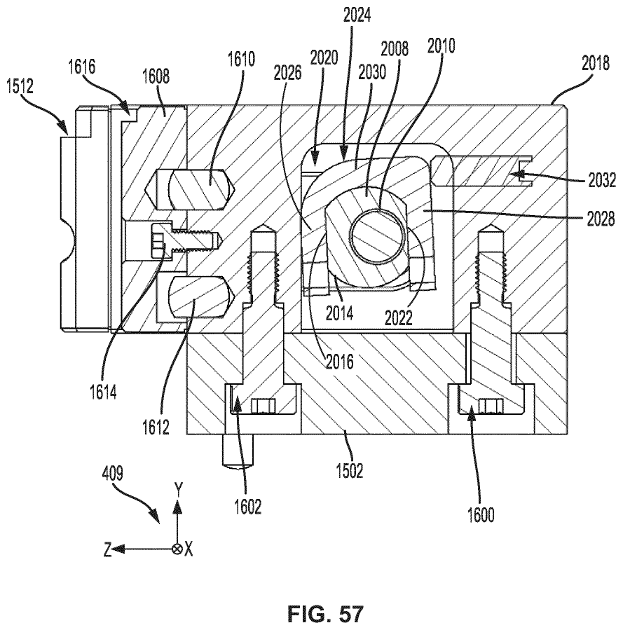

FIG. 57 illustrates a side cross-sectional view of the device 2000, in accordance with an example implementation. The cross section shown in FIG. 57 is taken a long a plane that passes through the rib 2018 and the center of the retaining tube 2008 looking in the negative x-axis direction of the coordinate system 409.

The rib 2018 is similar to the rib 1508 described above and is fixedly-coupled to the housing base plate 1502 and located at a center of the housing base plate 1502 between the first fixed housing plate 1504 and the second fixed housing plate 1506.

The rib 2018 further has a through-hole 2020 that is generally rectangular and allows the retaining tube 2008 to pass therethrough. As mentioned above, the cam portion 2014 of the retaining tube 2008 has the flat portion 2016 that is disposed within the rib 2018. The retaining tube 2008 further has another flat portion 2022 opposite the flat portion 2016.

The device 2000 further includes a rocker block 2024 that is horseshoe-shaped (e.g., a yoke or U-shaped block) disposed in the through-hole of the rib 2018. The rocker block 2024 has a leg portion 2026 and a leg portion 2028 that are generally-parallel, laterally-disposed legs connected by a base portion 2030.

The leg portion 2026 has a flat surface that interfaces with the flat portion 2016 of the retaining tube 2008, and the leg portion 2028 has a respective flat surface that interfaces with the flat portion 2022 of the retaining tube 2008. The base portion 2030 has a curved interior surface that interfaces and conforms with the curved exterior surface of the cam portion 2014 of the retaining tube 2008.

Further, the device 2000 has a screw 2032 disposed through the rib 2018 and interfaces with the rocker block 2024. For example, the screw 2032 is substantially-aligned with the base portion 2030 of the rocker block 2024 such that the screw 2032 is offset from a center of the rocker block 2024 (i.e., from centers of the leg portions 2026, 2028).

The screw 2032 operates as an actuator. Particularly, if the screw 2032 is rotated in a given direction, e.g., counter-clockwise, it moves inward (e.g., extends to the left in FIG. 57) toward the rocker block 2024 and vice versa. As the screw 2032 moves toward the rocker block 2024, it causes the rocker block 2024 to rotate or rock in a counter-clockwise direction in FIG. 57. Due to the interface of the leg portions 2026, 2028 with the flat portions 2016, 2022, respectively, the retaining tube 2008 rotates with the rocker block 2024.

The retaining tube 2008 rotates about an axis passing through respective centers of the first boss 2010 and the second boss 2012. Due to the cam portion 2014 being eccentric relative to the first boss 2010 and the second boss 2012, the cam portion 2014 is pushed against the interior bottom surfaces of the sets of fingers 1510, 1512. As such, the cam portion 2014 is tightened against the sets of fingers 1510, 1512 and retains them from moving in the y-axis direction.

To relieve the sets of fingers 1510, 1512, the screw 2032 can be unscrewed (e.g., retracts to the right in FIG. 57), relieving the rocker block 2024, which in turn allows the retaining tube 2008 to loosen and the cam portion 2014 relieves the pressure on the interior bottom surfaces of the sets of fingers 1510, 1512.

Further, various additional or alternative features can be included in the fingers described above. For example, as mentioned above, a finger can include a finger body and a finger tip configured to be removably coupled to the finger body. Coupling the finger tip to the finger body can be accomplished in several ways.

For example, as mentioned above with respect to FIG. 38, the finger body 1302 is coupled to the replaceable tip 1304 via the cleat 1310 configured as a receptacle of the portion 1312 of the replaceable tip 1304, which dove tails into the cleat 1310. The fastener 1314 can then be used to mount or couple the replaceable tip 1304 to the finger body 1302.

In another example described above with respect to FIGS. 44-45, the finger can have a finger body with coupling features such as the finger dowel holes 1710, 1712 and the screw hole 1714. The replaceable finger tip 1716 has respective coupling features such as finger dowel holes and threaded screw holes corresponding to the finger dowel holes 1710, 1712 and the screw hole 1714. The finger dowels 1718, 1720 and the finger screw 1722 are then used to couple the replaceable finger tip 1716 to the finger body of the finger 1511. Other configurations and coupling features can be used.

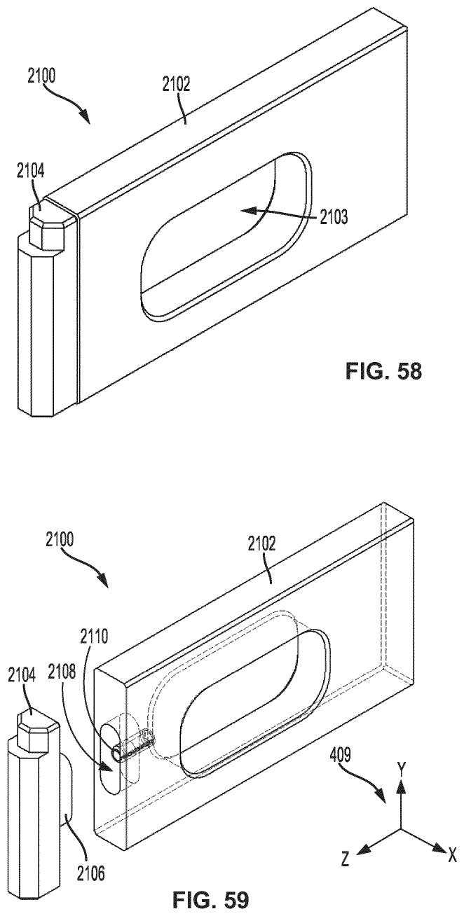

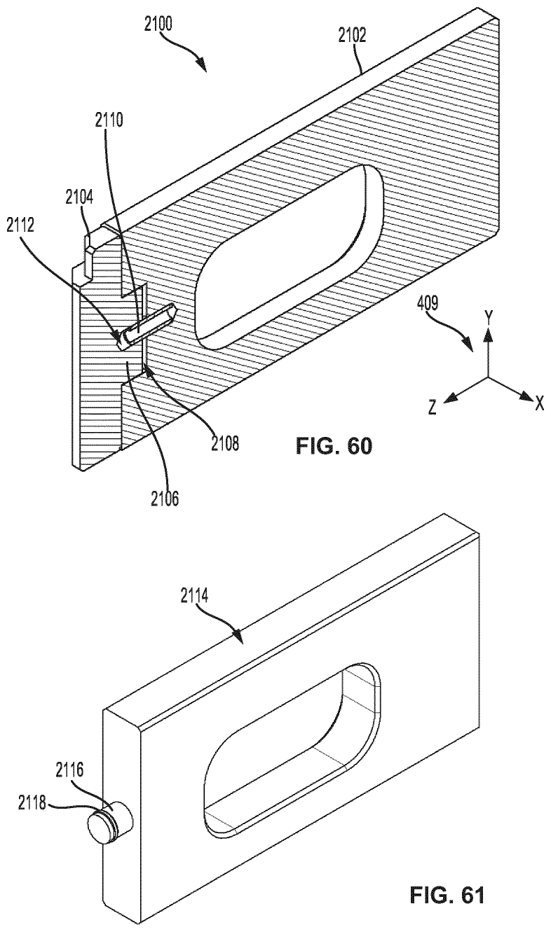

FIG. 58 illustrates a perspective view of a finger 2100 having a finger body 2102 and a finger tip 2104, FIG. 59 illustrates a perspective view of the finger body 2102 and the finger tip 2104 before assembly, and FIG. 60 illustrates a perspective cross-sectional view of the finger 2100, in accordance with an example implementation. FIG. 59 particularly illustrates a transparent view of the finger body 2102 to illustrate its internal features.

The finger body 2102 is similar to the finger bodies of the fingers described above and has a slot 2103 configured as a through-window. The slot 2103 can be generally-rectangular as shown or can take other shapes, e.g., oval or circular.

As shown in FIG. 59, the finger tip 2104 has a coupling feature such as a boss 2106 and the finger body 2102 has a respective coupling feature such as a cavity or hole 2108 configured to cooperate with the boss 2106 to removably mount the finger tip 2104 to the finger body 2102. The boss 2106 is a protruding feature on the finger tip 2104 configured to locate the finger tip 2104 within the hole 2108 of the finger body 2102. In the illustrated implementation, the finger tip 2104 includes the boss 2106 and the finger body 2102 includes the hole 2108; however, in another example implementation, the finger body 2102 has a boss, whereas the finger tip 2104 has a hole configured to receive the boss.

The hole 2108 can be formed as a stepped hole or a counterbore and is configured to receive therein a compliant member such as a spring roll pin 2110 mounted within the hole 2108 of the finger body 2102. As shown in FIG. 60, the boss 2106 has a blind hole 2112. To assemble the finger 2100, the spring roll pin 2110 can be mounted within the hole 2108 of the finger body 2102, and then the blind hole 2112 of the boss 2106 of the finger tip 2104 can be aligned with the spring roll pin 2110. The finger tip 2104 can then be pushed toward the finger body 2102 (or the finger body 2102 is pushed toward the finger tip 2104) causing the spring roll pin 2110 to be inserted in the blind hole 2112.

The spring roll pin 2110, which can also be referred to as a tension pin, operates as a mechanical fastener that secures the finger body 2102 and the finger tip 2104 to each other. The spring roll pin 2110 is generally cylindrical and has a body diameter that is larger than the diameter of the blind hole 2112. The spring roll pin 2110 has a chamfer on either one or both ends to facilitate inserting the spring roll pin 2110 into the blind hole 2112 and the smaller diameter portion of the hole 2108.

The spring roll pin 2110 is a compliant member and is allowed to compress as it is inserted in the blind hole 2112. The force exerted by the spring roll pin 2110 against the walls bounding the blind hole 2112 retains it in the blind hole 2112. As such, the spring roll pin 2110 operates as a self-retaining fastener.

To render the spring roll pin 2110 compliant, it can be configured as a slotted spring pin or a coiled spring pin. The spring roll pin 2110 is illustrated as a slotted spring pin in FIGS. 58-60. A slotted spring pin is a cylindrical pin rolled from a strip of material with a slot to allow the pin to have some flexibility during insertion. A slotted spring pin can also be referred to as a sellock pins or a “C” pin.

A coiled spring pin, which can also referred to as a spiral pin, is a self-retaining fastener manufactured by roll-forming a metal strip into a spiral cross section. When coiled spring pins are installed, the compression starts at the outer edge and moves through the coils toward the center. Coiled pins continue to flex after insertion when a load is applied to the pin.

Once inserted, the spring roll pin 2110 presses outward against the interior surfaces bounding the blind hole 2112 and retains the finger tip 2104 longitudinally (in the z-axis direction) to the finger body 2102 due to friction. The boss 2106 inserted in the hole 2108 retains the finger tip 2104 in the y-axis and x-axis direction, as well as rotationally. Further, the compliance of the spring roll pin 2110 allows the finger tip 2104 to be removed by pulling it from the finger body 2102 (e.g., by hand or other pulling tool) when replacing the finger tip 2104 is desired.

Other types of compliant members could be used.

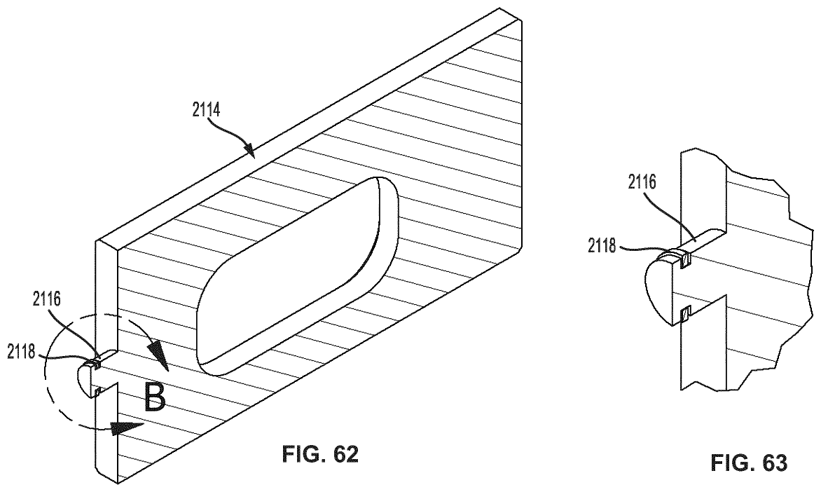

FIG. 61 illustrates a perspective view of a finger body 2114, FIG. 62 illustrates a perspective cross-sectional view of the finger body 2114, and FIG. 63 illustrates detail “B” labelled in FIG. 62, in accordance with an example implementation. The finger body 2114 has a boss or cylindrical protrusion 2116 as a coupling feature. The cylindrical protrusion 2116 is configured to be inserted in a respective coupling feature, such as a hole in the finger tip.

The compliant member in this implementation is a retaining ring 2118 (e.g., a C-clip configured as a semi-flexible metal ring) mounted in a circumferential groove formed in the cylindrical protrusion 2116. The retaining ring 2118 operates similar to the spring roll pin 2110 in that it is compressed upon insertion of the cylindrical protrusion 2116 into a corresponding hole in the finger tip, and presses against the bounding walls to retain the finger tip longitudinally to the finger body 2114.

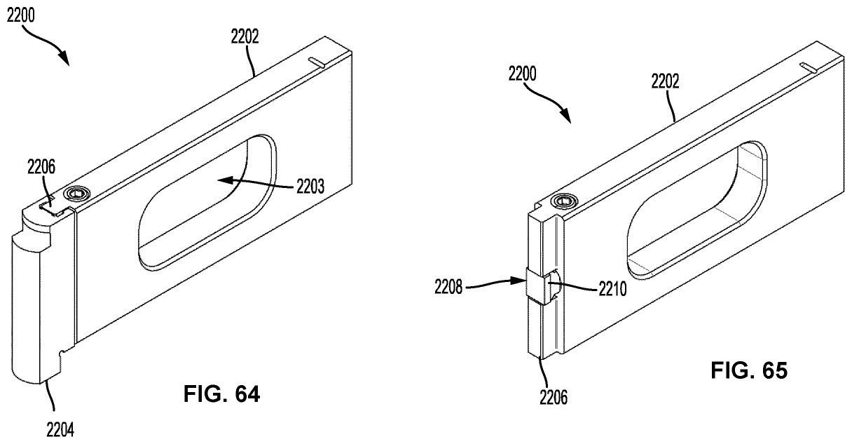

FIG. 64 illustrates a perspective view of a finger 2200 having a finger body 2202 and a finger tip 2204, in accordance with an example implementation. The finger body 2202 is similar to the finger bodies of the fingers described above and has a slot 2203 configured as a through-window. The slot 2203 can be generally-rectangular as shown or can take other shapes, e.g., oval or circular. The finger tip 2204 is similar to the finger tips described above in being a replaceable tip that can be removably coupled to the finger body 2202.

The finger body 2202 has a coupling feature such as protrusion or key 2206 that has a generally square or rectangular profile. The key 2206 can be referred to as a boss or protrusion. The finger 2200 further includes a retaining cam locking system that couples or retains the finger tip 2204 to the finger body 2202.

FIG. 65 illustrates a partial perspective view of the finger 2200 depicting a cam member 2208 inserted into the finger body 2202, in accordance with an example implementation. Particularly, the finger body 2202 has a hole and the key 2206 has a gap that allows the cam member 2208 to be inserted or disposed, at least partially, into the finger body 2202. The cam member 2208 has a flange 2210 formed at an end of the cam member 2208.

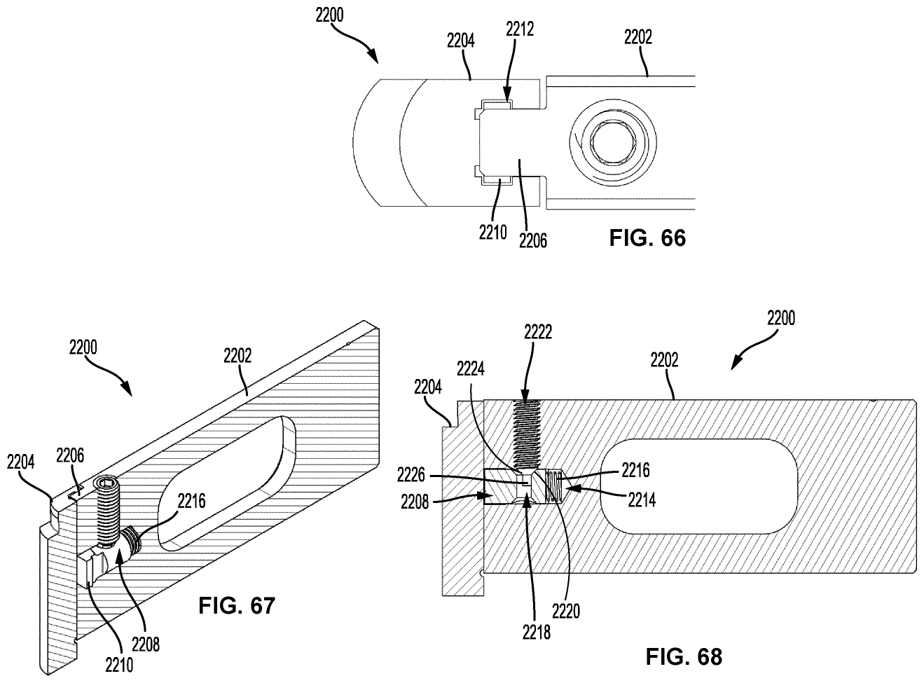

FIG. 66 a partial top view of the finger 2200, in accordance with an example implementation. The finger tip 2204 has a groove 2212 that operates as a key slot configured to receive the key 2206 therein. Further, the groove 2212 is flange-shaped so as to accommodate the flange 2210. Thus, the finger tip 2204 can be inserted transversely or vertically to be mounted to the finger body 2202. For example, the finger tip can be positioned at an upper end of the finger body 2202 with the key 2206 aligned with the groove 2212, then the finger tip 2204 is moved downward, allowing the groove 2212 to engage the flange 2210 of the cam member 2208.

FIG. 67 illustrates a perspective cross-sectional view of the finger 2200, and FIG. 68 illustrates a side cross-sectional view of the finger 2200, in accordance with an example implementation. Referring to FIGS. 67-68 together, the finger body 2202 has a blind hole 2214 configured to receive or accommodate the cam member 2208 therein.

At least a portion of the blind hole 2214 may have a square or rectangular shape or profile. A portion of the cam member 2208 leading to the flange 2210 may also have a square or rectangular shape that interfaces with the square or rectangular surface bounding the blind hole 2214 to preclude the cam member 2208 from rotating within the blind hole 2214.

The finger 2200 includes a spring 2216 disposed in the blind hole 2214. One end of the spring 2216 bears against the interior surface of the finger body 2202, and the other end of the spring 2216 rests against the cam member 2208. With this configuration, the spring 2216 biases the cam member 2208 outward from the finger body 2202 to facilitate engaging the finger tip 2204. When the cam member 2208 is biased outward and the flange 2210 is exposed outside the finger body 2202, the finger tip 2204 can be inserted vertically to be mounted to the finger body 2202 as described above.

As shown in FIG. 68, the cam member 2208 has a transversal hole 2218. The transversal hole 2218 has a countersink or a conical depression 2220. The tapered or conical surface bounding the conical depression 2220 can be referred to as a cam surface, i.e., an interior surface of the cam member 2208 operates as the cam surface.

The finger 2200 further includes a fastener or screw 2222 that can be threadedly-engaged with the finger body 2202 as depicted. The screw 2222 has a tapered portion 2224 that is received by the conical depression 2220. The screw 2222 operates as a cam actuator that actuates the cam member 2208 (pulls the cam member 2208 inward against the spring 2216).

Once the finger tip 2204 is engaged with the flange 2210 of the cam member 2208, the screw 2222 can be rotated or screwed such that the tapered surface of the tapered portion 2224 contacts the cam surface bounding the conical depression 2220. Further rotation of the screw 2222 causes the tapered portion 2224 to slide against the cam surface to actuate the cam, thereby causing the cam member 2208 to be pulled inward against the spring 2216 and pulling the finger tip 2204 toward the finger body 2202 via interaction between the flange 2210 and the groove 2212.

This way, screwing the screw 2222 couples the finger tip 2204 to the finger body 2202. In this position or configuration, loads applied to the finger tip 2204 (while machining a workpiece hold in place by the finger tip 2204 and other finger tips) are transmitted to the finger body 2202.

To release the finger tip 2204, the screw 2222 can be unscrewed to disengage the tapered portion 2224 from the cam surface bounding the conical depression 2220, and the spring 2216 pushes the cam member 2208 and the finger tip 2204 outward, away from the finger body 2202. The finger tip 2204 can then be removed in a vertical/transversal direction.

In an example, the screw 2222 has a “dog” or protrusion 2226 at an end or tip thereof, and the protrusion 2226 can prevent the cam member 2208 from being pushed out of the blind hole 2214 by the spring 2216 upon disengagement of the tapered portion 2224 of the screw 2222 from the conical depression 2220. In other words, the protrusion 2226 of the screw 2222 facilitates retaining the cam member 2208 in the blind hole 2214 when the screw 2222 is unscrewed to release the finger tip 2204. A screw is used herein as an example fastener. Any other type of fastener with a tapered portion can be used.

The vertical position of the finger tip 2204 relative to the finger body 2202 can be adjusted by sliding the finger tip 2204 up or down while the finger tip 2204 is engaged with the key 2206 and the flange 2210 of the cam member 2208. In this case, the surface of a housing base plate (i.e., a bottom portion of the housing of the workpiece holding apparatus) can operate as a reference surface to facilitate vertical positioning of the finger tip 2204.

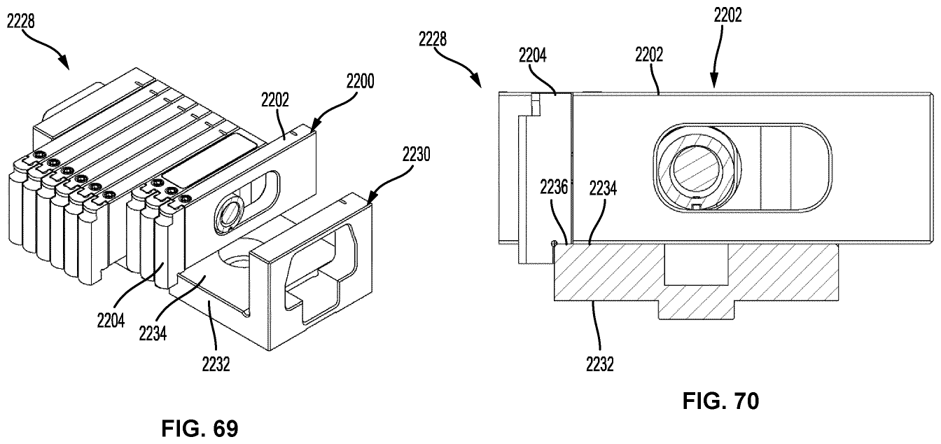

FIG. 69 illustrates a partial perspective view of a device 2228 for holding a workpiece, and FIG. 70 illustrates a side cross-sectional view of the device 2228, in accordance with an example implementation. The device 2228 can be similar to any of the workpiece holding devices described above.

The device 2228 has a housing 2230 (e.g., a combined or unitary construction that combines the housing base plate 1502, the first fixed housing plate 1504, and the second fixed housing plate 1506). A bottom portion 2232 of the housing 2230 has a surface 2234 that can operate as a reference surface for the finger tip 2204.

Referring to FIGS. 69-70 together, the finger 2200 can be pulled back, and then the finger tip 2204 can be adjusted in a vertical direction with reference to the surface 2234. The finger tip 2204 has a stepped bottom surface with a recessed portion having a bottom surface 2236. The finger tip 2204 can be moved vertically downward until the bottom surface 2236 mates with the surface 2234 of the bottom portion 2232 of the housing 2230. The screw 2222 can then be screwed to retain the finger tip 2204 to the finger body 2202.

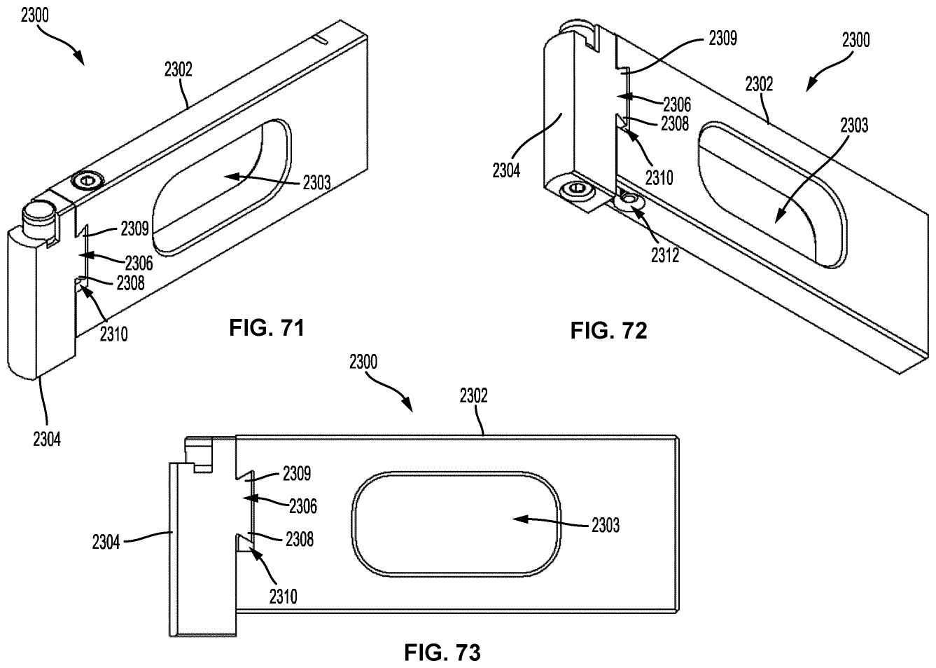

FIGS. 71-79 illustrates another finger configuration. FIG. 71 illustrates a top perspective view of a finger 2300 having a finger body 2302 and a finger tip 2304, FIG. 72 illustrates a bottom perspective view of the finger 2300, and FIG. 73 illustrates a side view of the finger 2300, in accordance with an example implementation. The finger body 2302 is similar to the finger bodies of the fingers described above and has a slot 2303 configured as a through-window. The slot 2303 can be generally-rectangular as shown or can take other shapes, e.g., oval or circular. The finger tip 2304 is similar to the finger tips described above in being a replaceable tip that can be removably coupled to the finger body 2302.

The finger tip 2304 has a boss 2306 that includes wedges such as wedge 2308 and wedge 2309. The finger body 2302 has a recess 2310 configured to receive the boss 2306 therein. Further, the finger body 2302 has a hole 2312 shown in FIG. 72 that facilitates mounting a clamp therethrough.

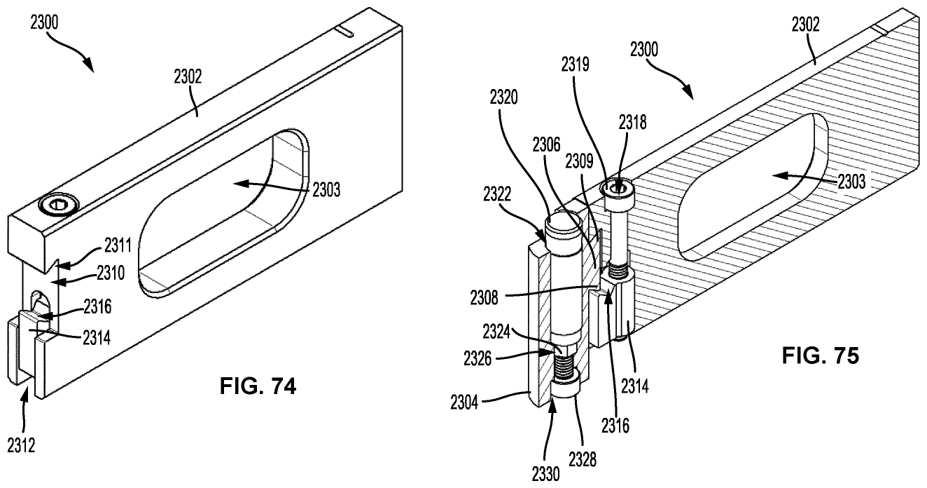

FIG. 74 illustrates a partial perspective view of the finger 2300 showing a clamp 2314 disposed through the hole 2312 of the finger body 2302, in accordance with an example implementation. The hole 2312 of the finger body 2302 can be substantially square-shaped and allows the clamp 2314 to be inserted therethrough. The clamp 2314 is, at least partially, mounted within the finger body 2302.

The clamp 2314 has a wedge-shaped groove 2316 that corresponds to the wedge 2308 of the finger tip 2304. The clamp is configured to retain the finger tip 2304 to the finger body 2302.

FIG. 75 illustrates a perspective partial cross-sectional view of the finger 2300, in accordance with an example implementation. The finger 2300 incudes a fastener such as a screw 2318 mounted through a top surface of the finger body 2302 and configured to threadedly engage with the clamp 2314, which has a threaded hole that receives the screw 2318. The screw 2318 can be a socket screw having a socket cap 2319 that can be received in a counterbore formed in the finger body 2302.

The threads of the threaded hole of the clamp 2314 and the threads of the screw 2318 are configured such that rotation of the screw 2318 causes the clamp 2314 to translate up and down the hole 2312. For example, rotation of the screw 2318 clockwise, causes the clamp 2314 to move linearly upward.

Referring to FIGS. 73-75 together, during assembly, the clamp 2314 can be inserted into the hole 2312 from the bottom, and the screw 2318 can be threadedly coupled to the clamp 2314, while keeping the clamp 2314 disposed below the recess 2310. The finger tip 2304 can then be positioned such that the boss 2306 is aligned with the recess 2310, and the finger tip 2304 can then be moved longitudinally (e.g., from left to right in FIGS. 73-75) toward the finger body 2302 to insert the boss 2306 into the recess 2310. The recess 2310 has another wedge-shaped groove 2311 (see FIG. 74) that receives the wedge 2309.

While the boss 2306 is disposed within the recess 2310, the screw 2318 can then be rotated to move the clamp 2314 linearly upward, thereby causing the wedge-shaped groove 2316 to engage with or receive the wedge 2308 of the boss 2306 therein. Further rotation of the screw 2318 presses the wedge 2309 against the interior surface of the finger body 2302 that bounds the wedge-shaped groove 2311, and the clamp 2314 is further pressed against the boss 2306, thereby firmly retaining the finger tip 2304 to the finger body 2302.

In an example, the finger 2300 can further include a stud 2320 mounted through a pilot hole 2322 formed in the finger tip 2304. The stud 2320 can be similar to the studs 1418-1422 described above, but is mounted to the finger tip 2304 rather than the finger body. Similar to the studs 1418-1420, the stud 2320 can have different shapes and heights to facilitate grabbing and interfacing with various workpieces.

In an example, the stud 2320 can be inserted in the pilot hole 2322 without retaining features. When the finger 2300 is pressed against a workpiece, the stud 2320 is precluded from movement by being retained between the interior surfaces of the finger tip 2304 and the workpiece.

In another example, the stud 2320 can be retained within the finger tip 2304 via retaining features. For example, an O-ring or a retaining ring can be mounted in an external groove formed in the stud 2320, and the finger tip 2304 can have a corresponding internal groove configured to receive such O-ring or retaining ring to retain the stud 2320 within the finger tip 2304.

In another example, the finger 2300 can have a screw 2328. The screw 2328 can be inserted through a hole 2330 formed in the finger tip 2304, and is then threadedly-engaged with the stud 2320, which can have a threaded hole therein that receives the screw 2328. The screw 2328 can be a socket screw having a socket cap that can be disposed within a counterbore formed at the bottom of the finger tip 2304.

In an example, the stud 2320 can have a polygon head and the finger tip 2304 can have a corresponding polygonal shape that receives the polygonal head of the stud 2320, thereby allowing the stud 2320 to be oriented at respective different orientations, i.e., the stud can be oriented at different discrete angles corresponding to a number of sides of the polygonal head. For instance, the stud 2302 can have a hexagon-shaped portion or hexagonal head 2324 that interfaces or is disposed within a hexagon-shaped hole 2326 formed in the finger tip 2304. With this hexagonal configuration, the stud 2320 is rotatable to be oriented at to six different angles or positions that are 60 degrees apart. For instance, if a portion of the stud 2320 interfacing with workpieces is worn out overtime, the stud 2320 can be pulled upward, then rotated 60 degrees, and reinserted into the pilot hole 2322 such that a different portion or surface of the stud 2320, which is not worn-out, faces a workpiece. Further, during operation (e.g., during machining a workpiece) the hexagonal configuration prevents the stud 2320 from rotating.

In an example, the workpiece may have a flat surface. In this example, it may be desirable to configure the stud to have a corresponding flat surface that facilitates interfacing with the workpiece.

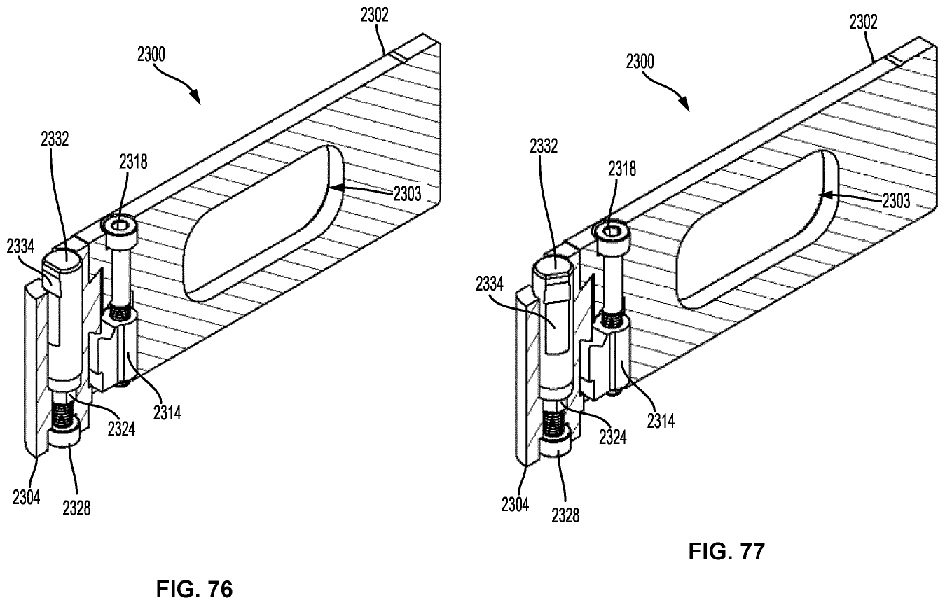

FIG. 76 illustrates a perspective partial cross-sectional view of the finger 2300 with a stud 2332 having a flat surface 2334, in accordance with an example implementation. As shown, the stud 2332 has the flat surface 2334, which can be positioned to face a corresponding flat surface of the workpiece. Further, the stud 2332 can be oriented in six different positions due to the hexagonal interface between the hexagonal head 2324 and the hexagon-shaped hole 2326.

FIG. 77 illustrates a partial cross-sectional view of the finger 2300 with the stud 2332 oriented at a different angle, in accordance with an example implementation. If the workpiece has a flat surface that does not face the finger 2300 directly, but is disposed at an angle, the stud 2332 can be rotated in 60 degree increments to a different position at which the flat surface 2334 of the stud 2332 faces the flat surface of such workpiece. For example, in FIG. 77, the stud 2332 has rotated 60 degrees counter-clockwise (from a top view perspective) such that the flat surface 2334 faces in a different direction.

A hexagonal configuration is used herein as an example. Different polygonal shapes can be used. For instance, the stud can have an octagonal head that allows the stud to be positioned at eight different orientations, 45 degrees apart from each other.

In an example, rather than having the discrete positions for the stud 2332, the stud 2332 can be configured to rotate through a continuum of angles by removing the hexagonal configuration. In this example, the stud 2332 can be rotated to any angle based on a configuration of the workpiece.

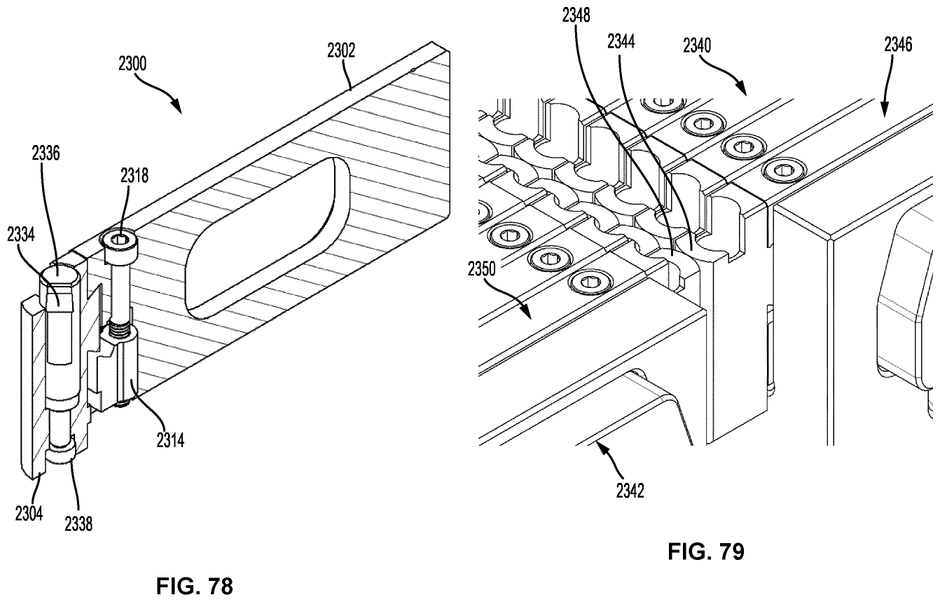

FIG. 78 illustrates a partial cross-sectional view of the finger 2300 with a stud 2336 having the flat surface 2334 without a hexagonal head, in accordance with an example implementation. The finger 2300 can have a shoulder bolt 2338, rather than the screw 2328, coupled to the stud 2336. The shoulder bolt 2338 can be coupled to the stud 2336, and can be used to rotate the stud 2336 to any desired angle to have the flat surface 2334 facing in a desired direction.

In addition to the studs described above facilitating interfacing with various workpieces, they can also facilitate reducing the manufacturing tolerance of the finger tips. When devices having the finger 2300 are placed opposite each other so they can grip a workpiece therebetween, the stud can be temporarily removed and surfaces of the finger tips can be machined to the same level.

FIG. 79 illustrates a partial perspective view of two devices having fingers configured as the finger 2300, in accordance with an example implementation. Particularly, a device 2340 and a device 2342 are positioned opposite each other, each having respective fingers that are configured as the finger 2300. The studs of the fingers can be removed and the fingers can be extended to contact each other as shown in FIG. 79. A skim cutter can then be used to perform a dressing operation on surfaces of the fingers such as surface 2344 of finger 2346 and surface 2348 of finger 2350.

This way, the surfaces of the fingers can be made to match in height (i.e., to make the surfaces level) to accurately interface with a workpiece. As such, manufacturing tolerance of the finger tips can be reduced as precise dimensions of, for example, the surfaces 2344, 2348 can be adjusted later once the workpiece holding device is assembled.

Features of the fingers described above can be used in combination with each other. For example, the features described with respect to FIG. 58-60, 61-63, 64-70, or 71-79 can be used in combination with other features described above (e.g., features of FIG. 38 or FIG. 44) as appropriate.

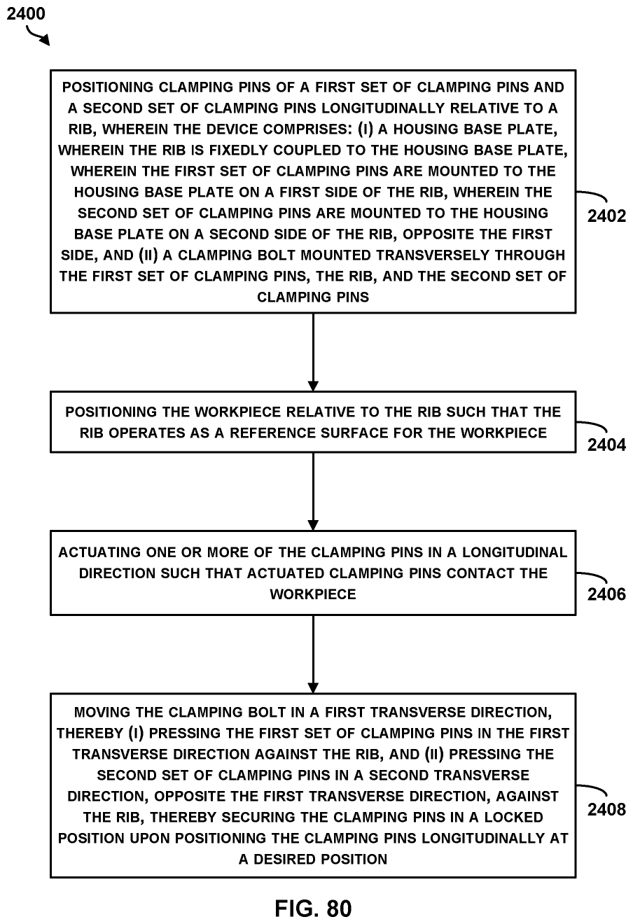

FIG. 80 is a flowchart of a method 2400 for operating a device for holding a workpiece, in accordance with an example implementation. The method 2400 may include one or more operations, or actions as illustrated by one or more of blocks 2402, 2404, 2406, and 2408. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 2402, the method 2400 includes positioning fingers of the first set of fingers 1510 and the second set of fingers 1512 longitudinally relative to the rib 1508. For instance, the fingers can be pulled back such that the rib 1508 is positioned foremost relative to the fingers in a longitudinal direction (i.e., the positive z-axis direction).

At block 2404, the method 2400 includes positioning the workpiece 16 relative to the rib 1508 such that the rib 1508 operates as a reference surface for the workpiece 16.

At block 2406, the method 2400 includes actuating one or more of the sets of fingers 1510, 1512 in a longitudinal direction such that actuated fingers contact the workpiece 16.

At block 2408, the method 2400 includes moving the clamping bolt 1810 in a first transverse direction (e.g., rotating the clamping bolt 1810, causing it to move in the negative x-axis direction), thereby (i) pressing the first set of fingers 1510 in the first transverse direction against the rib 1508, and (ii) pressing the second set of fingers 1512 in a second transverse direction, opposite the first transverse direction, against the rib 1508, thereby securing the sets of fingers 1510, 1512 in a locked position upon positioning the sets of fingers 1510, 1512 longitudinally at a desired position.

The method 2400 can include any of the other steps described above. Further, any of the fingers described above can be used instead of the sets of fingers 1510, 1512.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Implementations of the present disclosure can thus relate to one of the enumerated example implementation (EEEs) listed below.

EEE 1 is a finger of a device for holding a workpiece, the finger comprising: a finger body; a finger tip configured to be removably coupled to the finger body; and a cam member disposed, at least partially, in the finger body and configured to engage the finger tip, wherein actuating the cam member causes the cam member to pull the finger tip toward the finger body to couple the finger tip to the finger body.

EEE 2 is the finger of EEE 1, wherein the finger body comprises a key and wherein the finger tip comprises a groove configured as a key slot, such that the key of the finger body is received in the groove of the finger tip to facilitate coupling the finger tip to the finger body.

EEE 3 is the finger of EEE 2, wherein the cam member had a flange, and wherein the groove of the finger tip is flanged-shaped, such that when the finger tip is mounted to the finger body, the key and the flange are received in the groove, and wherein when the cam member is actuated, the cam member pulls the finger tip toward the finger body via interaction between the flange and the groove.

EEE 4 is the finger of any of EEEs 1-3, wherein the cam member is disposed in a blind hole formed in the finger body, wherein the finger further comprises: a spring disposed in the blind hole, wherein the spring biases the cam member outward from the finger body to facilitate engaging the finger tip.

EEE 5 is the finger of EEE 4, wherein at least a portion of the blind hole has a rectangular shape, and wherein at least a portion of the cam member has a corresponding rectangular shape interacting with the portion of the blind hole having the rectangular shape to preclude the cam member from rotating within the blind hole.

EEE 6 is the finger of any of EEEs 1-5, wherein the cam member has a hole comprising a conical depression bound by a conical surface, and wherein the finger further comprises: a fastener disposed in the finger body and having a tapered portion configured to slide against the conical surface of the conical depression of the cam member, thereby pulling the cam member inward and pulling the finger tip engaged with the cam member toward the finger body.

EEE 7 is the finger of EEE 6, wherein the fastener is a screw threadedly-engaged with the finger body, wherein screwing the screw in the finger body causes the tapered portion to slide against the conical surface, thereby pulling the cam member inward and pulling the finger tip engaged with the cam member toward the finger body.

EEE 8 is the finger of EEE 7, wherein the cam member is disposed in a blind hole formed in the finger body, wherein the finger further comprises: a spring disposed in the blind hole, wherein the spring biases the cam member outward from the finger body to facilitate engaging the finger tip, wherein the screw has a protrusion disposed in the hole of the cam member to prevent the cam member from being pushed out of the blind hole by the spring upon disengagement of the tapered portion of the screw from the conical depression.

EEE 9 is a finger of a device for holding a workpiece, the finger comprising: a finger body having a recess; a finger tip configured to be removably coupled to the finger body, wherein the finger tip comprises a boss having a wedge, wherein the recess of the finger body is configured to receive the boss of the finger tip; and a clamp mounted, at least partially, within the finger body and having a wedge-shaped groove, wherein upon mounting the finger tip to the finger body, the clamp is moved to engage the finger tip, thereby causing the wedge-shaped groove of the clamp to receive the wedge of the boss of the finger tip and coupling the finger tip to the finger body.

EEE 10 is the finger of EEE 9, further comprising: a fastener mounted to the finger body and configured to engage the clamp, such that upon mounting the finger tip to the finger body, the fastener moves the clamp, thereby causing the wedge-shaped groove to receive the wedge of the boss of the finger tip and coupling the finger tip to the finger body.

EEE 11 is the finger of EEE 10, wherein the fastener is a screw mounted to the finger body and threadedly-engaged with the clamp, such that rotation of the screw causes the clamp to move linearly within the finger body to engage the finger tip.

EEE 12 is the finger of any of EEEs 9-11, wherein the wedge is a first wedge and the wedge-shaped groove is a first wedge-shaped groove, wherein the recess of the finger body comprises a second wedge-shaped groove, wherein the boss of the finger tip comprises a second wedge, and wherein the second wedge-shaped groove of the finger body receives the second wedge of the boss of the finger tip.

EEE 13 is the finger of any of EEEs 9-12, further comprising: a stud removably mounted to the finger tip.

EEE 14 is the finger of EEE 13, wherein the stud has a flat surface, and wherein the stud is configured to be rotatable to different angles to orient the flat surface at respective different orientations.

EEE 15 is the finger of any of EEEs 13-14, wherein the stud has a polygonal head, and wherein the finger tip comprises a hole having a corresponding polygonal shape and configured to receive the polygonal head of the stud, such that the stud is configured to be oriented at different discrete angles corresponding to a number of sides of the polygonal head.

EEE 16 is the finger of EEE 15, wherein the polygonal head is a hexagonal head, and wherein the stud is configured to be oriented at six different angles.

What is claimed is:

1. A finger of a device for holding a workpiece, the finger comprising:
a finger body;
a finger tip configured to be removably coupled to the finger body; and
a cam member disposed, at least partially, in the finger body and configured to engage the finger tip, wherein actuating the cam member causes the cam member to pull the finger tip toward the finger body to couple the finger tip to the finger body.

2. The finger of claim 1, wherein the finger body comprises a key and wherein the finger tip comprises a groove configured as a key slot, such that the key of the finger body is received in the groove of the finger tip to facilitate coupling the finger tip to the finger body.

3. The finger of claim 2, wherein the cam member had a flange, and wherein the groove of the finger tip is flange-shaped, such that when the finger tip is mounted to the finger body, the key and the flange are received in the groove, and wherein when the cam member is actuated, the cam member pulls the finger tip toward the finger body via interaction between the flange and the groove.

4. The finger of claim 1, wherein the cam member is disposed in a blind hole formed in the finger body, wherein the finger further comprises:
a spring disposed in the blind hole, wherein the spring biases the cam member outward from the finger body to facilitate engaging the finger tip.

5. The finger of claim 4, wherein at least a portion of the blind hole has a rectangular shape, and wherein at least a portion of the cam member has a corresponding rectangular shape interacting with the portion of the blind hole having the rectangular shape to preclude the cam member from rotating within the blind hole.

6. The finger of claim 1, wherein the cam member has a hole comprising a conical depression bound by a conical surface, and wherein the finger further comprises:
a fastener disposed in the finger body and having a tapered portion configured to slide against the conical surface of the conical depression of the cam member, thereby pulling the cam member inward and pulling the finger tip engaged with the cam member toward the finger body.

7. The finger of claim 6, wherein the fastener is a screw threadedly-engaged with the finger body, wherein screwing the screw in the finger body causes the tapered portion to slide against the conical surface, thereby pulling the cam member inward and pulling the finger tip engaged with the cam member toward the finger body.

8. The finger of claim 7, wherein the cam member is disposed in a blind hole formed in the finger body, wherein the finger further comprises:
a spring disposed in the blind hole, wherein the spring biases the cam member outward from the finger body to facilitate engaging the finger tip, wherein the screw has a protrusion disposed in the hole of the cam member to prevent the cam member from being pushed out of the blind hole by the spring upon disengagement of the tapered portion of the screw from the conical depression.

9. A finger of a device for holding a workpiece, the finger comprising:
a finger body having a recess;
a finger tip configured to be removably coupled to the finger body, wherein the finger tip comprises a boss having a wedge, wherein the recess of the finger body is configured to receive the boss of the finger tip; and
a clamp mounted, at least partially, within the finger body and having a wedge-shaped groove, wherein upon mounting the finger tip to the finger body, the clamp is moved to engage the finger tip, thereby causing the wedge-shaped groove of the clamp to receive the wedge of the boss of the finger tip and coupling the finger tip to the finger body.

10. The finger of claim 9, further comprising:
a fastener mounted to the finger body and configured to engage the clamp, such that upon mounting the finger tip to the finger body, the fastener moves the clamp, thereby causing the wedge-shaped groove to receive the wedge of the boss of the finger tip and coupling the finger tip to the finger body.

11. The finger of claim 10, wherein the fastener is a screw mounted to the finger body and threadedly-engaged with the clamp, such that rotation of the screw causes the clamp to move linearly within the finger body to engage the finger tip.

12. The finger of claim 9, wherein the wedge is a first wedge and the wedge-shaped groove is a first wedge-shaped groove, wherein the recess of the finger body comprises a second wedge-shaped groove, wherein the boss of the finger tip comprises a second wedge, and wherein the second wedge-shaped groove of the finger body receives the second wedge of the boss of the finger tip.

13. The finger of claim 9, further comprising:
a stud removably mounted to the finger tip.

14. The finger of claim 13, wherein the stud has a flat surface, and wherein the stud is configured to be rotatable to different angles to orient the flat surface at respective different orientations.

15. The finger of claim 13, wherein the stud has a polygonal head, and wherein the finger tip comprises a hole having a corresponding polygonal shape and configured to receive the polygonal head of the stud, such that the stud is configured to be oriented at different discrete angles corresponding to a number of sides of the polygonal head.

16. The finger of claim 15, wherein the polygonal head is a hexagonal head, and wherein the stud is configured to be oriented at six different angles.
